(19) United States
(12) Patent Application Publication
(10) Pub. No.: US 2025/0274343 A1
(43) Pub. Date: Aug. 28, 2025

(54) UPDATING ROLES AND/OR RELATIONSHIPS OF DEVICES IN A MESH NETWORK

(71) Applicant: Lutron Technology Company LLC, Coopersburg, PA (US)

(72) Inventors: Jordan H. Crafts, Bethlehem, PA (US); Galen Edgar Knode, Macungie, PA (US)

(73) Assignee: Lutron Technology Company LLC, Coopersburg, PA (US)

(21) Appl. No.: 19/060,648

(22) Filed: Feb. 22, 2025

Related U.S. Application Data
(60) Provisional application No. 63/557,306, filed on Feb. 23, 2024.

(51) Int. Cl. H04L 41/0823

(52) U.S. Cl. CPC H04L 41/0823

(57) ABSTRACT

A load control system may include control devices configured to communicate via a network. The network may include router devices and end devices for enabling communication of messages throughout the network. After the network is established, adjustments may be made to the roles of control devices and/or the relationship between the control devices to adjust the operation and/or configuration of the network.

### CROSS-REFERENCE TO RELATED APPLICATIONS

This application claims priority to U.S. patent application Ser. No. 63/557,306, filed Feb. 23, 2024, which is incorporated by reference herein in its entirety.

### BACKGROUND

A user environment, such as a residence or an office building, for example, may be configured using various types of load control systems. A lighting control system may be used to control the lighting loads providing artificial light in the user environment. A motorized window treatment control system may be used to control the natural light provided to the user environment. A heating, ventilation, and air conditioning (HVAC) system may be used to control the temperature in the user environment.

Each load control system may include various control devices, including input devices and load control devices. The control devices may receive messages, which may include load control instructions, for controlling an electrical load from one or more of the input devices. The control devices may be capable of directly controlling an electrical load. The input devices may be capable of indirectly controlling the electrical load via the load control device. Examples of load control devices may include lighting control devices (e.g., a dimmer switch, an electronic switch, a ballast, or a light-emitting diode (LED) driver), a motorized window treatment, a temperature control device (e.g., a thermostat), a plug-in load control device, and/or the like. Examples of input devices may include remote control devices, occupancy sensors, daylight sensors, glare sensors, color temperature sensors, temperature sensors, and/or the like. Remote control devices may receive user input for performing load control.

### SUMMARY

A load control system may include control devices configured to communicate via a network. The network may include router devices and end devices for enabling communication of messages throughout the network. After the network is established, adjustments may be made to the roles of control devices and/or the relationship between the control devices to adjust the operation and/or configuration of the network.

Embodiments are described herein for adjusting a network configuration of a network comprising a plurality of control devices in a load control system. A control device may collect data characteristics related to the plurality of control devices in the load control system. The plurality of control devices may be permitted to initiate adjustments to the network configuration based on an expiration of a prior network formation period or a prior adjustment stabilization period after a prior adjustment to the network configuration. Based on the collected network optimization characteristics (e.g., network adjustment characteristics), the control device may determine to initiate an adjustment to the network configuration. Prior to receipt of an indication that any control device of the plurality of control devices has initiated adjustment to the network configuration after the determination that the plurality of control devices is permitted to initiate adjustments, the control device may initiate the adjustment to the network configuration.

In another example, a control device may collect network optimization characteristics that are related to the plurality of control devices in the load control system. The plurality of control devices may comprise at least one control device that is assigned a role of end device in the network. The plurality of control devices may comprise at least one control device that is assigned a role of router device in the network. The network optimization characteristics may be collected based on advertisement messages received from each control device of the plurality of control devices in the network. Based on the collected network optimization characteristics, the control device may determine to initiate an adjustment to the network configuration. The control device may determine that the plurality of control devices is permitted to initiate adjustments to the network configuration based on an expiration of a prior network formation period or a prior adjustment stabilization period after a prior adjustment to the network configuration. Prior to receipt of an indication that any control device of the plurality of control devices has initiated adjustment to the network configuration after the determination that the plurality of control devices is permitted to initiate adjustments, the control device may initiate the adjustment to the network configuration.

In another example, a first control devices of the plurality of control devices may collect first network optimization characteristics related to the plurality of control devices in the load control system and determine, based on the first network optimization characteristics, to initiate a first adjustment to the network configuration. A second control device of the plurality of control devices may collect second network optimization characteristics related to the plurality of control devices in the load control system. The second control device may determine, based on the second network optimization characteristics, to initiate a second adjustment to the network configuration. The second control device may determine that the plurality of control devices is permitted to initiate adjustments to the network configuration based on an expiration of a prior network formation period or a prior adjustment stabilization period after a prior adjustment to the network configuration. The second control device may initiate the second adjustment to the network configuration. In response to receipt of an indication that the second control device has initiated the second adjustment to the network configuration, the first control device may be configured to await an adjustment stabilization period before additional collection of network optimization characteristics or a subsequent determination to initiate the first adjustment or a third adjustment to the network configuration.

In another example, a load control system may comprise a first control device and a second control device. The first control device may collect first network optimization characteristics related to the plurality of control devices in the load control system. The first control device may determine, based on the first network optimization characteristics, to initiate a first adjustment to the network configuration. The first control device may, in response to the determination to initiate the first adjustment, start a first random backoff timer that is set to a first random period of time within a first predefined timeframe. The first control device may delay the initiation of the first adjustment until an expiration of the first random backoff timer. The second control device may collect second network optimization characteristics related to the plurality of control devices in the load control system. The second control device may determine, based on the second network optimization characteristics, to initiate a second adjustment to the network configuration. The second control device may, in response to the determination to initiate the second adjustment, start a second random backoff timer that is set to a second random period of time within a second predefined timeframe. The second control device may delay the initiation of the second adjustment until an expiration of the second random backoff timer. The second control device may, in response to receipt of an indication that the first control device has initiated the first adjustment to the network configuration prior to the second control device initiating the second adjustment to the network configuration, await an adjustment stabilization period before additional collection of network optimization characteristics or initiation of any adjustment to the network configuration. The second control device may, prior to receipt of an indication that any control device of the plurality of control devices has initiated adjustment to the network configuration and after the expiration of the second random backoff timer, initiate the second adjustment to the network configuration.

In another example, a control device may collect network optimization characteristics related to a plurality of control devices in a load control system. The control device may receive an indication that a first control device of the plurality of control devices is initiating an adjustment to the network configuration. The control device may, after the receipt of the indication that the first control device is initiating the adjustment to the network configuration, await an adjustment stabilization period before continuing the collecting of the network optimization characteristics or initiating an adjustment to the network configuration at a second control device of the plurality of control devices. The control device may, after the adjustment stabilization period, continue the collection of the network optimization characteristics. The control device may determine, based on the collection of the network optimization characteristics after the adjustment stabilization period, to initiate an adjustment to the network configuration at the second control device of the plurality of control devices. Prior to receipt of an indication that any control device of the plurality of control devices has initiated adjustment to the network configuration after the adjustment stabilization period, the control device may initiate at least one of the adjustment to the network configuration at the second control device.

In another example, a control device may receive a router network optimization advertisement message (e.g., network adjustment advertisement message) from at least one router device of the plurality of control devices in the load control system. The control device may receive an end device network optimization advertisement message from at least one end device of the plurality of control devices in the load control system. The end device network optimization advertisement message may include information that is based on the router network optimization advertisement message. The control device may process the router network optimization advertisement message and the end device network optimization advertisement message to determine to upgrade from an end device to a router device. The control device may initiate an upgrade from the end device to the router device.

After the determination to initiate the adjustment to the network configuration at the first control device, the control device may set a random backoff timer within a predefined timeframe before initiating the network adjustment. After an expiration of the random backoff timer, the control device may transmit a message configure to indicate that the first control device is performing the adjustment to the network configuration. The message may comprise an adjustment notice.

The control device may detect that a network has been formed. The control device may, in response to the formation of the network, await a network stabilization period prior to at least one of the collecting of the network data or the determination to initiate the adjustment to the network configuration at the first control device.

The adjustment to the network configuration may comprise an adjustment to a role of the first control device on a network. The role of the first control device may be a router device in the network prior to the adjustment. The adjustment may be initiated to downgrade the role of the first control device to an end device in the network. The role of the first control device may be an end device in the network prior to the adjustment. The adjustment may be initiated to upgrade the role of the first control device to a router device in the network.

The adjustment to the network configuration may comprise an adjustment to a relationship of the first control device with another control device of the plurality of control devices on a network. The relationship may be a parent-child relationship. The first control device may be a child device to another control device of the plurality of control devices to which the first control device is attached as a parent device. The adjustment is initiated to change the parent device of the first control device to another control device of the plurality of control devices in the network.

The first control device may be a first load control device configured to control a first electrical load. The second control device may be a second load control device configured to control a second electrical load. At least one of the first load control device or the second load control device comprises a lighting control device. At least one of the first electrical load or the second electrical load comprises a lighting load. The at least one of the first lighting load or the second lighting load may be controlled based on control instructions sent to the at least one of the first lighting control device or the second lighting control device.

### BRIEF DESCRIPTION OF THE DRAWINGS

FIG. 1A is a diagram of an example load control system.

FIG. 1B is a block diagram illustrating an example of a device capable of processing and/or communication in a load control system, such as the load control system of FIG. 1A.

FIG. 1C is a block diagram illustrating an example of a load control device capable of operating in a load control system, such as the load control system of FIG. 1A.

FIG. 2A is a diagram of an example network that may allow for communication between devices in the load control system of FIG. 1A.

FIG. 2B is a diagram of example networks or network partitions (e.g., networks or subnetworks) that allow for communication between devices in the load control system of FIG. 1A.

FIGS. 2C to 2E are diagrams of another example network that allows for communication between devices in the load control system of FIG. 1A.

FIG. 2F is a diagram of another example network that illustrates the cost and network overhead associated with communication between the devices in the load control system of FIG. 1A.

FIG. 2G is a table that illustrates example link costs that may correspond to different link qualities.

FIG. 3 is a flow diagram illustrating example process for making adjustments to network behavior and/or network configuration.

FIGS. 4A-4D include diagrams of illustrating examples of a network that includes control devices changing roles and/or relationships over time during a procedure for adjusting network behavior and/or network configuration.

FIGS. 5A and 5B are diagrams illustrating example timelines of an example procedure for adjusting network behavior and/or network configuration.

FIGS. 6A and 6B are sequence flow diagrams illustrating example message flows for making adjustments to network behavior and/or network configuration.

FIG. 7A includes a graph of an example router device advertised cost value per number of router devices in the network.

FIG. 7B includes a graph of an example router device advertised cost value per number of child devices attached to a router device.

FIG. 7C includes a graph of an example end device advertised cost value per number of router device parent options in the network.

FIG. 7D includes a graph of an example end device advertised cost value per based on the communication quality (e.g., SNR) of the communications (e.g., communications to and/or from) the current router device parent in the network.

FIGS. 8A and 8B are flowcharts of example procedures for control devices to collect network data and initiate adjustment to network behavior and/or network configuration to update network operation.

FIGS. 9A and 9B include flowcharts of other example procedures for control devices to collect network data and initiate adjustments to network behavior and/or network configuration to update network operation.

### DETAILED DESCRIPTION

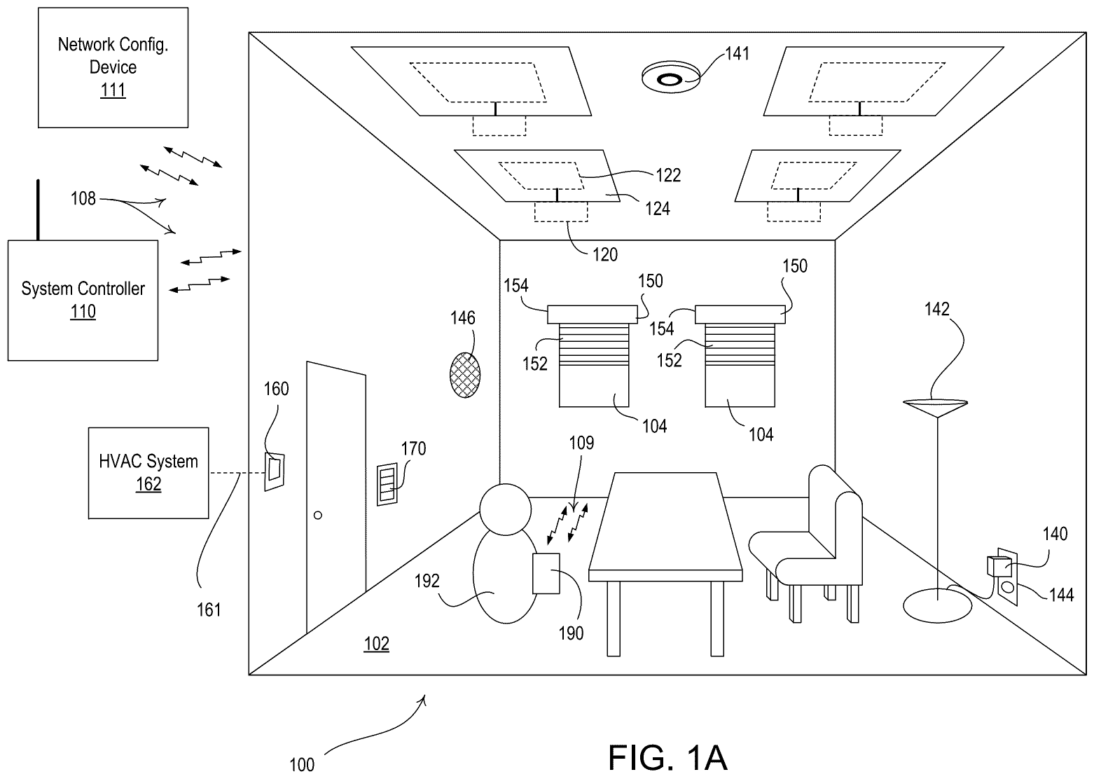

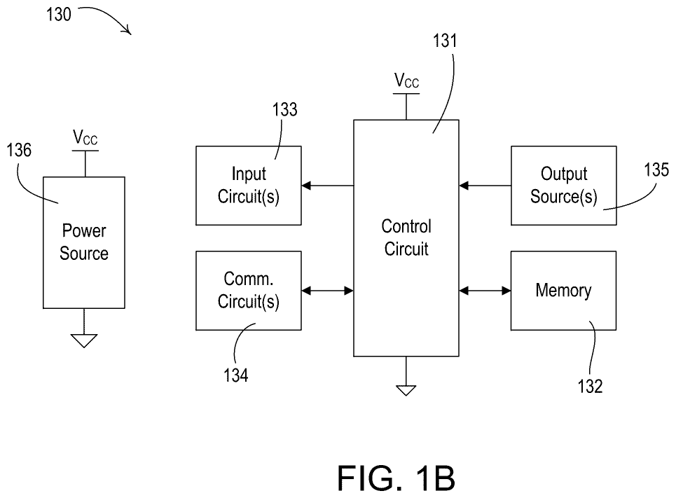

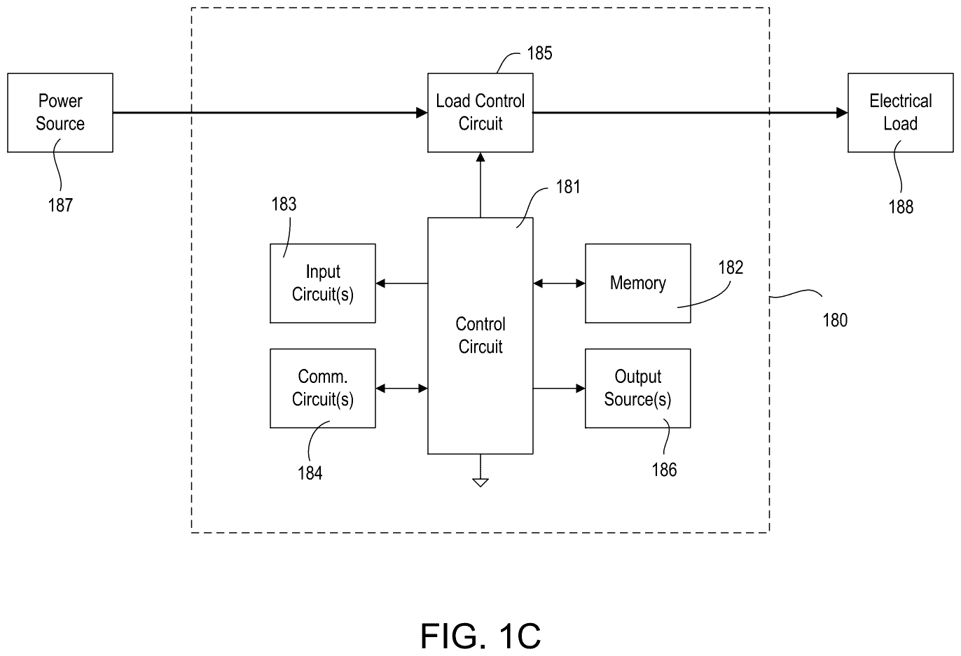

FIG. 1A is a diagram of an example load control system 100 for controlling the amount of power delivered from an alternating-current (AC) power source (not shown) to one or more electrical loads. The load control system 100 may be installed in a load control environment 102. The load control environment 102 may include a space in a residential or commercial building. For example, the load control system 100 may be installed in one or more rooms on one or more floors in the building. The load control system 100 may comprise a plurality of control devices. The control devices may include load control devices that are configured to control one or more electrical loads in the load control environment 102 (e.g., also referred to as a user environment). For example, the load control devices may control the one or more electrical loads in response to inputs from one or more input devices or other devices in the load control system 100.

The load control devices in the load control system 100 may include lighting control devices. For example, the load control system 100 may include lighting control devices 120 for controlling lighting loads 122 in a corresponding lighting fixture 124. The lighting control devices 120 may comprise, for example, light-emitting diode (LED) drivers and the lighting loads 122 may comprise LED light sources. While each of the lighting fixtures 124 is shown having a single lighting load 122, each lighting fixture may comprise one or more individual light sources (e.g., lamps and/or LED emitters) that may be controlled individually and/or in unison by the respective lighting control device. Though an LED driver is provided as an example lighting control device, other types of load control devices may be implemented as load control devices in the load control system 100. For example, the lighting control devices of the load control system 100 may comprise dimmer switches, electronic dimming ballasts for controlling fluorescent lamps, or other lighting control devices for controlling corresponding lighting loads. Each of the lighting control devices 120 may be configured to control (e.g., directly control) an amount of power provided to the respective lighting load 122. Each of the lighting control devices 120 may be configured to receive messages via wired or wireless communication and to control the lighting load 122 in response to the received messages. For example, each of the lighting control devices 120 may be configured to communicate the messages wirelessly via radio-frequency (RF) signals 108, 109. One will recognize that lighting control device 120 and lighting load 122 may be integral and thus part of the same fixture or bulb, for example, or may be separate.

The lighting control device 120 may be configured to control the lighting load 122 to emit light at an intensity level (e.g., lighting intensity level and/or brightness) and/or a color (e.g., color temperature or a full-color value) in response to messages that are received from devices in the load control system 100. The lighting control device 120 may control of a total light output of the emitted light produced by the lighting load 122 to a color temperature and/or a full-color value. Each lighting load 122 may include a plurality of differently colored LEDs. In other words, the lighting loads 122 may include a number of differently colored LEDs within a single package. The package may be configured such that the light emitted by each of the LEDs is mixed to produce a cumulative light having varying chromaticity coordinates (e.g., color points) within a color gamut formed by the various LEDs that make up the lighting load 122. As one example, the lighting loads 122 may include one or more red LEDs, one or more green LEDs, one or more blue LEDs, and one or more white LEDs (e.g., which may be collectively referred to herein as an RGBW lighting load). For example, the white LEDs may comprise substantially white LEDs (e.g., phosphor-coated yellow and/or mint green LED(s)). Although the RGBW lighting load is described herein with a combination of four LEDs of certain colors, other combinations of LEDs (e.g., more or less LEDs and/or different color LEDs) may be used. For example, another combination of four or more LEDs of other color combinations may be used.

The lighting control devices 120 may each adjust various settings of the corresponding lighting load 122 to adjust the light (e.g., the cumulative light) emitted from the lighting loads. For example, the lighting control device 120 may adjust the intensity level (e.g., lighting intensity level and/or brightness), the color (e.g., color temperature and/or full-color value), the value of a vibrancy parameter affecting color saturation, and/or another lighting control parameter. For example, the color temperature may be defined as a correlated color temperature (CCT) value. Each lighting control device 120 and respective lighting load 122 may be configured to produce white or near-white light of varying brightness/intensity within a range of color temperatures ranging from “warm white” (e.g., roughly 2600 Kelvin (K)-3700 K), to “neutral white” (e.g., 3700 K-5000 K) to “cool white” (e.g., 5000 K-8300 K). For example, the lighting control device 120 and respective lighting load 122 may be configured to produce light at colors of varying chromaticity coordinates that lie on or near the black body locus or curve. As a further example, the lighting control devices 120 and their corresponding light loads 122 may be further configured to cause the respective lighting loads 122 to emit light at any of a plurality of colors within the color gamut formed by the various LEDs that make up the lighting load 122.

Each of the lighting control devices 120 may be configured to control the respective lighting load 122 to increase and/or decrease a color saturation of objects in the load control environment 102. For example, the lighting control device 120 may control or be responsive to a vibrancy parameter that is configured to adjust a spectrum of the light emitted by the lighting load 122 in order to control the color saturation of the objects in the load control environment 102. The vibrancy parameter may allow the lighting control device 120 to tune the individual colors that make light at a given color (e.g., full color or a color temperature). The vibrancy parameter may allow the lighting control device 120 to control the saturation of light having given chromaticity coordinates. The vibrancy parameter allows the lighting control device 120 to control the power provided to the LEDs of the corresponding lighting loads 122 to adjust the overall spectral power distribution of the light source, which may affect the color of the light (e.g., the reflected light) on objects within the load control environment 102. Increases and decreases in the value of the vibrancy parameter may increase and/or decrease the color saturation of objects in the area without changing the color of the light emitted by the lighting loads 122 when the occupant of the space looks directly at the lighting loads 122. In an example, the vibrancy parameter may be a value between zero and one hundred percent for increasing and/or decreasing the color saturation of the objects in the load control environment 102. Changing the value of the vibrancy parameter may cause the lighting control device 120 to decrease or increase the intensity of one or more white LEDs (e.g., white or substantially white LEDs) that make up the respective lighting loads 122. For example, increasing the value of the vibrancy parameter may thereby decrease the intensity of the one or more white LEDs that make up the respective lighting loads 122, and thereby increase the color saturation of the objects in the load control environment 102. Decreasing the value of the vibrancy parameter may thereby increase the intensity of the one or more white LEDs that make up the respective lighting loads 122, and thereby decrease the color saturation of the objects in the load control environment 102. Changing the value of the vibrancy parameter in this manner may also include changing the intensities of other LEDs (e.g., red, green, and/or blue LEDs) of the lighting loads 122 to maintain the same color output and/or intensity level of the lighting loads 122 (e.g., to maintain the same (or approximately the same within one or more MacAdam ellipses) chromaticity coordinates of the mixed color output of the lighting loads) and/or the same lumen output of the lighting loads 122. Adjusting the vibrancy value may, however, adjust a spectral power distribution of the light, which may adjust the light reflected off of objects in the space. For example, as the vibrancy value increases, a spectral power distribution curve (e.g., spectrum) of the emitted light (e.g., relative intensity vs wavelength) may become sharper and/or may result in individual colors on the objects to appear more vibrant when the light reflects off of them. One example of such a lighting control device and respective lighting load is described as illumination device 38 of U.S. Pat. No. 10,237,945, issued Mar. 19, 2019, entitled ILLUMINATION DEVICE, SYSTEM AND METHOD FOR MANUALLY ADJUSTING AUTOMATED PERIODIC CHANGES IN EMULATION OUTPUT, the contents of which are hereby incorporated by reference in their entirety. One will recognize that other examples of lighting control devices and respective lighting loads are possible.

The load control devices in the load control system 100 may comprise a plug-in load control device 140 for controlling a plug-in electrical load, e.g., a plug-in lighting load (such as a floor lamp 142 or a table lamp) and/or an appliance (such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108, 109 and to turn on and off or adjust the intensity level of the floor lamp 142 in response to the received messages.

The load control devices in the load control system 100 may comprise one or more daylight control devices, e.g., such as motorized window treatments 150, for controlling the amount of daylight entering the load control environment 102. For example, the motorized window treatments 150 may comprise motorized roller shades and/or motorized cellular shades. Each motorized window treatment 150 may comprise a window treatment fabric 152 hanging from a headrail 154 in front of a respective window 104. Each motorized window treatment 150 may further comprise a motor drive unit (not shown) located inside of the headrail 154 for raising and lowering the window treatment fabric 152 for controlling the amount of daylight entering the load control environment 102. The motor drive units of the motorized window treatments 150 may comprise electrical loads (e.g., motors). The motor drive units may each be configured to receive messages via the RF signals 108 and control the respective motor to adjust the position of the respective window treatment fabric 152 in response to the received messages. For example, the motorized window treatments 150 may be battery-powered. The load control system 100 may comprise other types of daylight control devices, such as, for example, a drapery, a Roman shade, a Venetian blind, a Persian blind, a pleated blind, a tensioned roller shade system, an electrochromic or smart window, and/or other suitable daylight control device. Examples of battery-powered motorized window treatments are described in greater detail in U.S. Pat. No. 8,950,461, issued Feb. 10, 2015, entitled MOTORIZED WINDOW TREATMENT, and U.S. Patent Application Publication No. 2023/0193691, published Jun. 22, 2023, entitled CONTROLLING A POSITION OF A COVERING MATERIAL OF A BATTERY-POWERED MOTORIZED WINDOW TREATMENT, the entire disclosures of which are hereby incorporated by reference.

The load control devices in the load control system 100 may comprise one or more temperature control devices, e.g., a thermostat 160 for controlling a room temperature in the load control environment 102. The thermostat 160 may be configured to communicate with a heating, ventilation, and air conditioning (HVAC) system 162 via wired or wireless communication. For example, the thermostat 160 may be coupled to the HVAC system 162 via a control link 161 (e.g., an analog control link or a wired digital communication link). The thermostat 160 may be configured to communicate messages with a controller of the HVAC system 162 (e.g., via wired or wireless communication). The thermostat 160 may comprise a temperature sensor for measuring the room temperature of the load control environment 102 and may control the HVAC system 162 to adjust the temperature in the room to a setpoint temperature. The load control system 100 may comprise one or more wireless temperature sensors (not shown) located in the load control environment 102 for measuring the room temperatures. The HVAC system 162 may be configured to turn a compressor on and off for cooling the load control environment 102 and to turn a heating source on and off for heating the rooms in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the load control environment 102. The thermostat 160 may be configured to receive messages via the RF signals 108, 109 and adjust heating, ventilation, and cooling in response to the received messages.

The load control system 100 may comprise one or more other types of load control devices, such as, for example, a screw-in luminaire including a dimmer circuit and an incandescent or halogen lamp; a screw-in luminaire including a ballast and a compact fluorescent lamp; a screw-in luminaire including an LED driver and an LED light source; an electronic switch, controllable circuit breaker, or other switching device for turning an appliance on and off; a controllable electrical receptacle, or controllable power strip for controlling one or more plug-in loads; a motor control unit for controlling a motor load, such as a ceiling fan or an exhaust fan; a drive unit for controlling a projection screen; motorized interior or exterior shutters; an air conditioner; a compressor; an electric baseboard heater controller; a controllable damper; a variable air volume controller; a fresh air intake controller; a ventilation controller; hydraulic valves for use radiators and radiant heating system; a humidity control unit; a humidifier; a dehumidifier; a water heater; a boiler controller; a pool pump; a refrigerator; a freezer; a television or computer monitor; a video camera; an audio system or amplifier; an elevator; a power supply; a generator; an electric charger, such as an electric vehicle charger; an alternative energy controller; and/or another type of load control device.

The load control system 100 may comprise one or more input devices capable of receiving an input (e.g., detecting an input event) for controlling one or more load control devices in the load control system 100. The input devices and the load control devices may be collectively referred to as control devices in the load control system 100. The input devices in the load control system 100 may comprise one or more remote control devices, such as a remote control device 130. For example, the remote control device 130 may comprise a keypad. In another example, the remote control device 130 may comprise a rotary knob configured to transmit messages to one or more other devices in response to a rotation on the rotary knob (e.g., rotation of a predefined distance or for a predefined period of time). The remote control device 130 may be mounted to a structure, such as a wall, a toggle actuator of a mechanical switch, or a pedestal to be located on a horizontal surface. In another example, the remote control device 130 may be handheld. For example, the remote control device 130 may be battery-powered and/or may be powered from an external power source, such as an AC power supply and/or a DC power supply.

The remote control device 130 may be configured to transmit messages to one or more other devices in the load control system 100 in response to an input event, such as an actuation of one or more buttons or a rotation of a rotary knob of the remote control device 130. For example, the remote control device 130 may transmit messages to the load control devices of the load control system 100 (e.g., the lighting control devices 120, the plug-in load control device 140, the motorized window treatments 150, the temperature control device 160, and/or other load control devices) wirelessly via the RF signals 108 in response to actuation of one or more actuators and/or buttons located thereon. The remote control device 130 may also be configured to transmit message to the load control devices in the load control system 100 via a wired communication link in response to actuation of one or more actuators and/or buttons located thereon. In response to an input event at the remote control device 130, one or more of the load control devices may be responsive to the messages transmitted by the remote control device 130 (e.g., for controlling the one or more electrical loads of the load control system 100).

The remote control device 130 may provide feedback (e.g., visible feedback) to a user of the remote control device 130 on a visible indicator, such as a status indicator. The status indicator may be illuminated by one or more light emitting diodes (LEDs) for providing feedback. The status indicator may provide different types of feedback. The feedback may include feedback indicating actuations by a user or other user interface event, a status of one or more of the electrical loads being controlled by the remote control device 130, and/or a status of one or more of the load control devices that are responsive to the remote control device 130. The feedback may be displayed in response to user interface event and/or in response to messages received that indicate the status of load control devices and/or electrical loads. Examples of remote control devices are described in greater detail in commonly-assigned U.S. Pat. No. 8,330,638, issued Dec. 11, 2012, entitled WIRELESS BATTERY-POWERED REMOTE CONTROL HAVING MULTIPLE MOUNTING MEANS, and U.S. patent application Publication No, 2024/0355559, published Oct. 24, 2024, entitled CONTROL DEVICE, the entire disclosures of which are hereby incorporated by reference.

The input devices of the load control system 100 may comprise one or more sensor devices, such as a sensor device 132. The sensor device 132 may be configured to transmit messages to one or more other devices in the load control system 100 in response to an input event, such as a sensor detection event and/or a sensor measurement event. For example, the sensor device 132 may transmit messages to the load control devices of the load control system 100 (e.g., the lighting control devices 120, the plug-in load control device 140, the motorized window treatments 150, the temperature control device 160, and/or other load control devices) wirelessly via the RF signals 108 in response to a sensor detection event and/or a sensor measurement event. The sensor device 132 may also or alternatively be configured to transmit messages to the load control devices in the load control system 100 via a wired communication link in response to a sensor detection event and/or a sensor measurement event.

The sensor device 132 may operate as an ambient light sensor or a daylight sensor and may be capable of performing a sensor measurement event by measuring a total light intensity in the space around the sensor device 132. The sensor device 132 may transmit messages including the measured light level and/or control instructions based on the measured light level via the RF signals 108. Examples of load control systems having daylight sensors are described in greater detail in commonly assigned U.S. Pat. No. 8,410,706, issued Apr. 2, 2013, entitled METHOD OF CALIBRATING A DAYLIGHT SENSOR; and U.S. Pat. No. 8,451,116, issued May 28, 2013, entitled WIRELESS BATTERY POWERED DAYLIGHT SENSOR, the entire disclosures of which are hereby incorporated by reference.

Additionally or alternatively, the sensor device 132 may operate as an occupancy sensor and/or a vacancy sensor configured to detect occupancy and/or vacancy conditions in the load control environment 102. The sensor device 132 may be capable of performing a sensor detection event by detecting an occupancy condition or a vacancy condition in response to occupancy or vacancy, respectively, of an occupant in the load control environment 102. For example, the sensor device 132 may comprise a passive infrared (PIR) sensor capable of detecting the occupancy condition or the vacancy condition in response to the presence or absence, respectively, of the occupant. The sensor device 132 may transmit messages including the occupancy conditions or vacancy conditions, and/or control instructions generated in response to the occupancy and/or vacancy conditions. Examples of load control systems having occupancy and vacancy sensors are described in greater detail in commonly-assigned U.S. Pat. No. 8,228,184, issued Jul. 24, 2012, entitled BATTERY-POWERED OCCUPANCY SENSOR, and U.S. Pat. No. 8,009,042, issued Aug. 30, 2011, entitled RADIO-FREQUENCY LIGHTING CONTROL SYSTEM WITH OCCUPANCY SENSING, the entire disclosures of which are hereby incorporated by reference.

Additionally or alternatively, the sensor device 132 may operate as a visible light sensor (e.g., including a camera and/or other device capable of sensing visible light). The sensor device 132 may be capable of performing the sensor detection event and/or sensor measurement event by processing one or more images of the load control environment 102 (e.g., as recorded by the camera). For example, the sensor device 132 may comprise a visible light sensing circuit having an image recording circuit (e.g., such as a camera) and an image processing circuit. The image processing circuit may comprise a digital signal processor (DSP), a microprocessor, a programmable logic device (PLD), a microcontroller, an application specific integrated circuit (ASIC), a field-programmable gate array (FPGA), or any suitable processing device capable of processing images or levels of visible light. The sensor device 132 may be positioned towards the load control environment 102 to sense (e.g., detect and/or measure) one or more environmental characteristics in the load control environment 102. The image recording circuit of the sensor device 132 may be configured to record (e.g., capture) the one or more images. The image recording circuit may provide the captured image to the image processing circuit.

The image processing circuit may be configured to process the image into sensor data (e.g., one or more sense signals) that is representative of the one or more environmental characteristics. The one or more environmental characteristics may be interpreted from the sensor data (e.g., the sense signals) by a control circuit of the sensor device 132 or the sensor data (e.g., the sense signals) may be transmitted to one or more other devices (e.g., via the RF signals 108, 109) for interpreting the one or more environmental characteristics. For example, the one or more environmental characteristics interpreted from the sensor data (e.g., the sense signals) may comprise an occurrence of movement, an amount of movement, a direction of movement, a velocity of movement, a counted number of occupants, an occupancy condition, a vacancy condition, a light intensity, a color of visible light, a color temperature of visible light, an amount of direct sunlight penetration, or another environmental characteristic in the load control environment 102. In another example, the sensor device 132 may provide a raw image or a processed (e.g., preprocessed) image to one or more other devices in the load control system 100 for further processing. The sensor device 132 may operate as a color temperature sensor when sensing the color temperature of the visible light. Examples of load control systems having visible light sensors are described in greater detail in commonly-assigned U.S. Pat. No. 10,264,651, issued Apr. 16, 2019, entitled LOAD CONTROL SYSTEM HAVING A VISIBLE LIGHT SENSOR, and U.S. Pat. No. 11,600,071, issued Mar. 7, 2023, entitled CONFIGURATION OF A VISIBLE LIGHT SENSOR, the entire disclosures of which are hereby incorporated by reference.

In some examples, the sensor device 132 may be external to the lighting fixtures 124 (e.g., affixed or attached to a ceiling or a wall of the load control environment 102). The sensor device 132 may be positioned towards the load control environment 102 and may be capable of performing sensor measurement events in the load control environment 102. In one example, the sensor device 132 may be affixed or attached to a window 104 of the load control environment 102 and operate as a window sensor that is capable performing sensor measurement events on light that is entering the load control environment 102 through the window 104. For example, the sensor device 132 may comprise an ambient light sensor capable of detecting when sunlight is directly shining into the sensor device 132, is reflected onto the sensor device 132, and/or is blocked by external means, such as clouds or a building based on the measured light levels being received by the sensor device 132 from outside the window. The sensor device 132 may transmit messages indicating the measured light level. Though illustrated as being external to the lighting fixtures 124, one or more sensor devices 132 may be mounted to one or more of the lighting fixtures 124 (e.g., on a lower or outward-facing surface of the lighting fixture 124). For example, one or more sensor devices 132 may be electrically coupled to a control circuit or a load control circuit of the load control devices 120 for performing control in response to the sensor detection events and/or the sensor measurement events sensed (e.g., detected and/or measured) by the sensor devices 132.

The load control system 100 may comprise other types of input devices, such as, for example, temperature sensors; humidity sensors; radiometers; cloudy-day sensors; shadow sensors; pressure sensors; smoke detectors; carbon monoxide detectors; air-quality sensors; motion sensors; security sensors; proximity sensors; fixture sensors; partition sensors; keypads; multi-zone control units; slider control units; kinetic or solar-powered remote controls; key fobs; cell phones; smart phones; tablets; personal digital assistants; personal computers; laptops; timeclocks; audio-visual controls; safety devices; power monitoring devices (e.g., such as power meters, energy meters, utility submeters, utility rate meters, etc.); central control transmitters; residential, commercial, or industrial controllers; and/or one or more other types of input devices.

The input devices and the load control devices of the load control system 100 may be configured to communicate messages between one another on a network (e.g., a control system network) within the load control system 100. For example, the network may be a mesh network on which the input devices and the load control devices of the load control system 100 communicate using a mesh network wireless communication protocol (e.g., the THREAD protocol, the CLEAR CONNECT X protocol, or other suitable protocol). The mesh network may include communication paths between different devices, which may include one or more hops (e.g., communication links). For example a communication path between a first control device and a second control device may include a hop between the first control device and a third control device, and a second hop between the third control device and the second control device. The network (e.g., on which the input devices and the load control devices of the load control system 100 may communicate) may comprise one or more network communication links (e.g., attachments) through which messages may be transmitted for performing end-to-end communications in the load control system 100. For example, the input devices and the load control devices may be capable of communicating messages directly to one another via the RF signals 108. The RF signals 108 may be transmitted using a proprietary RF protocol, such as the CLEAR CONNECT protocol (e.g., CLEAR CONNECT TYPE A and/or CLEAR CONNECT TYPE X protocols and/or a standard protocol, for example, one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD protocols, for a different protocol. In an example, the input devices may transmit messages to the load control devices via the RF signals 108 that comprise input events (e.g., button presses, sensor measurement events, or other input event) or control instructions generated in response to the input events for performing control of the electrical loads controlled by the load control devices. The input devices and the load control devices may be configured to communicate via the RF signals 108 on a first wireless communication link via a first wireless communication protocol (e.g., a wireless network communication protocol, such as THREAD, CLEAR CONNECT TYPE A, CLEAR CONNECT TYPE X, WIFI, etc.) and communicate via the RF signals 109 on a second wireless communication link via a second wireless communication protocol (e.g., a short-range wireless communication protocol, such as BLUETOOTH, BLE, etc.). Though communication links may be described as a wireless communication links, wired communication links may similarly be implemented for enabling communications herein.

In some examples, for each of the control devices in the load control system 100 to be responsive to the messages directed to the respective control device, the control device may be associated with one another by performing an association procedure. For example, for a load control device to be responsive to messages transmitted by an input device, the input device may first be associated with the load control device. As one example of an association procedure, one of the control devices may be put in an association mode for sharing a unique identifier for being associated with and/or stored at one or more of the other control devices in the load control system 100. For example, an input device and a load control device may be put in an association mode by a user actuating a button on the input device and/or the load control device. The actuation of the button on the input device and/or the load control device may place the input device and/or the load control device in the association mode for being associated with one another. In the association mode, the input device may transmit an association message(s) to the load control device. The association message from the input device may include a unique identifier of the input device. The load control device may locally store the unique identifier of the input device in association information, such that the load control device may be capable of be responsive to messages (e.g., subsequent messages) from the input device that may include load control instructions (e.g., commands). The association information stored at the load control device may include the unique identifiers of the devices with which the load control device is associated. The load control device may be configured to respond to the messages from the associated input device by controlling a corresponding electrical load according to the load control instructions received in the messages. The input device may also store the unique identifier of the load control device with which it is being associated in association information stored locally thereon. A similar association procedure may be performed between other control devices in the load control system 100 to enable each control device to perform communication of messages with associated devices. This is merely one example of how control devices may communicate and be associated with one another and other examples are possible.

According to another example, one or more of the control devices of the load control system 100 may receive system configuration data (e.g., or subsequent updates to the system configuration data) that is uploaded to the control devices and that specifies the association information comprising the unique identifiers of the control devices for being associated. The system configuration data may comprise a load control dataset that defines the operation of the control devices and operational settings of the load control system 100. The system configuration data may include information about the control devices in the user environment 102 and/or the load control system 100, including configuration identifiers (e.g., fixture identifiers or load control device identifiers, groups, zones, areas, and/or location identifiers) of the control devices. For example, the system configuration data may include association information that indicates defined associations between control devices in the load control system 100. The association information may be updated using any of the association procedures described herein.

One or more intermediary devices may also maintain association information that includes the unique identifiers that make up the associations of other control devices in the load control system 100. For example, the input devices and the load control devices may communicate on a communication link in the load control system 100 through one or more other intermediary devices, such as router devices or other devices in the network of the load control system 100. The intermediary devices may comprise input devices, load control devices, a central processing device, or another intermediary device capable of enabling communication between devices in the load control system. The association information that is maintained on the intermediary devices may comprise the unique identifiers of the control devices that are associated with one another for identifying and/or enabling communication of messages between control devices in the load control system 100. For example, an intermediary device may identify the unique identifiers being transmitted in association messages between control devices during the association procedure and store the unique identifiers of the control devices as an association in the association information. The intermediary devices may use the association information for monitoring and/or routing communications on a communication link between devices in the load control system 100. In another example, the association information of other devices may be uploaded to the intermediary device and/or communicated from the intermediary device to the other devices for being locally stored thereon (e.g., at the input devices and/or load control devices).

The load control system 100 may comprise a system controller 110. For example, the system controller 110 may operate as a central processing device the load control system 100. The system controller 110 may be configured to communicate messages between the control devices of the load control system 100 (e.g., between the input devices and the load control devices). In some examples, the system controller 100 may operate as an intermediary device, as described herein. For example, the system controller 110 may be configured to receive messages from the input devices and transmit messages to the load control devices in response to the messages received from the input devices. The system controller 110 may route the messages based on the association information stored thereon.

The system controller 110 may be configured to transmit and receive messages over one or more wireless communication links (e.g., via the RF signals 108) and/or over one or more wired communication links. The system controller 110 may be configured to communicate via one or more networks, such as the network of the load control system 100. In addition, the system controller 110 may be configured to communicate via a local area network (LAN), e.g., for access to the Internet. The system controller 110 may be wirelessly connected to the local area network using one or more wireless protocols. The system controller 110 may be coupled to the local area network via a wired communication link, such as a network communication bus (e.g., an Ethernet communication link). The system controller 110 may be configured to communicate via the local area network with one or more computing devices, e.g., such as a mobile device 190, such as, a personal computing device and/or a wearable wireless device. The mobile device 190 may be a user device located on an user 192, for example, may be attached to the user's body or clothing or may be held by the user. The mobile device 190 may be characterized by a unique identifier (e.g., a serial number or address stored in memory) that uniquely identifies the mobile device 190 and thus the user 192. Examples of personal computing devices may include a smart phone, a laptop, and/or a tablet device. Examples of wearable wireless devices may include an activity tracking device, a smart watch, smart clothing, and/or smart glasses. The load control system 100 may comprise other types of computing devices coupled to the local area network, such as a desktop personal computer (PC), a wireless-communication-capable television, or any other suitable Internet-Protocol-enabled device. In addition, the system controller 110 may be configured to communicate via the local area network with one or more other control systems (e.g., a building management system, a security system, etc.).

The mobile device 190 may be configured to transmit messages to the system controller 110, for example, in one or more Internet Protocol packets. For example, the mobile device 190 may be configured to transmit messages to the system controller 110 via the local area network and/or the Internet. The mobile device 190 may be configured to transmit messages via the local area network and/or the Internet to an external service, and then the messages may be received by the system controller 110. The mobile device 190 may transmit and receive messages via RF signals 109. The RF signals 109 may be the same signal type and/or transmitted using the same protocol as the RF signals 108. Alternatively, or additionally, the mobile device 190 may be configured to transmit the RF signals 109 according to a different signal type and/or protocol than the RF signals 108. The mobile device 190 and/or the system controller 110 may be capable of communicating on communication links with other devices via RF signals 108, 109.

The operation of the load control system 100 may be programmed and configured using, for example, the mobile device 190 or another computing device (e.g., when the mobile device is a personal computing device). The mobile device 190 may execute a graphical user interface (GUI) configuration software for allowing the user 192 to program how the load control system 100 will operate. For example, the configuration software may run as a PC application or a web interface. The configuration software may be executed locally at the mobile device 190 and/or on the system controller 110. For example, the configuration software may be executed as a local application on the mobile device 190 that communicates with the system controller 110 and/or the load control devices to operate as described herein. In another example, the configuration software may execute on the system controller 110 and may be displayed on the mobile device 190 via a local application (e.g., a browser) for displaying the GUI. The configuration software and/or the system controller 110 (e.g., via instructions from the configuration software) may generate the system configuration data that may include the load control dataset that defines the operation of the load control system 100. For example, the load control dataset may include information regarding the operational settings of different load control devices of the load control system (e.g., the lighting control device 120, the plug-in load control device 140, the motorized window treatments 150, and/or the thermostat 160). The load control dataset may comprise information regarding how the load control devices respond to inputs received from the input devices. Examples of configuration procedures for load control systems are described in greater detail in commonly-assigned U.S. Pat. No. 10,027,127, issued Jul. 17, 2018, entitled COMMISSIONING LOAD CONTROL SYSTEMS, the entire disclosure of which is hereby incorporated by reference.

The load control system 100 may also include a network configuration device 111. The network configuration device 111 may be configured to communicate over the network through which the control devices of the load control system 100 communicate with each other (e.g., the control system network). The network configuration device 111 may be configured to administer or oversee the network on which control devices are communicating. For example, the network configuration device 111 may be configured to assign roles to the control devices in the network during initial setup and commissioning or during an procedure for adjusting network behavior and/or network operation, as further described herein. The network configuration device 111 may be a temporary devices of the load control system 100. For example, the network configuration device 111 may temporarily join the network of the load control system 100 and later be removed from the network of the load control system 100 (e.g., after performing one or more of the procedures described herein). Further, the network configuration device 111 may be physically installed at the load control system 100, or an external device that accesses the load control system 100 via the internet and/or an external network or cloud. As described herein, the network configuration device 111 may be a distinct device added to the network or a role that is assigned to a given device in the load control system 100.

The network configuration device 111 may be configured to perform one or more of the procedures further described herein. For example, the network configuration device 111 may be added to and/or installed at the load control system 100 to perform one or more of the procedures described herein, which may include joining and/or communicating over the network. The network configuration device 111 may then be removed and/or uninstalled from the load control system, for example, after completion of the procedure. In a scenario in which the network configuration device may access the load control system 100 via the local area network and/or the Internet (e.g., an external network and/or the cloud), the network configuration device 111 may receive information remotely that may be used to perform the procedures described herein.

FIG. 1B is a block diagram illustrating an example of a processing device 170 capable of processing and/or communication in a load control system, such as the load control system 100 of FIG. 1A. In an example, the processing device 170 may be a control device capable of transmitting and/or receiving messages. The processing device 170 may be in an input device, such as the remote control device 130, the sensor device 132 (e.g., an occupancy sensor or another sensor device), or another input device capable of transmitting messages to load control devices or other devices in the load control system 100. The processing device 170 may be a computing device, such as the system controller 110, the network configuration device 111, the mobile device 190, or another computing device in the load control system 100.

The processing device 170 may include a control circuit 171 for controlling the functionality of the processing device 170. The control circuit 171 may include one or more general purpose processors, special purpose processors, conventional processors, digital signal processors (DSPs), microprocessors, integrated circuits, a programmable logic device (PLD), application specific integrated circuits (ASICs), or the like. The control circuit 171 may perform signal coding, data processing, image processing, power control, input/output processing, or any other functionality that enables the processing device 170 to perform as one of the control devices of the load control system (e.g., the input devices and/or the computing devices of the load control system 100) described herein.

The control circuit 171 may be communicatively coupled to a memory 172 to store information in and/or retrieve information from the memory 172. The memory 172 may comprise a computer-readable storage media or machine-readable storage media that maintains a device dataset of associated device identifiers, network data, and/or computer-executable instructions for performing as described herein. For example, the memory 172 may comprise computer-executable instructions or machine-readable instructions that when executed by the control circuit 171 configure the control circuit 171 to provide one or more portions of the procedures described herein. The control circuit 171 may access the instructions from memory 172 for being executed to cause the control circuit 171 to operate as described herein, or to operate one or more devices as described herein. The memory 172 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 172 may be implemented as one or more external integrated circuits (ICs) and/or as one or more internal circuits of the control circuit 171.

The memory 172 may comprise computer-executable instructions for executing configuration software. For example, the control circuit 171 may be configured to store in and retrieve from the memory 172 configuration data for configuring the load control devices of the load control system and/or control data for controlling the load control devices of the load control system. In addition, the control circuit 171 may be configured to store in and retrieve from the memory 172 operational settings, such as, association information (e.g., unique identifiers of control devices of the load control system), present intensities levels and/or colors of the lighting loads controlled by the load control devices of the load control system, etc. For example, the operational characteristics stored in the memory 172 may be configured during a configuration procedure of the processing device 170.

The processing device 170 may comprise a communication circuit 174 configured to communicate (e.g., transmit and/or receive) messages (e.g., digital messages). For example, the communication circuit 174 may include one or more wired and/or wireless communication circuits that are in communication with the control circuit 171 for sending and/or receiving messages as described herein. The control circuit 171 may be configured to transmit messages including control information (e.g., one or more commands) for controlling and/or configuration information for configuring the load control devices of the load control system via the communication circuit 174. In addition, the control circuit 171 may be configured to receive messages (e.g., including feedback data, such as status information of the load control devices of the load control system) from the load control devices via the communication circuit 174.

The communication circuit 174 may perform wireless and/or wired communications. The one or more wired and/or wireless communication circuits of the communication circuit 174 may be implemented as external integrated circuits (ICs) and/or as internal circuits of the control circuit 171. For example, the one or more wireless communication circuits of the communication circuit 174 may include for example, one or more a radio-frequency (RF) transceivers coupled to a respective antenna for transmitting and/or receiving RF signals. In addition, the one or more wireless communication circuits of the communication circuit 174 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 174 may be capable of performing communication via the same communication channels or different communication channels. The one or more wired communication circuits of the communication circuit 174 may be capable of communicating on a wired communication link. The wired communication link may include an Ethernet communication link, an RS-485 serial communication link, a 0-10 volt analog link, a pulse-width modulated (PWM) control link, a Digital Addressable Lighting Interface (DALI) digital communication link, and/or another wired communication link. The communication circuit 174 may be configured to communicate via power lines (e.g., the power lines from which the processing device 170 receives power) using a power line carrier (PLC) communication technique.

The one or more wired and/or wireless communication circuits of the communication circuit 174 may be configured to communicate via one or more wired and/or wireless communication networks and/or protocols. For example, a first communication circuit of the communication circuit 174 may be configured to communicate via a wired or wireless communication link, while a second communication circuit of the communication circuit 174 may be capable of communicating on another wired or wireless communication link. The first communication circuit may be configured to communicate via a first wireless communication link (e.g., a wireless network communication link) using a first wireless protocol (e.g., a wireless network communication protocol), and the second communication circuit may be configured to communicate via a second wireless communication link (e.g., a short-range or direct wireless communication link) using a second wireless protocol (e.g., a short-range wireless communication protocol).

One of the communication circuits of the communication circuit 174 may comprise a beacon transmitting and/or receiving circuit capable of transmitting and/or receiving beacons (e.g., beacon messages) via a short-range RF signal. The control circuit 171 may communicate with beacon transmitting circuit (e.g., a short-range communication circuit) of the communication circuit 174 to transmit beacons. The beacon transmitting circuit may be a one-way communication circuit (e.g., the beacon transmitting circuit is configured to transmit beacons) or a two-way communication circuit capable of receiving information on the same network and/or protocol on which the beacons are transmitted (e.g., the beacon transmitting circuit is configured to transmit and receive beacons). The information received at the beacon transmitting circuit may be provided to the control circuit 171.

The control circuit 171 may be in communication with an input/output circuit 176. The input/output circuit 176 may be included in a user interface for receiving inputs from the user of the processing device 170 and/or providing feedback to the user of the processing device 170. The input/output circuit 176 may include one or more input circuits from which inputs may be received. The input circuits of the input/output circuit 176 may include one or more actuators that may be actuated by the user to communicate user input or selections to the control circuit 171. In response to actuations of the one or more actuators, the control circuit 171 may enter an association mode, transmit association messages from the processing device 170 via the communication circuit 174, and/or receive other information (e.g., control instructions for performing control of an electrical load). In response to actuations of the one or more actuators, the control circuit 171 may perform control by transmitting control instructions indicating the actuations of the one or more actuators and/or control instructions generated based on the actuations of the one or more actuators. For example, the one or more actuators of the input/output circuit 176 may comprise respective mechanical tactile switches that may be actuated by one or more respective physical buttons of the user interface of the processing device 170. In addition, the one or more actuators of the input/output circuit 176 may comprise a potentiometer and/or a position sensing circuit that may be responsive to actuations of a rotary knob and/or a slider control. Further, the one or more actuators of the input/output circuit 176 may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from the user.

The input circuits of the input/output circuit 176 may include a sensing circuit (e.g., a sensor). The sensing circuit of the input/output circuit 176 may be an occupant sensing circuit, a temperature sensing circuit, a color (e.g., color temperature) sensing circuit, a visible light sensing circuit (e.g., a camera), a daylight sensing circuit or ambient light sensing circuit, or another sensing circuit for receiving input (e.g., sensing an environmental characteristic in the environment of the processing device 170). The control circuit 171 may receive information from the input/output circuit 176 and process the information for performing functions as described herein. For example, the control circuit 171 may transmit control instructions indicating the information received from the input/output circuit 176 and/or control instructions generated based on the information received from the input/output circuit 176.

The input/output circuit 176 may also comprise one or more output sources (e.g., output circuits) for providing output to a user and/or other control devices in the load control system. The output sources of the input/output circuit 176 may include one or more light sources (e.g., LEDs) for providing indications (e.g., feedback) to the user. The control circuit 171 may be configured to illuminate the one or more light sources different colors. The one or more light sources may be configured to illuminate, for example, one or more indicators (e.g., visible indicators) of the user interface of the processing device 170. The output sources of the input/output circuit 176 may include a display (e.g., a visible display) for providing information (e.g., feedback) to the user. The control circuit 171 and/or the display may generate a graphical user interface (GUI) via software for being displayed on the display of the input/output circuit 176.

The user interface of the processing device 170 may combine features of the input/output circuit 176. For example, the user interface may have respective buttons that actuate the one or more actuators of the input/output circuit 176 and may have respective indicators (e.g., visible indicators) that may be illuminated by the light sources of the input/output circuit 176. In another example, the display of the input/output circuit 176 and the control circuit 171 may be in two-way communication, as the display may display information to the user and include a touch screen capable of receiving user inputs from the user. The user inputs received via the touch screen may be capable of providing the indicated information received from the touch screen as information to the control circuit 171 for performing functions and/or control.

Each of the hardware circuits within the processing device 170 may be powered by a power source 178. The power source 178 may include a power supply configured to receive power from an alternating-current (AC) power supply or a direct-current (DC) power supply, for example. In addition, the power source 178 may comprise one or more batteries. The power source 178 may produce a supply voltage V_{CC} for powering the hardware within the processing device 170.

FIG. 1C is a block diagram illustrating an example load control device 180 that may be electrically coupled in series between a power source 187 (e.g., an AC power source and/or a DC power source) and an electrical load 188. For example, the load control device 180 may be a lighting control device (e.g., the lighting control device 120), such as a dimmer switch, an electronic switch, a light-emitting diode (LED) driver for an LED light source, an electronic ballast for fluorescent lamps. In addition, the load control device 180 may be a motorized window treatment (e.g., the motorized window treatments 150), a plug-in load control device (e.g., the plug-in load control device 140), a temperature control device (e.g., the temperature control device 160), and/or another load control device. In some examples, the electrical load 188 may be integral with the load control device 180, for example, when the load control device 180 is a controllable light source (e.g., a smart lamp) and/or a motorized window treatment (e.g., where the electrical load 188 is a motor integral with the motorized window treatment). In addition, the power source 187 may also be integral with the load control device 180, for example, when the load control device is a motorized window treatment (e.g., where the power source 187 is one or more batteries and/or one or more solar cells that are integral with the motorized window treatment).

The load control device 180 may include a control circuit 181 for controlling the functionality of the load control device 180. The control circuit 181 may include one or more general purpose processors, special purpose processors, conventional processors, digital signal processors (DSPs), microprocessors, integrated circuits, a programmable logic device (PLD), application specific integrated circuits (ASICs), or the like. The control circuit 181 may perform signal coding, data processing, image processing, power control, input/output processing, or any other functionality that enables the load control device 180 to perform as one of the control devices of the load control system (e.g., the load control devices of the load control system 100) described herein.

The load control device 180 may include a load control circuit 185 that may be electrically coupled in series between the power source 187 and the electrical load 188. The control circuit 181 may be configured to control the load control circuit 185 for controlling the electrical load 188, for example, in response to received control instructions (e.g., commands). For example, the electrical load 188 may comprise a lighting load, such as incandescent lamp, a LED light source, a fluorescent lamp, and other suitable light sources. In addition, the electrical load 188 may comprise, for example, a motor load, such as an external motor (e.g., for a ceiling fan and/or exhaust fan) or an internal motor (e.g., for a motorized window treatment). Further, the electrical load 188 may comprise, for example, a component of a heating, ventilation, and cooling (HVAC) system, an appliance (e.g., a speaker, a television, a visible display, or other switched electrical device), and/or any other type of electrical load.

The control circuit 181 may be communicatively coupled to a memory 182 to store information in and/or retrieve information from the memory 182. The memory 182 may comprise a computer-readable storage media or machine-readable storage media that maintains a device dataset of associated device identifiers, network data, and/or computer-executable instructions for performing as described herein. For example, the memory 182 may comprise computer-executable instructions or machine-readable instructions that that when executed by the control circuit 171 configure the control circuit 171 to provide one or more portions of the procedures described herein. The control circuit 181 may access the instructions from memory 182 for being executed to cause the control circuit 181 to operate as described herein, or to operate one or more devices as described herein. The memory 182 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 182 may be implemented as one or more external integrated circuits (ICs) or as one or more internal circuits of the control circuit 181.

The memory 182 may comprise computer-executable instructions for executing configuration software. For example, the control circuit 181 may be configured to store in and retrieve from the memory 182 configuration data for configuring the load control device 180 for operation in the load control system and/or control data for controlling the load control circuit 185 of the load control device 180. In addition, the control circuit 181 may be configured to store in and retrieve from the memory 182 operational settings, such as, association information (e.g., unique identifiers of control devices of the load control system), present intensities levels and/or colors of the electrical load 188 controlled by the load control device 180 (e.g., when the electrical load 188 is a lighting load), etc. For example, the operational characteristics stored in the memory 182 may be configured during a configuration procedure of the load control device 180.

The load control device 180 may comprise a communication circuit 184 configured to communicate (e.g., transmit and/or receive) messages (e.g., digital messages). For example, the communication circuit 184 may one or more wired and/or wireless communication circuits that are in communication with the control circuit 181 for sending and/or receiving messages as described herein. The control circuit 181 may be configured to receive messages including control information (e.g., one or more commands) for controlling the electrical load 188 via the communication circuit 184. The control circuit 181 may be responsive to the control information in messages that include a device identifier (e.g., a unique identifier of the load control device 180, such as a serial number). The control circuit 181 may use the control information to control the load control circuit 185 to control the electrical load 188. In addition, the control circuit 181 may be configured to transmit, to an external load control device via the communication circuit 184, messages including control information (e.g., one or more commands) for controlling an electrical load controlled by the external load control device. The control circuit 181 may be configured to receive messages including configuration information for configuring the load control device 180.

The communication circuit 184 may perform wireless and/or wired communications. The one or more wired and/or wireless communication circuits of the communication circuit 184 may be implemented as external integrated circuits (ICs) and/or as internal circuits of the control circuit 181. For example, the one or more wireless communication circuits of the communication circuit 184 may include for example, one or more a radio-frequency (RF) transceivers coupled to a respective antenna for transmitting and/or receiving RF signals. In addition, the one or more wireless communication circuits of the communication circuit 184 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 184 may be capable of performing communication via the same communication channels or different communication channels. The one or more wired communication circuits of the communication circuit 184 may be capable of communicating on a wired communication link. The wired communication link may include an Ethernet communication link, an RS-485 serial communication link, a 0-10 volt analog link, a pulse-width modulated (PWM) control link, a Digital Addressable Lighting Interface (DALI) digital communication link, and/or another wired communication link. The communication circuit 184 may be configured to communicate via power lines (e.g., the power lines from which the load control device 180 receives power) using a power line carrier (PLC) communication technique.

The one or more wired and/or wireless communication circuits of the communication circuit 184 configured to communicate via one or more wired and/or wireless communication networks and/or protocols. For example, a first communication circuit of the communication circuit 184 may be configured to communicate via a wired or wireless communication link, while a second communication circuit of the communication circuit 184 may be capable of communicating on another wired or wireless communication link. The first communication circuit may be configured to communicate via a first wireless communication link (e.g., a wireless network communication link) using a first wireless protocol (e.g., a wireless network communication protocol, such as the CLEAR CONNECT (e.g., CLEAR CONNECT A and/or CLEAR CONNECT X) and/or THREAD protocols), and the second communication circuit may be configured to communicate via a second wireless communication link (e.g., a short-range or direct wireless communication link) using a second wireless protocol (e.g., a short-range wireless communication protocol, such as the BLUETOOTH and/or BLUETOOTH LOW ENERGY (BLE) protocols).

One of the communication circuits of the communication circuit 184 may comprise a beacon transmitting and/or receiving circuit capable of transmitting and/or receiving beacons (e.g., beacon messages) via a short-range RF signal. A control circuit 181 may communicate with beacon transmitting circuit (e.g., a short-range communication circuit) of the communication circuit 184 to transmit beacons. The beacon transmitting circuit may be a one-way communication circuit (e.g., the beacon transmitting circuit is configured to transmit beacons) or a two-way communication circuit capable of receiving information on the same network and/or protocol on which the beacons are transmitted (e.g., the beacon transmitting circuit is configured to transmit and receive beacons). The information received at the beacon transmitting circuit may be provided to the control circuit 181.

The control circuit 181 may be in communication with a user interface circuit 186. The input/output circuit 186 may be included in a user interface for receiving inputs from the user of the processing device 180 and/or providing feedback to the user of the processing device 180. The input/output circuit 186 may include one or more input circuits from which inputs may be received. The input circuits of the input/output circuit 186 may include one or more actuators that may be actuated by the user to communicate user input or selections to the control circuit 181. In response to actuations of the one or more actuators, the control circuit 181 may enter an association mode, transmit association messages from the load control device 180 via the communication circuits 184, and/or receive other information (e.g., control instructions for performing control of the electrical load 188). In response to actuations of the one or more actuators, the control circuit 181 may perform control by controlling the load control circuit 185 to control the electrical load 188, and/or by transmitting control instructions indicating the actuations of the one or more actuator and/or control instructions generated based on the actuations of the one or more actuators. For example, the one or more actuators of the input/output circuit 186 may comprise respective mechanical tactile switches that may be actuated by one or more respective physical buttons of the user interface of the load control device 180. In addition, the one or more actuators of the input/output circuit 186 may comprise a potentiometer and/or a position sensing circuit that may be responsive to actuations of a rotary knob and/or a slider control. Further, the actuators of the input/output circuit 186 may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from the user.

The input circuits of the input/output circuit 186 may include a sensing circuit (e.g., a sensor). The sensing circuit of the input/output circuit 186 may be an occupant sensing circuit, a temperature sensing circuit, a color (e.g., color temperature) sensing circuit, a visible light sensing circuit (e.g., a camera), a daylight sensing circuit or ambient light sensing circuit, or another sensing circuit for receiving input (e.g., sensing an environmental characteristic in the environment of the load device 180). The control circuit 181 may receive information from the input/output circuit 186 and process the information for performing functions as described herein. For example, the control circuit 181 may control the load control circuit 185 to control the electrical load 188 in response to the information received from the input/output circuit 186.

The input/output circuit 186 may also comprise one or more output sources (e.g., output circuits) for providing output to a user or other control devices in the load control system. For example, the output sources may include one or more light sources (e.g., LEDs) for providing indications (e.g., feedback) to the user. The control circuit 181 may be configured to illuminate the one or more light sources different colors. The one or more light sources may be configured to illuminate, for example, one or more indicators (e.g., visible indicators) of the user interface of the load control device 180. The output sources of the input/output circuit 186 may include a display (e.g., a visible display) for providing information (e.g., feedback) to the user. The control circuit 181 and/or the display may generate a graphical user interface (GUI) via software for being displayed on the display of the input/output circuit 186.

The user interface of the load control device 180 may combine features of the input/output circuit 186. For example, the user interface may have respective buttons that actuate the one or more actuators of the input/output circuit 186 and may have respective indicators (e.g., visible indicators) that may be illuminated by the light sources of the input/output circuit 186. In another example, the display of the input/output circuit 186 and the control circuit 181 may be in two-way communication, as the display may display information to the user and include a touch screen capable of receiving user inputs from the user. The user inputs received via the touch screen may be capable of providing the indicated information received from the touch screen as information to the control circuit 181 for performing functions and/or control.

As described herein, a network (e.g., a control system network) may be used to facilitate communication between the respective control devices (e.g., input devices, load control devices, and/or a system controller) of a load control system (e.g., the load control system 100 of FIG. 1A). For a respective control device to communicate with other control devices in the network, the control device may be configured to first join the network, for example, by initiating a commissioning procedure. The commission procedure may include a claiming procedure, a joining procedure, and/or an attachment procedure. The claiming procedure may be used to discover and claim control devices for being added to the network. For example, the control devices in the load control system may be claimed using a mobile device (e.g., the mobile device 190). Each control device may be claimed by the mobile device for joining the network (e.g., via a joining procedure), and/or attaching to other devices in the network (e.g., via an attachment procedure). Each control device may transmit a beacon (e.g., a beacon message) via a short-range wireless communication link. The mobile device may discover (e.g., receive) beacons transmitted by the control devices in the load control system. Each beacon may include a unique beacon identifier of the control device that transmitted the respective beacon. The unique beacon identifier may include a unique device identifier (e.g., serial number) of the control device itself.

The mobile device may identify one or more control devices from which a respective beacon was received having a communication quality metric (e.g., a received signal strength indicator (RSSI) or other communication quality metric) above a predefined value. For example, the mobile device may identify one or more of the control devices transmitting the beacons that are received having the strongest received signal strength indicators, and transmit a connection message to the control devices from which the beacons having the strongest received signal strength indicators were received. The control devices that receive the connection message from the mobile device may be configured to establish a connection (e.g., a two-way communication connection) with the mobile device.

The mobile device may transmit the connection message to one of the control devices to indicate that the respective control device has been selected for claiming. The connection message may operate as a claiming message, or a separate claiming message may be sent after the connection is established between the mobile device and the control device. The claiming message may indicate that the control device has been claimed for being added (e.g., joined) to the network. In response to receiving the claiming message, the control device may transmit a claim confirmation message to the mobile device. The claim confirmation message may include configuration information that may be used to join the control device to the network. For example, the configuration information may include a unique device identifier (e.g., serial number) of the control device and/or network credentials for joining a network. The network credentials may include a network key for the network, a network address for the control device (e.g., a network address) and/or a joiner identifier for the control device. The network address and/or the joining identifier may be used during the joining procedure to allow the control device to join the network.

The user may move the mobile device around a load control environment (e.g., the load control environment 102) in which the load control system is installed to perform the claiming procedure with a plurality of control devices. When the user is done claiming control devices (e.g., the mobile device has claimed each of the control devices or a portion of the control devices of the load control system), the mobile device may upload the configuration information from the claimed devices to a central processing device, such as a system controller (e.g., the system controller 110). The uploaded configuration information may be used to identify the control devices for being joined to the network. As described herein, the system controller may be installed at the space being commissioned, or may be a remote computing device. Though the mobile device is described as the device performing communications with the control devices during the claiming procedure, other devices in the load control system 100 may perform similar communications with the control devices during the claiming procedure (e.g., the network configuration device 111 and/or another computing device of the load control system 100).

During the joining procedure, the control device may look for a network to join. For example, the control device may begin the joining procedure after being claimed using the claiming procedure. As described herein, during the joining procedure, the control device may transmit and/or receive joining messages (e.g., message to join a wireless network, such as joining request messages and/or joining response messages). As a result of the joining procedure, and as further described herein, the control device may be configured with a network key that may allow the device to send and/or receive messages over the network.

After the control device joins the network, the control device may, for example, attempt to attach to another device (e.g., during the attachment procedure) in the network to form the mesh network (e.g., formation of the network). A network may be formed when a leader device begins transmitting network status advertisement messages on the network and/or one or more control devices attaches to the leader device or another control device on the network. In order to attach to another device in the network, the control device may send and receive a number of attachment messages via the network.

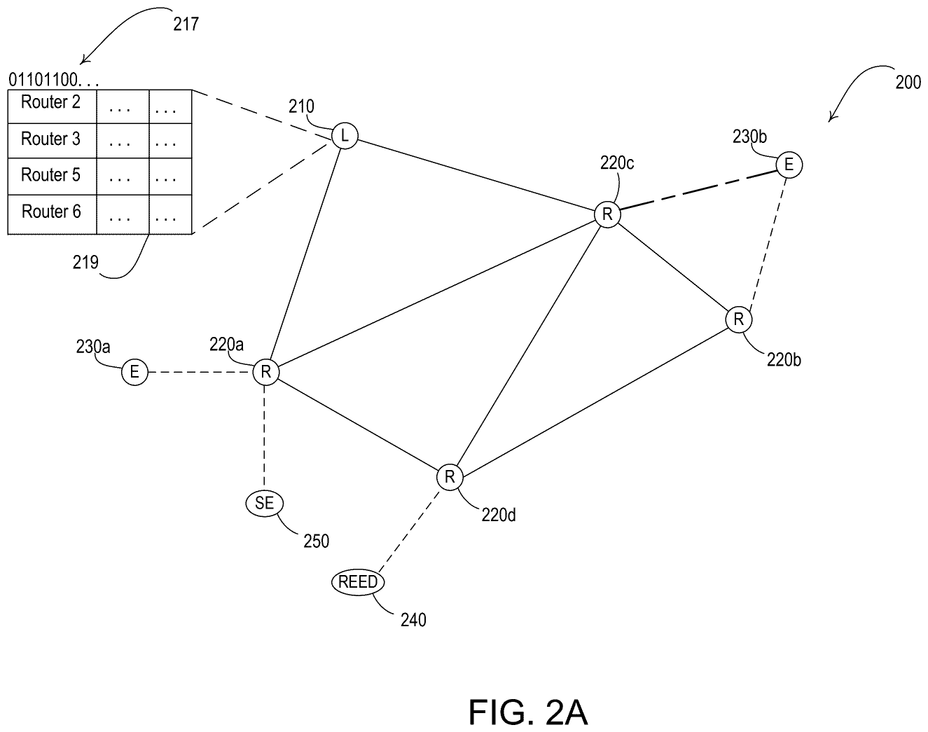

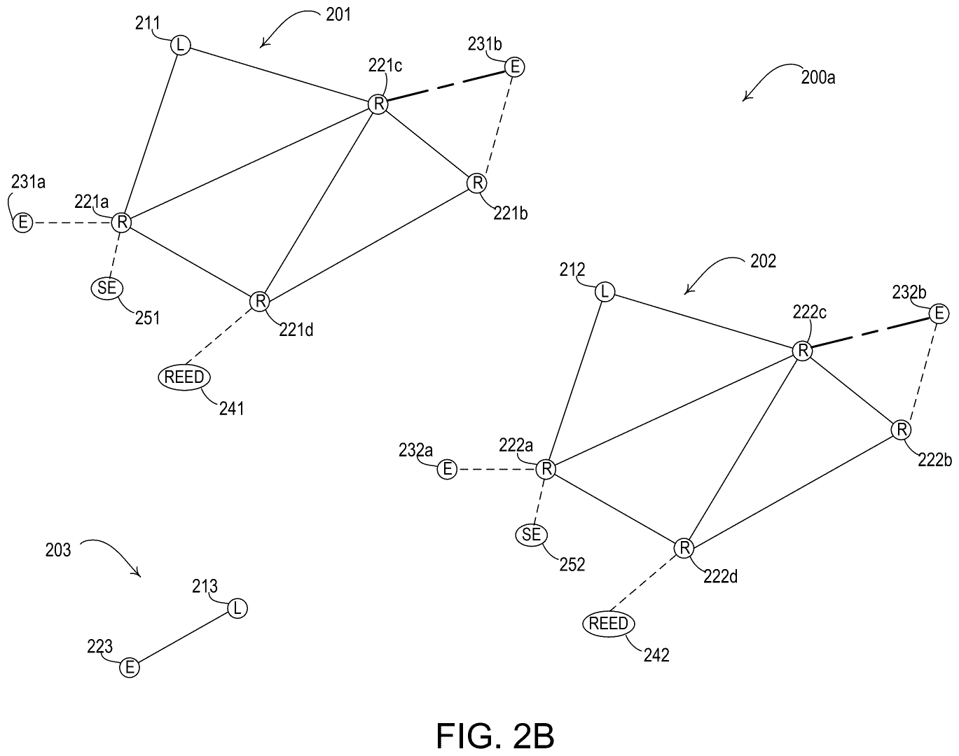

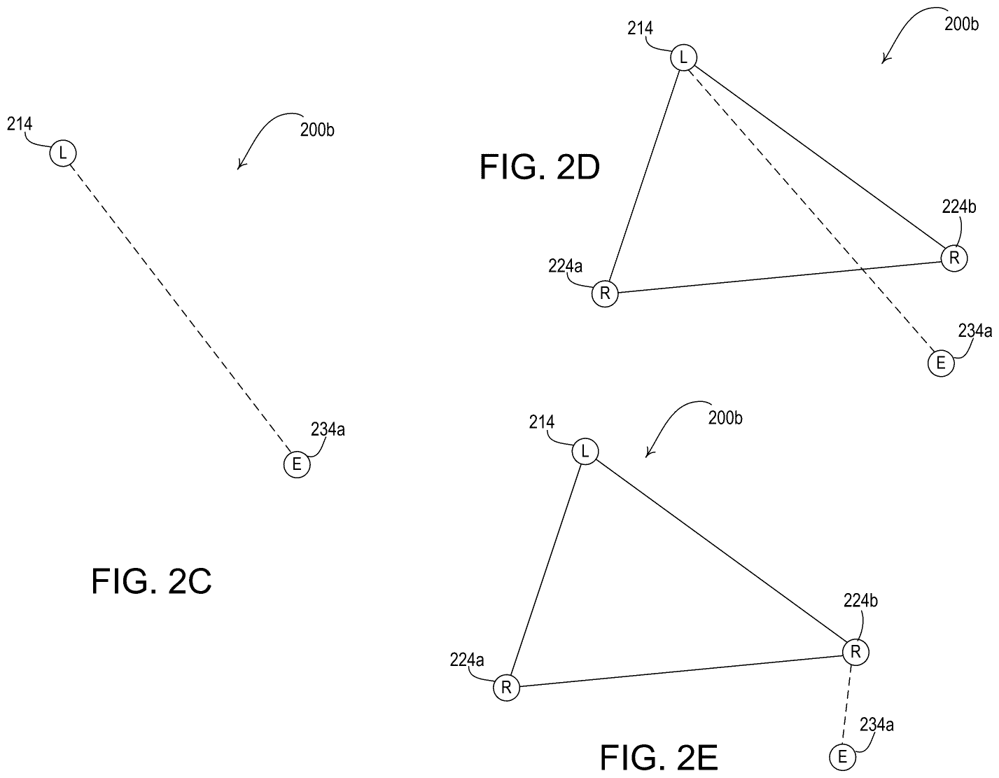

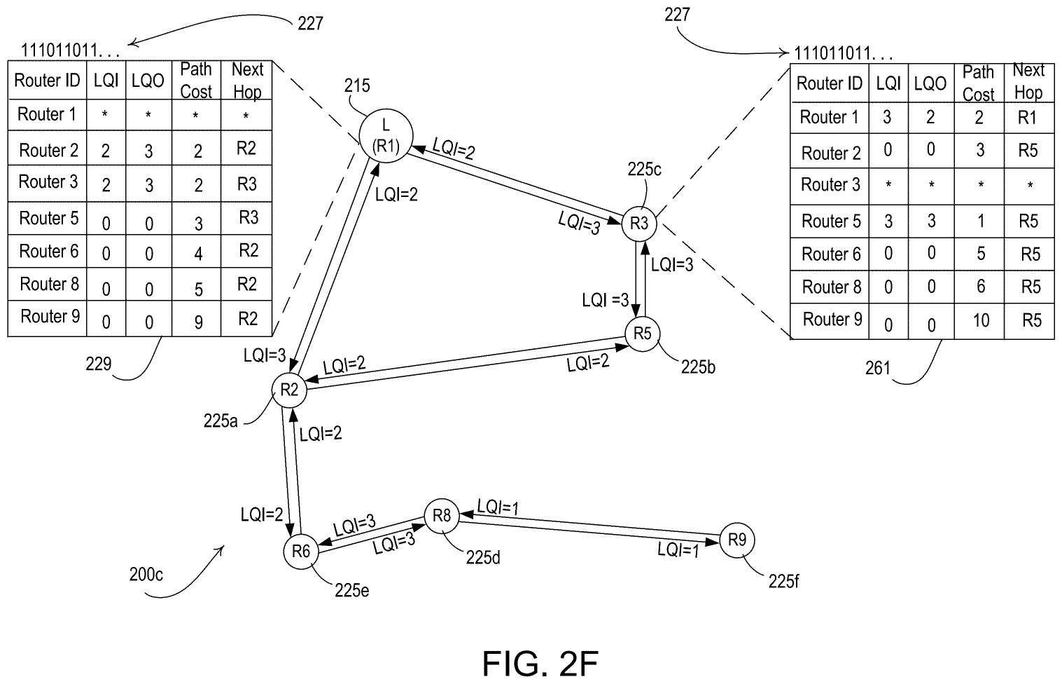

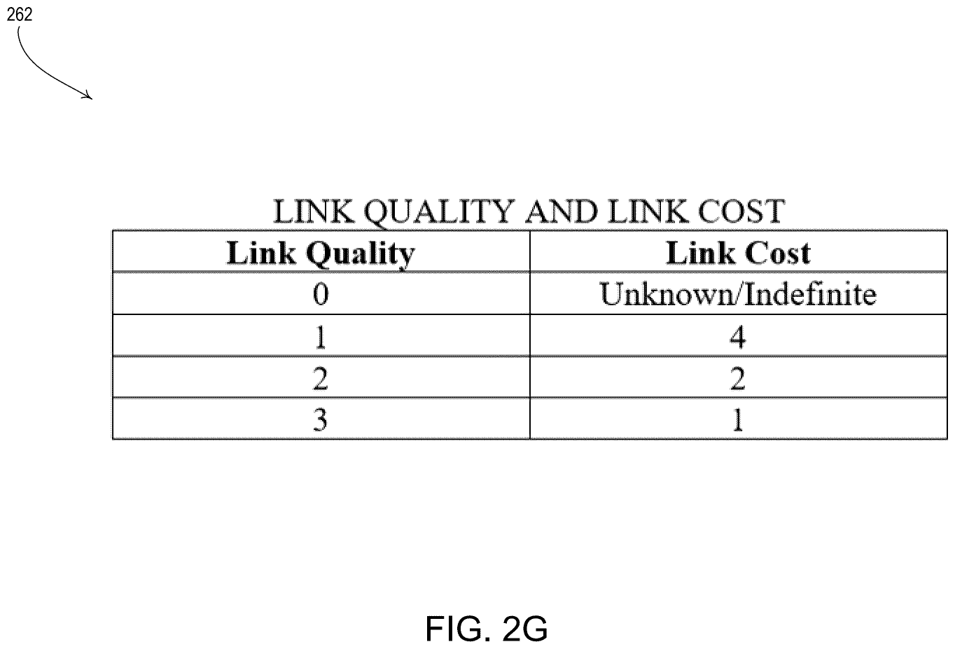

FIGS. 2A-2F illustrate examples of networks and/or network partitions. FIG. 2A is an illustration of an example network 200 that may allow for communication between control devices in a load control system (e.g., the load control system 100 of FIG. 1A). The network 200 may include any suitable network to facilitate communications in a load control system (e.g., such as the load control system 100 shown in FIG. 1A). For example, the network 200 may be a mesh network on which the control devices communicate using a mesh network wireless communication protocol (e.g., the THREAD protocol, the CLEAR CONNECT X protocol, or other suitable protocol). For example, the various control devices of the load control system 100 of FIG. 1A may communicate with each other via the network 200 of FIG. 2A. As shown in FIG. 2A, the network 200 may comprise a single network partition. In addition, the network 200 may be an example of a network partition (e.g., a subnetwork or subnet) within a larger network (e.g., which may be composed of a plurality of network partitions). The network 200 is an example network and the techniques described herein may be applied to other networks, for example, that include more or less control devices than the network 200.

Each of the control devices may form one or more attachments with other control devices to form the network 200. The circled nodes of FIG. 2A may represent control devices that are attached to other control devices in the network 200 (e.g., the various control devices of the load control system 100). Each of the control devices may be attached to at least one other control device in the network 200 in order to be able the respective control device to communicate via the network 200. A control device that is attached to at least one other control device in the network 200 may then be configured to communicate with the other control devices in the network 200 (e.g., those control devices that are attached to at least one other control device in the network 200). Communication within the network 200 may be facilitated by network communication links (e.g., attachments) established within the network 200. The network 200 may comprise one or more network communication links through which messages may be transmitted for performing end-to-end communications between the control devices (e.g., the control devices in the load control system 100). Referring to FIG. 2A, the network communication links between the control devices in the network 200 may be indicated by lines (e.g., solid and dashed lines) that connect the respective control devices.

One or more communication links between the control device in the network 200 may establish a communication path in the network 200 for transmitting one or more messages from a transmitting device to an intended recipient device (e.g., either directly to the intended recipient device and/or on a communication path to the intended recipient). Each communication link in a communication path from a transmitting device to an intended recipient may be referred to as a hop. As illustrated in FIG. 2A, there may be one or multiple communication paths in the network 200 over which messages may be communicated. Embodiments are described herein for identifying a communication path over which messages may be routed from a transmitting device to one or more intended recipients. The control devices in the network 200 may store routing information related to one or more communication paths for routing messages in the network 200, as described herein.

The control devices that are attached to at least one other device in the network 200 may take on and/or be assigned a respective role in the network 200. The roles of the control devices may be stored in the routing information on respective control devices in the network 200. For example, the roles may include: a leader device (e.g., a leader device 210), a router device (e.g., router devices 220a-220d), and an end device (e.g., end devices 230a and 230b, a router-eligible end device (REED) 240, and/or a sleepy end device 250). The role of a control device may indicate the functions and/or capabilities of the control device with respect to the network 200. As described herein, each of the end devices may have specific capabilities when taking on the role of end device (e.g., the router-eligible end device 240 and/or the sleepy end device 250). Router devices may include border router devices. A border router device may be a router device configured to provide connectivity to adjacent networks on other physical layers (e.g., WIFI and/or Ethernet networks) to provide access to the Internet.

The network 200 may include a leader device 210 and one or more router devices 220a-220d (e.g., as shown in FIG. 2A). The leader device 210 may manage other control devices in the network 200. For example, the leader device 210 may maintain router identifiers (e.g., router IDs) for each of the router devices 220. Each of the router devices 220a-220d may be assigned a unique router identifier. The leader device 210 may be configured as the gateway for the network 200 or configured with other function to allow for communication between control devices in the network 200. For example, the leader device 210 may be a control device that facilitates communication (e.g., routes and receives messages to and from) between the network 200 and other networks or network partitions. For example, a system controller of a load control system (e.g., the system controller 110 of the load control system 100 shown in FIG. 1A) may be may be assigned to the role of the leader device. In addition, another control device of the load control system 100 that is capable of being assigned to the role of a router device may be also assigned to the role of the leader device.

The leader device 210 may support and be attached to multiple router devices (e.g., up to 64 router devices, 32 router devices, or another number of router devices may be defined for the network 200). The leader device 210 may operate as a router device. The router devices 220a-220d in the network 200 (e.g., attached to the leader device 210 in the network 200) may be in communication with each other, for example, to form the mesh network. The router devices 220a-220d may be in communication with one another via network communication links (e.g., as indicated by the solid lines connecting the router devices 220a-220d). Each of the router devices 220a-220d may be attached to one or more of the other router devices 220a-220d via one or more of the network communication links of the network 200. The router devices 220a-220d may be in communication with the leader device 210, either directly and/or through one or more other router devices (e.g., as indicated by the solid lines connecting the leader device 210 to the router devices 220a and 220c). The router devices 220a-220d may receive and route messages to other devices in the network 200 (e.g., the end devices 230a, 230b, the router-eligible end device 240, and/or the sleepy end device 250). The router devices 220a-220d may receive and/or transmit messages between devices, or between each other for communicating messages received from an attached device to another device attached to another router device. For example, a device that is externally-powered (e.g., a device that is not battery-powered) may be assigned to the role of a router device. Examples of the router devices 230a, 230b may be a system controller (e.g., the system controller 110) and/or load control devices (e.g., the lighting control device 120, the plug-in load control device 140, the motorized window treatments 150, and/or the thermostat 160).

The network 200 may include one or more end devices, such as the end devices 230a, 230b (e.g., standard, full, or minimal end devices), the router-eligible end device 240, and/or the sleepy end device 250. The end devices 230a, 230b may be attached to one of the router devices 220a-220d in the network 200 to create a parent-child relationship with that router device. The router devices (e.g., the leader device 210 and/or the router devices 220a-220d) may be parent devices in the parent-child relationship. The end devices (e.g., the end devices 230a, 230b, the router-eligible end device 240, and/or the sleepy end device 250) may be child devices in the parent-child relationship. Each child device may have a single parent. Each parent device may have multiple child devices. After a child device attaches to a parent device, a network communication link (e.g., an attachment) may be established between the respective end device and the respective router device. The end devices (e.g., the end devices 230a, 230b, the router-eligible end device 240, and/or the sleepy end device 250) may transmit and/or receive messages via its attached parent device (e.g., the leader device 210 and/or the router devices 220a-220d) through the network communication link (e.g., the attachment between the parent and the child). Though two end devices 230a, 210b are shown in FIG. 2A, and each is attached to different router devices, each router device 220a-220d may support multiple end devices (e.g., more than 500 end devices). Examples of the end devices 230a, 230b may be a system controller (e.g., the system controller 110), input devices (e.g., the remote control device 130), and/or load control devices (e.g., the lighting control device 120, the plug-in load control device 140, the motorized window treatments 150, and/or the thermostat 160).

The end devices of the network 200 (e.g., the router-eligible end device 240 and/or the sleepy end device 250) may be particular types of end devices in the network 200. The router-eligible end device 240 may be an end device that is capable (e.g., hardware-capable and/or software-capable) of becoming a leader device and/or a router device. For example, the router-eligible end device 240 may be an end device that is powered by an external power source (e.g., an external AC or DC power supply). The router-eligible end device 240 may be aware of its role as a router-eligible end device based on, for example, an indication that is stored in memory in the router-eligible end device 240. In certain situations, the role of the router-eligible end device 240 may be upgraded to be a leader device and/or a router device. For example, when the router-eligible end device 240 identifies itself as being within a threshold range (e.g., signal strength threshold, such as an RSSI threshold or other signal strength threshold) of an end device attempting to attach to the network 200, the router-eligible end device 240 may upgrade itself to the role of a router device. The router-eligible end device 240 may transmit and/or receive messages via the attached router device 220d. As shown in FIG. 2A, the router-eligible end device 240 may remain in the role of an end device and may be one of the end devices that is attached to the router device 220d. For example, a control device that is, for example, externally-powered (e.g., a control device that is not battery-powered) may be assigned to the role of a router-eligible end device. Examples of the router-eligible end device 240 may be a system controller (e.g., the system controller 110), and/or load control devices (e.g., the lighting control device 120, the plug-in load control device 140, the motorized window treatments 150, and/or the thermostat 160).

The sleepy end device 250 may an end device that is configured to periodically go to sleep when not active. For example, the sleepy end device 250 may be an end device that is powered by a finite power source (e.g., a battery). The sleepy end device 250 may not be capable of becoming a leader device and/or a router device. The sleepy end device 250 may be aware of its role as a sleepy end device based on, for example, an indication that is stored at the sleepy end device 250. Communication with the sleepy end device 250 may be performed such that the finite power source is preserved and/or is efficiently consumed. For example, the sleepy end device 250 may periodically disable its communication circuit(s) in between message transmissions (e.g., go to sleep). As shown in FIG. 2A, the sleepy end device 250 may be one of the end devices that is attached to the router device 220a. The sleepy end device 250 may be configured to transmit and/or receive messages via the router device 220a. Examples of the sleepy end device 250 may be input devices (e.g., the remote control device 130), sensors (e.g., the sensor device 132), load control devices (e.g., the motorized window treatments 150 when battery-powered), and/or other battery-powered control device.

As the network 200 forms (e.g., initially forms), the control devices may update their roles (e.g., upgrade from an end devices to a router device and/or downgrade from a router device to an end device). The control devices may be configured to initially take on the role of end devices (e.g., when first powered up). One or more of the initial end devices may determine to upgrade to take on the role of a router device (e.g., the router devices 220a-220d shown in FIG. 2A). The remaining end devices may continue in the role of end devices (e.g., the end devices 230a, 230b, the router-eligible end device 240, and/or the sleepy end device 250 shown in FIG. 2A). In addition, one or more of the router device may determine to downgrade to the role of an end device.

The leader device 210 may manage the roles of the devices communicating within the network 200. For example, the leader device 210 may confirm and/or approve updates of the roles of the devices in the network 200. The devices of the network 200 may update their respective roles, for example, based on changes to the network 200. In an example, a control device may take on a certain role when the device attaches to the network 200 (e.g., by attaching to one or more other devices and/or becoming a leader device and/or a router device), and the control device may update its role based on changes in network conditions of the network 200. Changes in network conditions may include: increased message traffic, attachment of other devices, changes in signal strength of messages received from other devices in the network 200, and/or other network conditions. Updates to the assigned role of each of the control devices may be based on the capabilities of the respective control device. For example, an end device that is a router-eligible end device may be capable of upgrading to take on the role of a router device (e.g., as a router-eligible end device is an end device that is eligible to perform the role of a router device). The router-eligible end device may determine to upgrade from an end device to a router device, and the leader device 210 may assign a router identifier (ID) to the device. In some examples, the leader device 210 may update the role of one or more of the devices in the network 200.

The router devices in the network 200 (e.g., the leader device 210 and/or the router devices 220a-220d) may be configured to transmit network status advertisement messages. For example, the router devices may transmit network status advertisement messages to enable other control devices to determine that the network 200 has been formed and to enable the end devices (e.g., the end devices 230a, 230b, the router-eligible end device 240, and/or the sleepy end device 250) that hear the network status advertisement messages to attempt to attach to one of the router devices of the network 200. In some examples, each of the control devices may receive and track the network status advertisement messages transmitted by the router devices to determine whether the respective control device is able to communicate via the network 200. Additionally or alternatively, the network status advertisement messages transmitted by one of the router devices may allow the other router devices and the end devices to measure a communication quality metric (e.g., a received signal strength indicator value) that indicates the quality of the communication between the respective router devices attached to the network 200. As described herein, the control device in the network 200 may each measure the received signal strength indicator (RSSI) or another communication quality metric of the received network status advertisement messages and/or the network communication link between that control device and the router device that transmitted the received network status advertisement message. For example, each of the router devices of the network 200 (e.g., the leader device 210 and/or the router devices 220a-220d) may transmit the network status advertisement message as multicast messages (e.g., and/or broadcast messages). The communication quality metric of the advertisement messages received from other control devices in the network 200 may be stored in the routing information on respective control devices in the network 200.

The router devices in the network 200 (e.g., the leader device 210 and/or the router devices 220a-220d) may each maintain a router list of the respective router identifiers of the router devices in use in the network 200. The router list may be stored in the routing information on the respective control devices in the network 200. As the roles of the devices in the network 200 are updated, the router devices in the network 200 may update the router list of the router identifiers of router devices in use in the network 200. In addition, one or more of the end devices (e.g., the end devices 230a, 230b, the router-eligible end device 240, and/or the sleepy end device 250) may also maintain a router list that includes the router identifiers of router devices in use in the network 200. For example, the router-eligible end device 240 may create and store the router list. The router devices and/or the devices may create the router list based on the network status advertisement messages that are transmitted by the router devices.

The router devices in the network 200 (e.g., the leader device 210 and/or the router devices 220a-220d) may create and/or store, for example, a bitmap 217 that may be used to indicate the router identifiers of the router devices in use in the network 200 in the router list. The bitmap may be stored in the routing information on the respective control devices in the network 200. The bitmap 217 may include a number of bits that correspond to the different router identifiers of the router devices in use in the network 200. In an example, the network 200 may support 64 router devices in the router list and the router devices may generate and store a 64-bit bitmap for tracking the router identifiers of the router devices in use in the network 200. Each router identifier in the bitmap may indicate whether a router identifier is identified by the leader device 210 as being used (e.g., with a value of “1”) or unused (e.g., with a value of “0”). In addition, one or more of the end devices (e.g., the router-eligible end device 240) may create and/or store the bitmap 217 (e.g., in a similar manner as the router devices). One of the end devices (e.g., one of the router-eligible end devices, such as the router-eligible end device 240) may determine to upgrade to a router device and, so long as a router identifier is available, the leader device 210 may assign a router identifier to the router device. In addition, one of the router devices may determine to downgrade from a router device to an end device. As devices determine to upgrade to being and/or downgrade from being router devices in the network 200, the router devices and/or the end devices (e.g., the router-eligible end device 240) may update the bitmap 217 to indicate the router identifiers of router devices that are in use in the network 200. The router devices and/or the end devices (e.g., the router-eligible end device 240) may transmit a message including the bitmap 217 indicating the router list to the other router devices and/or the end devices in the network 200 (e.g., the router devices 220a-220d).

Each of the router devices (e.g., the leader device 210 and the router devices 220a-220d), may create and/or maintain network data about each of the router devices identified in the router list as being used in the network 200, which may be stored in the routing information on the respective router device. For example, each router device may maintain network data about each of the router devices in use in the network 200 in a router table, such as a router table 218 that may be maintained by the leader device 210 (e.g., as shown in FIG. 2A). The network data in the router tables of the respective router devices (e.g., the leader device 210 and the router devices 220a-220d) may identify the router devices in the network 200 (e.g., the router identifiers from the router list) and a respective communication quality metric (e.g., a received signal strength identifier) that identifies the quality of communications that the respective router device has with the other router devices being maintained in the router table stored locally thereon. For example, the network data in the router table 218 of the leader device 210 may identify the router devices 220a-220d in the network 200 and a communication quality metric that may identify the quality of communications that the leader device 210 has with the router devices 220a-220d in the router table 218 stored on the leader device 210. The router devices may determine the communication quality metrics (e.g., the received signal strength indicators) based on the received network status advertisement messages that are transmitted by the router devices. Each of the router tables of the respective router devices may include a row for each router identifier indicated in the bitmap 217. Each of the router devices in the network 200 may perform communications via the network 200 based on the network data being stored and maintained in the respective router table (e.g., as locally stored at the respective router device). For example, one of the router devices (e.g., as the leader device 210 and/or the router devices 220a-220d) may transmit messages differently within the network 200 based on the quality of the communications with corresponding router devices identified in the respective router table stored locally thereon.

Each of the end devices (e.g., the end devices 230a, 230b, the router-eligible end device 240, and/or the sleepy end device 250) may also maintain network data about each of the router devices of the router list in a router table, which be stored in the routing information on the respective end devices. The router table may include network data regarding the router devices from which the respective end device from which has received messages (e.g., network status advertisement messages). The network data in the router tables of the respective end devices may identify the router devices in the network 200 (e.g., the router identifiers from the router list) and a respective communication quality metric (e.g., a received signal strength identifier) that identifies the quality of communications that the end device has with the router devices being maintained in the router table stored locally thereon. The end devices may determine the communication quality metrics (e.g., the received signal strength indicators) based on the received network status advertisement messages that are transmitted by the router devices.

The control devices in the network 200 may operate as parent devices and/or child devices in the parent-child relationship, as described herein. The parent-child relationship may be defined in the routing information on the respective control devices in the network 200. Router devices (e.g., the leader device 210 and/or the router devices 220a-220d) that are attached to one or more end devices (e.g., the end devices 230a, 230b, the router-eligible end device 240, and/or the sleepy end device 250) may operate as parent devices in the parent-child relationships. End devices (e.g., the end devices 230a, 230b, the router-eligible end device 240, and/or the sleepy end device 250) that are attached to a router device (e.g., the leader device 210 or one of the router devices 220a-220d) may operate as child devices in the parent-child relationships. As a parent device, the leader device 210 and the router devices 220a-220d may each be attached to one or more child devices (e.g., one or more of the end devices 230a, 230b, the router-eligible end device 240, and/or the sleepy end device 250, as described herein). In addition, the leader device 210 and the router devices 220a-220d may store and/or relay messages that are sent by their respective attached child devices. For example, the leader device 210 and the router devices 220 may receive messages from their respective child devices and route the received messages to the intended recipient device (e.g., either directly to the intended recipient device, via the respective parent device of the intended recipient device, and/or to a router device or leader device this is on the communication path to the intended recipient). Similarly, the leader device 210 and the router devices 220a-220d may receive messages intended for their respective child device and route the message to the appropriate child device. The parent of a respective sleepy end device may schedule communications with the sleepy end device when the communication circuit of the sleepy end device is enabled.

As indicated in FIG. 2A, the parent-child relationship (e.g., formed by the attachment) between a child device and a respective parent device may be indicated by dashed lines. For example, the router device 220a may be configured as the parent device of the end device 230a and the sleepy end device 250. Similarly, the router device 220b may be configured as the parent device of the end device 230b and the router device 220d may be configured as the parent device of the router-eligible end device 240. The router device 220a may receive messages intended for the end device 230a and forward the message to the end device 230a. As the router device 220a is configured as the parent device of the end device 230a, the end device 230a may transmit messages to the router device 220a, and the router device 220a may route the message to the intended recipient. For example, when the end device 230a intends to transmit a message to the end device 230b, the end device 230a may initially transmit the message to the router device 220a. The router device 220a may route the message to the router device 220b (e.g., the parent device of the end device 230b). The router device 220a may route the message to the router device 220b via the router device 220c or the router device 220d, and the router device 220b may then forward to message to the end device 230b.

The control devices in the network 200 may be configured to transmit unicast messages to other control devices in the network 200. Child devices may be configured to transmit unicast messages to their respective parent device. A control device may transmit unicast messages to another control device in the network 200 directly or via hops through other devices in the network 200. Each unicast message may be individually addressed to another control device by including a unique identifier of the control device to which the unicast message being transmitted. Control devices may generate separate unicast messages for each control device with which they are communicating and address the unicast messages to each control device independently. The unicast messages may also include the unique identifier of the control device that is transmitting the unicast message. A control device may determine that it is the intended recipient of a unicast message by identifying its own unique identifier in the unicast message.

The control devices in the network 200 may also be configured to transmit multicast messages and/or broadcast messages. The multicast messages and broadcast messages may be propagated and/or transmitted by multiple devices in the network 200, which may increase the likelihood that all of the child devices hear the multicast messages. For example, rather than transmitting multiple unicast messages to multiple devices, one of the end devices may be configured transmit a multicast message to multiple devices, and the router devices may be configured (e.g., may all be configured) to propagate (e.g., repeat) the multicast messages. The multicast messages transmitted by the end device and retransmitted by the router devices may include the same load control instructions (e.g., commands) to be sent to multiple load control devices. Multicast messages may be sent to a group of control devices in the network 200. A multicast message may include a group identifier. The control devices that are members of the group may recognize the group identifier and process the multicast message accordingly. In some examples, a multicast message may be sent to all control devices in the network 200 (e.g., the multicast message may include a group identifier that identifies all devices the network 200). Broadcast messages may be sent to each control device (e.g., all of the control devices) capable of receiving the message in the network 200 (e.g., not to just a group of control devices in the network 200). The broadcast messages may include an indication that the message is a broadcast message (e.g., a broadcast address). Each device that receives a broadcast message may process the message accordingly. A broadcast message may be essentially the same as a multicast message that is sent to all control device in the network 200 (e.g., a multicast message having a group identifier that identifies all devices the network 200. The control devices communicating on the network 200 may use either multicast messages or broadcast messages. Embodiments are described herein that may implement either multicast messages or broadcast messages. However, for embodiments that are described as implementing multicast messages, broadcast messages may similarly be implemented. For embodiments that are described as implementing broadcast messages, multicast messages may similarly be implemented.

The messages transmitted by a child device to its respective parent device may include an indication (e.g., a unique identifier) of the intended recipient, and the parent device may route the message accordingly. Referring again to FIG. 2A, the end device 230a may transmit messages to the router device 220a (e.g., the parent device of the end device 230a), and the router device 220a may route the message based on the intended recipient. For example, if the end device 230a transmits a message intended for the end device 230b, the router device 220a may route the message to the router device 220b (e.g., the parent device of the router-eligible end device 230b) via the router device 220c or the router device 220d. If the router device 220a routes the message via the router device 220d, the router device 220d may forward the message to the router device 220b, which may forward the message to the end device 230b. The router device 220a may identify that the router device 220b is the parent device to which the end device 230b is attached via a lookup table. As illustrated in FIG. 2A, multiple communication paths may exist to route messages over the network 200, and router devices may identify the shortest communication path (e.g., lowest number of hops) to transmit messages to a respective device.

Child devices may be configured to communicate with one or more auxiliary parent devices (e.g., may be configured to communicate with more than one parent device). For example, the parent-child relationship may include an auxiliary parent relationship, such that a router device may be an auxiliary parent for one or more end devices and/or an end device may be a child device for one or more auxiliary parent devices. The auxiliary parent devices of a given control device may be stored in the routing information on the control device. Referring to FIG. 2A, for example, the end device 230b may be configured to communicate with (e.g., transmit messages to and receive messages from) a parent device (e.g., a primary parent device), such as the router device 220b. The end device 230b may also be configured to communicate with (e.g., receive messages from) an auxiliary parent device, such as the router device 220c (e.g., as illustrated by the long and short dashed lines in FIG. 2A). A child device may receive unicast messages from its parent device (e.g., primary parent device). A child device may also receive multicast messages (e.g., and/or broadcast messages) from its parent device (e.g., primary parent device) and its one or more auxiliary parent devices, which may increase the efficiency and reliability of child device receiving the messages. For example, the child device may receive network status advertisement messages via its one or more auxiliary parent devices. The number of auxiliary parent devices that a child device is synchronized with may be limited to a threshold number of auxiliary parent devices (e.g., 3, 5, 10, etc.), which may be pre-defined and/or configured.

A child device may be attached to a single parent device and synchronized with one or more auxiliary parent devices. For example, the child device may send and/or receive unicast messages via the parent devices. Similarly, the child device may receive multicast messages via the one or more synchronized auxiliary parent devices. A child device may attempt to synchronize with one or more router devices that are not the primary parent device for that child device (e.g., to have those router devices to become auxiliary parent devices for the child device) by transmitting a message (e.g., referred to herein as a synchronization request message) to the auxiliary parent device. For example, referring to FIG. 2A, the end device 230b may have transmitted a synchronization request message to the router 220c. The synchronization request message may be used to request a auxiliary parent link between two devices. As descried herein, multicast messages (e.g., broadcast messages) may be received by a child device from router devices to which the child device is connect by an auxiliary parent link. In response to receiving the synchronization request message, the router device 220c may transmit a message (referred to herein as a synchronization accept message) to the end device 230b. The synchronization accept message may include information that allows the child device (e.g., the end device 230b) to decrypt messages from the auxiliary parent device (e.g., the router device 220c), such as a frame counter. As described herein, when a child device is synchronized with an auxiliary parent device, the child device may receive multicast messages via the synchronized auxiliary parent device. For example, referring to FIG. 2A, the end device 230b (e.g., the child device) may receive multicast messages via the router device 220b (e.g., the primary parent device) and the router device 220c (e.g., the auxiliary parent device), which may increase the efficiency and reliability of the end device 230b receiving multicast messages.

The child devices may each receive the network status advertisement messages from the primary parent device and the auxiliary parent devices of the child device. The child devices may measure communication quality metrics (e.g., received signal strength identifiers) that indicate the network status advertisement messages transmitted by one of the router devices may allow the other router devices to The child devices may each measure communication quality metrics (e.g., the received signal strength indicator values) that indicate the quality of communication between the respective child device and the primary parent devices and/or the auxiliary parent devices of the child device (e.g., which the child devices may use to update their respective router tables and/or other routing information). As described herein, the child device may measure the received signal strength indicator (RSSI) or another communication quality metric of the received network status advertisement messages.

Each of the child devices in the network 200 may create and maintain an auxiliary parent table of auxiliary parent devices (e.g., its synchronized auxiliary parent devices). The auxiliary parent table may include a list of auxiliary parent devices with which the respective child device is configured to communicate (e.g., configured to receive multicast messages). In addition, the auxiliary parent table may include an indication of a respective communication quality metric (e.g., a received signal strength, such as an RSSI) for each of the auxiliary parent devices of the child device. For example, the auxiliary parent table may include a rolling average of the received signal strength indicators for each of the auxiliary parent devices of the child device. As used herein, the term auxiliary parent table may refer to a separate table from the router table or a subset of the router table that includes the router devices that are synchronized auxiliary parent devices of the child device.

As described herein, the network 200 may allow for communication between control devices in a load control system (e.g., the load control system 100 shown in FIG. 1A). The end devices 230a, 230b may include load control devices and/or input devices (e.g., input devices) that communicate with other control devices in the load control system. For example, the end device 230a may communicate with another end device and/or a router device in the load control system via RF communications. Referring to FIG. 1A, the remote control device 130 may operate as an end device (e.g., a sleepy end device) for communicating messages comprising indications of user input and/or control instructions for controlling a router device and/or another end device (e.g., the lighting control device 120, the plug-in load control device 140, the motorized window treatment 150, and/or the thermostat 160). The remote control device 130 may communicate via its primary parent device, such as the leader device 210 and/or one of the router devices 220a-220d, for example. The primary parent device may communicate with one or more other of the router devices in the network 200 to route the messages to another one of the end devices (e.g., the lighting control device 120, the plug-in load control device 140, the motorized window treatment 150, and/or the thermostat 160) for performing load control.

A control device may attach to another control device on a network or network partition (e.g., the network 200 shown in FIG. 2A) to enable the device to communicate (e.g., transmit and/or receive messages) via the network. A control device may initiate attachment to another control device on a network by transmitting a parent request message (e.g., a multicast parent request message) to discover potential parent devices. A parent request message may be transmitted by a control device to discover and/or attach to a parent device (e.g., router devices and/or leader devices). A control device may transmit the parent request message as a broadcast message, for example, to identify devices that are attached to the network that can act as a parent device of the control device. In some examples, the control device may transmit the parent request messages as a multicast message that is transmitted to all control devices of the network 200 (e.g., having a group identifier that identifies all devices the network 200) Potential parent devices (e.g., the leader device 210 and/or the router devices 220a-220d of the network 200) that receive a parent request message may respond by transmitting a parent response message. For example, potential parent devices that receive a multicast parent request message may each transmit a parent response message to the control device that transmitted the parent request message. Each of the potential parent devices may transmit the parent response messages as a unicast message to the control device that transmitted the parent request message. Each of the potential parent devices may transmit the parent response message to indicate that the respective potential parent device is available to act as a parent device. Accordingly, a control device that transmits a parent request message may receive a plurality of responses to the parent request message and determine a parent device with which to synchronize based on the received parent response messages. For example, the control device transmitting the parent request message may identify the received communication quality metric (e.g., the received signal strength indicator) associated with the parent response messages and attempt attachment to the parent device having the largest received signal strength indicator for the parent response message.

FIG. 2B is an example illustration of a network 200a having a plurality of network partitions 201, 202, 203 (e.g., separate network partitions). As illustrated in FIG. 2B, the network partition 201 may include parent devices, such as a leader device 211 and router devices 221a, 221b, 221c, 221d. In addition, the network 201 may include child devices, such as end devices 231a, 231b, a router-eligible end device 241, and a sleepy end device 251. For example, each of the router devices 221a-221d in the network partition 201 may be assigned a unique router identifier. The network partition 202 may include the parent devices, such as a leader device 212 and router devices 222a, 222b, 222c, 222d. In addition, the network 202 may include child devices, such as end devices 232a, 232b, a router-eligible end device 242, and a sleepy end device 252. For example, each of the router devices 222a-222d in the network partition 202 may be assigned a unique router identifier. The network partition 203 may include a parent device, such as a leader device 213, and an end device, end device 223.

The network 200a may allow for communication between control devices in a load control system (e.g., the load control system 100). In addition, the network partitions 201, 202, 203 may be formed as a result of certain control devices being unable to attach to an already-formed network partition (e.g., as a result of one or more of the control devices of one of the network partitions being unable to attach to one of the other network partitions). For example, as described herein, a control device may attempt to attach to another control device on a network partition by transmitting a parent request message (e.g., a broadcast parent request message). If, however, the control device fails to receive a response to the parent request message (e.g., because the control device is outside of a communication range of the router devices of an already-formed network partition), the control device may attempt to form its own network partition (e.g., become a leader device of a new network partition).

A control device that is unable to attach to a network partition may form another network partition. For example, referring to FIG. 2B, when the leader device 213 was operating as an end device (e.g., prior to taking on the role of leader device and forming the network partition 203), the leader device 213 may have been unable to attach to one of the router devices in the network partitions 201, 202 (e.g., because the leader device 213 was outside of communication range of the router devices in the network partitions 201, 202). Accordingly, when still operating as an end device, the leader device 213 may have determined to upgrade to the role of leader device and formed the network partition 203. In addition, the end device 223 may have attached to the leader device 213 in the network partition 203. Similarly, the leader device 211 (e.g., when operating as an end device prior to taking on the role of a leader device and forming the network partition 201) may have been unable to attach to one of the router devices in the network partitions 201, 202 (e.g., because the leader device 211 was outside of communication range of the router devices in the network partitions 202, 203) and may have then formed the network partition 202. In addition, the leader device 212 (e.g., when operating as an end device prior to taking on the role of a leader device and forming the network partition 202) may have been unable to attach to one of the router devices in the network partitions 201, 203 (e.g., because the leader device 212 was outside of communication range of the router devices in the network partitions 201, 203) and may have then formed the network partition 202.

The network partitions 201, 202, 203 may each be associated with a respective partition identifier (e.g., a partition ID). The partition identifier of each of the network partitions 201, 202, 203 may be randomly or pseudo-randomly assigned (e.g., randomly assigned from a range or list of identifiers). For example, the partition identifier of each of the network partitions 201, 202, 203 may define a priority of the respective network partition. The partition identifier may be assigned by randomly selecting a number from a range of partition identifier values. For example, the leader devices 211, 212, 213 of each of the respective network partitions 201, 202, 203 may be configured to selected (e.g., randomly select) the respective partition identifier and transmit in the respective partition identifier in the network status advertisement messages transmitted by the respective leader device 211, 212, 213 to other devices with communication range. In response to receiving the network status advertisement including the partition identifier of one of the partitions 201, 202, 203, unattached control devices may be configured to attach to the leader device and/or one of the router devices of the respective partition 201, 202, 203.

Referring now to FIG. 2B, the network partitions 201, 202, 203 may each be associated with a respective partition identifier. For example, the network partition 202 may be assigned a partition identifier of 1, the network partition 203 may be assigned a partition identifier of 2, and the network partition 201 may be assigned a partition identifier of 3. Although the partition identifiers of the network partitions 201, 202, 203 are sequential (e.g., in order to provide for a simplified explanation), the assignment of the partition identifiers to the network partition may be sequential, non-sequential, and/or randomized. As described herein, a partition identifier may also be an indication of a priority of the respective network partition 201, 202, 203. For example, the priority may be equal to the partition identifier of the respective network partition 201, 202, 203 (e.g., the respective priorities of the network partitions 201, 202, 203 may be 3, 1, and 2). A higher value of the partition identifier may indicate a higher value for the priority of one of the network partitions (e.g., the network partition 201 may have a higher priority than the network partitions 202, 203 based on the respective partition identifiers).

The network partitions 201, 202, 203 may each be assigned a priority based on the control devices (e.g., router devices and/or end devices) in the respective network partition 201, 202, 203. For example, the network partitions have at least one router device in addition to the leader device may be given a higher priority than the network partitions having only a leader device and no other router devices. Referring to FIG. 2B, the network partitions 201, 202 may be given higher priorities than the network partition 203 since the network partitions 201, 202 have router devices 221a-221d and router devices 222a-222d, respectively, and the network partition 203 has no router devices in addition to the leader device 213. In addition, the network partitions 201, 202, 203 may each be assigned a priority based on a total number of control devices (e.g., router devices and/or end devices) in the network partition. Referring to FIG. 2B, the network partitions 201, 202 may be given priorities than the network partition 203 since the network partitions 201, 202 may each have a greater number of control devices than the network partition 203. Each control device in the network partitions 201, 202, 203 may have stored locally thereon the number of control devices in the respective network partition.

The network partitions that have the same number of control devices may be given different priorities based on the respective partition identifiers (e.g., which may be different), as described herein. As shown in FIG. 2B, the network partition 201 and the network partition 202 may have the same number of control devices (e.g., router devices and/or end devices), and may be assigned different priorities based on the respective partition identifiers. For example, the network partition 201 may have a higher priority based on the network partition 201 having a higher value of the partition identifier (e.g., 3) than the partition identifier of the network partition 202 (e.g., 1). In some examples, the network partition 202 may have a higher priority based on the network partition 202 having a lower value of the partition identifier than the partition identifier of the network partition 201.

As the control devices attach to each of the network partitions 201, 202, 203, the effective communication range of each of the network partitions may increase. The router devices in each of the network partitions 201, 202, 203 may each be associated with a respective communication range. The communication range of each of the respective router devices may be pre-defined and/or pre-configured. For example, the communication range of each of the respective router devices may be pre-defined and/or pre-configured based on the hardware components of each of the respective router devices. The effective communication range of the network 200a and/or each of the network partition 201, 202, 203 may be based on the communication range of the router devices in the network 200a and/or in the respective network partition 201, 202, 203 (e.g., a union of the communication ranges of each of the router devices in the network 200a and/or the respective network partition 201, 202, 203). As a result, the communication range of a respective network or network partition may increase in area as the number of router devices in the respective network or network partition increases.

As the control devices attach to each of the network partitions 201, 202, 203 and the effective communication range of each of the network partitions 201, 202, 203 increases, the control devices that were initially unable to attach to one or more of the network partitions 201, 202, 203 (e.g., because the control device was previously outside of the communication ranges of all of the network partitions) may subsequently be able to attach to one of the network partitions 201, 202, 203. When the control devices of a control system (e.g., such as the load control system 100 shown in FIG. 1) are configured to communicate via a network, communication within the control system may be better facilitated when a single network partition is formed (e.g., the network 200 having a single network partition as illustrated in FIG. 2A) as compared to when a network having multiple network partitions is formed (e.g., the network 200a having the multiple network partitions 201, 202, 203 as illustrated in FIG. 2B). For example, in the network 200a that has the multiple network partitions 201, 202, 203, the control devices in one of the network partitions may be unable to communicate with the control devices in the other network partitions (e.g., the control devices in the network partition 201 may be unable to transmit messages to and/or receive messages from the control devices in the network partitions 202, 203). Accordingly, if a control device in a first network partition is also within the communication range of one or more of the router devices in a second network partition, the control device may attempt to detach from the respective router device (e.g., its parent device) in the first network partition and attach to one of the router devices in the second network partition. For example, a control device may detach from the respective router device in the first network partition and attach to one of the router devices in a second network partition when the priority of the second network partition is higher than the priority of the first network partition.

As described herein, the control devices attached to a network partition that has a lower priority may attempt to attach to a network partition that has a higher priority. For example, the control devices attached to the network partition 202 may attempt to attach to the network partition 201 (e.g., as the network partition 201 has a priority of 3 and the network partition 202 has a priority of 1). The router device 222a may receive a network status advertisement message from one of the router devices in the network partition 201 (e.g., from the router device 221d). The network status advertisement message may include an indication of the partition identifier of the network 201 (e.g., 3), which may be greater than the partition identifier of the network partition 202 and may indicate that the network partition 201 has a higher priority than the network partition 202. The router device 222a may determine to attach to the network partition 201 (e.g., as the network partition 201 has a higher priority).

The router devices of the network partitions 201, 202, 203 may attempt to attach to The router device 222a may attempt to attach to the network partition 201 by transmitting a request to the leader device of the network partition 201 (e.g., the leader device 211). The request may include a request to attach to the network partition 201 as a router device, for example, by requesting to attach to the network partition 201 and be assigned a certain router identifier. For example, the router device 222a may request to attach to the network partition 201 and be assigned the router identifier that the router device 222a is assigned in the network partition 202. In response, the leader device 211 may reject the request if another router device 212a-212d attached to the network partition 201 is already assigned the requested router identifier. The leader device 211 may accept the request if none of the router devices 212a-212d attached to the network partition 201 are assigned the requested router identifier. If the router device 222a attaches to the network partition 201 and is assigned the requested router identifier, the child devices of the router device 222a (e.g., the end device 232a and the sleepy end device 252) may automatically attach to the network partition 201. For example, as the child devices communicate with the router device 222a using the router identifier. If the router device 222a is assigned the requested identifier by the leader device 211 of the network partition 201 (e.g., the router identifier as assigned in the network partition 202), the child devices may continue to communicate with router device 222a using the same router identifier.

FIGS. 2C to 2E are illustrations of an example network 200b as the network 200b advances or progresses in network formation. As illustrated in FIG. 2C, the network 200b may include a leader device 214 and an end device 234a. As the network 200b is in the initial stages of network formation, the network 200b may not yet include a router device. The end device 234a may, as a result, attach to the leader device 214 (e.g., as other router devices not yet exist in the network 200b). However, the network communication link (e.g., the attachment between the parent and the child) between the leader device 214 and the end device 234a may be weak (e.g., the received signal strength indicator of messages received by the end device 234a may be approximately −60 dB). For example, the network communication link between the leader device 214 and the end device 234a may be weak because the leader device 214 and the end device 234a are not proximately positioned to each other. If the network communication link between the leader device 214 and the end device 234a is weak (e.g., a communication quality metric indicating a quality of the network communication link is below a first threshold), the likelihood of message reception failures between the leader device 214 and the end device 234a may be higher than desired or needed for maintaining network quality above a second threshold. The first threshold may be a communication quality metric threshold (e.g., an LQI threshold, an LQO threshold, an RSSI threshold, etc.), and may be different from the second threshold.

FIG. 2D illustrates the network 200b during a later stage of network formation than the stage of network formation illustrated in FIG. 2C. As illustrated in FIG. 2D, the network 200b may grow to include additional control devices as formation of the network 200b advances (e.g., as time progresses). For example, the network 200b may grow to include router devices 224a, 224b. The router devices 224a, 224b may be positioned proximate to the end device 234a (e.g., positioned closer to the end device 234a than the leader device 214). In addition, the received signal strength indicators of messages transmitted by the router devices 224a, 224b and received by the end device 234a may be strong (e.g., stronger than the received signal strength indicators of messages transmitted by the leader device 214 and received by the end device 234a). For example, the received signal strength indicators of messages transmitted by the router devices 224a, 224b and received by the end device 234a may be approximately −35 dB, and the received signal strength indicators of messages transmitted by the leader device 214 and received by the end device 234a may be approximately −30 dB. Thus, potential network communication links (e.g., potential attachments) between the router devices 224a, 224b and the end device 234a may be stronger than the network communication link (e.g., the existing attachment) between the leader device 214 and the end device 234a. Moreover, as illustrated in FIG. 2D, a potential network communication link between the router device 224b and the end device 234a may be stronger than a potential network communication link between the router device 224a and the end device 234a (e.g., as the router device 224b is positioned closer to the end device 234a than the router device 224a). As such, as shown in FIG. 2E, the end device 234a may update its parent device to be the router device 224b by attaching to the router device 224b, as described herein.

As network formation progresses, additional control devices may attach to the network 200b. The end device 234a may experience better communication over the network 200b if the end device 234a detaches from an initial parent device (e.g., the leader device 214) and attaches to an updated parent device (e.g., the router device 224a or the router device 224b). For example, the updated parent device may be positioned closer to the end device 234a than the initial parent device (e.g., such that the updated parent device and the end device 234a may have a stronger network communication link), which may increase the likelihood that message receptions are successful. As network formation advances, the end device 234a may determine whether to attach to an updated parent device, as shown in FIG. 2E. Although FIG. 2C to 2E are described using an example where the relative positioning of devices may increase or decrease the network communication link shared between two devices, other conditions may affect the network communication link shared between two devices (e.g., line of sight, interference, signal obstructions, etc.). To that extent, the scenarios of FIGS. 2C to 2E are merely examples to illustrate that a network may change over time and that changes to network may be considered in attempts to improve communications over the network.

FIG. 2F is an illustration of an example network 200c. As illustrated in FIG. 2F, the network 200c may include a leader device 215 and router devices 225a, 225b, 225c, 225d, 225e, 225f. In the network 200c, each of the router devices 225a-225f may be attached to one or more of the other router devices via respective network attachment links. Since each of the network attachment links between two of the router devices 225-225f may allow for direct communication between the two respective router devices, the network attachment links may each be referred to as a single-hop network communication link. Each of the router devices 225a-225f may be configured to communicate with the other router devices by transmitting and/or receiving unicast and/or multicast messages directly via the respective network communication links (e.g., the single-hop network communication links). For example, the router devices 225a, 225b may be router devices (e.g., neighboring router devices) that share a single-hop network communication link with each other. In addition, the router device 225a may share a single-hop network communication link with the leader device 215, as the router device 225a is capable of sending messages directly to and/or receiving messages directly from the leader device 215. When two of the router device 225a-225f are not able to communicate directly via one of the single-hop network communication links, the two respective router devices may be configured to transmit message to each other via one or more of the outer router devices. For example, the router device 225a may be configured to transmit a message to the router device 225c by transmitting a message to the router device 225b, which may rout the message to the router device 225c.

The router devices (e.g., the leader device 215 and the router devices 225a-225f) may periodically transmit network status advertisement messages that may be used for calculating cost and/or quality of communications in the network 200c. For example, the router device 225c may transmit a network status advertisement message that is received by the leader device 215 and the leader device 215 may transmit a network status advertisement message that is received by router device 225c (e.g., via the respective single-hop network communication links). Each of the router devices 225a-225f may measure the received communication quality metric (e.g., RSSI) of the received network status advertisement message and calculate a link quality metric (e.g., a link quality in (LQI) value) of network communication link (e.g., the attachment) between the respective router device and the router device that transmitted the network status advertisement message. each of the router devices in the network 200c (e.g., the leader device 215 and the router devices 225a-225f) may transmit the network status advertisement message, for example, as multicast messages (e.g., and/or broadcast messages). For example, each of the router devices in the network 220c may be configured to periodically transmit the network status advertisement messages.

After one of the router devices in the network 220c (e.g., the leader device 215 and the router devices 225a-225f) receives a network status advertisement message from one of the other router devices, the respective router device may calculate a communication quality metric that indicates the quality of communications between the respective router device and the router device that transmitted the network status advertisement. For example, each of the router devices in the network 200c, the link quality metric that indicates the quality of communications of the network communication link via which the network status advertisement message was received (e.g., the network communication link between the respective router device and the router device that transmitted the network status advertisement). For example, the link quality metric may be a link quality in (LQI) value and/or a link quality out (LQO) value.

Each of the router devices in the network 220c (e.g., the leader device 215 and the router devices 225a-225f) may be configured to determine (e.g., calculate) the LQI value as a predefined number that is within a range indicating different qualities of communication for the respective network communication link between two control devices (e.g., between the respective router device and the router device that transmitted the network status advertisement). For example, the LQI value may be set equal to values of 0, 1, 2, or 3. The different values of the LQI value may be assigned based on the RSSI value of the received network status advertisement message and a link margin relative to a predefined receive level. For example, the receive level may be a predefined minimum receive level. The receive level may be established as a predefined RSSI value for communications on the network. For example, the receive level may be defined by a noise floor that is set to an average RSSI value for noise generated in the network 200c over a period of time.

In an example in which the receive level is the noise floor, each of the router devices (e.g., the leader device 215 and/or router devices 225a-225f) may set the LQI value to 1 for communications on a network communication link from which one or more network status advertisement messages were received from one of the other router devices when the RSSI value (e.g., an average RSSI value over a period of time) of the one or more network status advertisement messages is at least a link margin of 2 dB above the noise floor. In addition, each of the router devices may set the LQI value to 2 for communications via the respective network communication link from which one or more network status advertisement messages were received from one of the other router devices when the RSSI value (e.g., an average RSSI value over a period of time) of the one or more network status advertisement messages is at least a link margin of 10 dB above the noise floor. Each of the router devices may set the LQI value to 3 for communications via the respective network communication link from which one or more network status advertisement messages were received from one of the other router devices when the RSSI value (e.g., an average RSSI value over a period of time) of the one or more network status advertisement messages is at least a link margin of 20 dB above the noise floor. Further, each of the router devices may set the LQI value to 0 for communications via the respective network communication link from which one or more network status advertisement messages were received from one of the other router devices when the RSSI value (e.g., an average RSSI value over a period of time) of the one or more network status advertisement messages is not a link margin of 2 dB above the noise floor. A link quality value of 0 may indicate that the quality of communications via the respective network communication link is unknown or infinite (e.g., when the RSSI value of the one or more network status advertisement messages is unable to be determined above the noise floor). Though examples are provided for setting the LQI value equal to different predefined value based on different ranges of the RSSI values of the received network status advertisement messages, other indicators and/or values may be used to define the LQI value of the respective network communication link between two router devices.

The LQI value of the network communication links (e.g., the single-hop network communication links) measured locally at each of the router devices (e.g., the leader device 215 and the router devices 225a-225f) may be exchanged with the other router devices (e.g., router devices within a single hop) in the network 200c. For example, each of the router devices in the network 200c (e.g., the leader device 215 and the router devices 225a-225f) may be configured to determine (e.g., measure and/or calculate) the LQI value locally and transmit the LQI value to the other router devices via one or more of the network status advertisement messages transmitted by the respective router device. In addition, each of the router devices in the network 200c may be configured to receive the LQI values determined (e.g., measured and/or calculated) by the other router devices via one or more of the network status advertisement messages transmitted by the other router devices. Each of the router devices in the network 220c may be configured to set the LQO value of the respective network communication link between the respective router device and the router device that transmitted one of the network status advertisement message equal to the LQI value of the respective network communication link included in the respective network status advertisement message.

Each of the router devices in the network 200c may be configured to store the LQI value and/or the LQO value that define the network communication links (e.g., the single-hop network communication links) between the respective router device and the other router devices in a router table (e.g., stored locally in memory). For example, the leader device 215 may store the LQI values and/or the LQO values for the single-hop network communication links with each router device within a single hop in the network 200c (e.g., the router devices 225a, 225c) in a router table 228. Similarly, the router device 225c may store the LQI values and the LQO values for the single-hop network communication links with each router device within a single hop in the network 200c (e.g., the leader device 215 and the router device 225b) in a router table 238. Each of the router devices may store in the router tables (e.g., the router tables 228, 238) network data (e.g., the LQI values and/or the LQO values) that defines the quality of communications on the single-hop network communication links on which respective router device (e.g., the leader device 215 and the router device 225b) is configured to communicate. In addition, each of the router devices may transmit the respective router table to each of the other router devices in the network 200c (e.g., in the network status advertisement messages transmitted by the respective router device).

The router devices in the network 200c (e.g., the leader device 215 and/or the router devices 225a-225f) may create and/or store, for example, a bitmap 227 that may be used to indicate the router identifiers of the router devices in use in the network 200c. In some examples, the bitmap 227 may be created and maintained by the leader device 215 and distributed to the router devices 225a-225f for locally storing a respective router list. In addition, the router devices 225a, 225c may receive the bitmap 227 and update the router tables stored locally thereon (e.g., in memory). The bitmap 227 may include a number of bits that correspond to the different router identifiers of the router devices in use in the network 200c. The bitmap 227 may indicate the number of rows in the router tables (e.g., indicating the number of identified router devices in the network 200c) and/or the router identifiers to include in the router tables. The router devices may update the network data in respective router tables for the router identifiers indicated by the bitmap 227. Each of the router devices may maintain and/or update the network data in the respective router table to include the LQI values and/or LQO values for the network communication links between the respective router device and the router devices identified in the bitmap 227. For example, the router device 225c may receive the bitmap 227 from the leader device 215, and may update the router table 238 to include the router devices that are indicated in the bitmap 277 or remove the router devices that are not indicated in the bitmap 277.

The router devices in the network 200c (e.g., the leader device 215 and the router devices 225a-225f) may each use communication quality metrics (e.g., the LQI values and/or the LQO values for the respective network communication links) in the respective router tables to determine a link cost for communicating with other router devices via the respective network communication link. Each of the router devices may be configured to set the link cost for each of the network communication links in the respective router table based on the lesser of the LQI value and the LQO value of the respective network communication link. The link cost for each of the network communication links between the router devices in the network 200c may correspond (e.g., directly correspond) to the link quality of communications via the respective network communication link. The link cost may indicate a relative cost or loss of signal strength of messages transmitted via the respective network communication link. For example, an LQI value of zero or an LQO value of zero in one of the router tables may indicate that the respective router device fails to have a network communication link (e.g., a single-hop network communication link) with the router device listed in the router table. FIG. 2G is an example table 239 that illustrates example link costs that may correspond to different link qualities (e.g., the lesser of LQI value and the LQO value of the respective network communication link). As shown in FIG. 2G, a lower value of the link cost in the table 239 may indicate greater quality of communications via the respective network communication link.

The router devices in the network 200c (e.g., the leader device 215 and the router devices 225a-225f) may use the link cost for each of the network communication links to determine (e.g., calculate) a path cost for communications between the two of the router devices (e.g., any two of the router devices) in the network 200c. The path cost may indicate an overall cost for communicating a message between two of the router devices in the network 200c (e.g., from a starting router device to an ending router device). The path cost may indicate the relative cost or loss of signal strength of messages transmitted between the two of the router devices via a complete communication path that may include one or more of the other router devices in the network 200c. The communication path having the path cost that indicates the highest quality communication path between two of the router devices of the network 200c may be used for transmitting messages between the those two router devices. For example, each of the router devices may calculate the path cost as the sum of the link costs for each of the network communication links via which the message may be transmitted between the two of the router devices (e.g., between the starting router device and the ending router device). Each of the router devices may set the path cost to a device on a single-hop network communication link as being equal to the link cost to that device and store the path cost in the locally-stored router table. For example, the router device 225c may set the path cost for network communication link with the leader device 215 equal to the link cost (e.g., which is based on the lesser of the LQI value and the LQO value) of the network communication link and store the path cost in the locally-stored router table 238. Similarly, the router device 225c may set the path cost for communications with the router device 225b equal to the link cost (e.g., which is based on the lesser of the LQI value and LQO) on network communication link and store the path cost in the locally-stored router table 238.

Each of the router devices in the network 200c (e.g., the leader device 215 and the router devices 225a-225f) may update the path cost for communicating messages to/from each of the router devices in the locally-stored router table based on the path costs received from the other router devices. For example, as the router device 225b may be unable to directly communicate with the leader device 215, the router device 225b may receive path cost for communicating messages through another router device in the network 200c. The router device 225c may transmit a multicast message that include the path cost for communicating messages to/from the leader device 215 (e.g., path cost=2) to the other router devices. The multicast message may be a network status advertisement message, for example. The router device 225b may receive the multicast message including the path cost for communicating messages between the leader device 215 and the router device 225c (e.g., path cost=2). To calculate the total path cost for communicating messages between the router device 225b and the leader device 215 through the router device 225c, the router device 225b may add the link cost for communications between the router device 225b and the router device 225c (e.g., link cost=1) to the path cost received from the router device 225c (e.g., path cost=2) to get a total path cost (e.g., path cost=3). The link cost for communications between the router device 225b and the router device 225c may be determined from the link quality metric of the network communication link between the router device 225b and the router device 225c, which may be the smaller of the LQI value and the LQO value of the respective network communication link (e.g., link quality=3).

Each of the router devices in the network 200c (e.g., the leader device 215 and the router devices 225a-225f) may transmit a network status advertisement message that includes the path cost information including the path costs to one or more other router devices in the network 200c. The router devices that receive the network status advertisement message that includes path cost information may update their respective path cost information in the locally-stored router tables (e.g., by adding their link cost for communications with the router device that sent the network status advertisement message to the path cost in the received message). Each router device may use the path cost information in the locally-stored router table to identify the communication path through which messages may be communicated. For example, messages transmitted from the router device 225b to the leader device 215 may be communicated through the router device 225a or the router device 225c. The router device 225b may receive respective network status advertisement messages from the router device 225a and the router device 225c. The respective network advertisement messages may indicate that the path cost for communication of messages between the router device 225a and the leader device 215 is the same as the path cost for communication of messages between the router device 225c and the leader device 215 (e.g., path cost=2 on each network communication link). The router device 225b may add the link cost determined for communicating messages between the router device 225b and the router device 225c (e.g., link cost=1) to the path cost included in the network status advertisement message received from the router 225c (e.g., path cost=2) to determine the total path cost for communicating with the leader device 215 through the router device 225c (e.g., total path cost=3). The router device 225b may similarly add the link cost determined for communicating messages between the router 225b and the router 225a (e.g., link cost=2) to the path cost included in the network status advertisement message received from the router 225a (e.g., path cost=2) to determine the total path cost for communicating with the leader device 215 through the router device 225a (e.g., total path cost=4). The router device 225b may update a locally-stored router table with the lowest calculated path cost for communicating with the leader device 215 and/or the identifier of the router device through which messages are to be transmitted (e.g., the router 225c). Each of the router devices may similarly update the respective locally-stored router table with the lowest calculated path cost for communicating with the other router devices in the network 200c. For example, as shown in FIG. 2F, the leader device 215 and the router device 225c may each determine the lowest path cost for communicating to other router devices in the network 200c and store the path cost in the respective router tables 228, 238. The router tables 228, 238 may also have stored therein the router identifier of the next hop from the respective devices 215, 225c through which messages are to be communicated to achieve the determine path for communications to the destination router device.

Through periodically updating the link quality metrics (e.g., the LQI value and/or the LQO value), the link costs, and/or the path costs, and communicating the link quality metrics (e.g., the LQI value and/or the LQO value), the link costs, and/or the path costs to the other router devices in network status advertisement messages, each of the router devices may have up-to-date path cost information for communicating messages to other router devices in the network 200c. Each of the router devices may use the best communication path (e.g., having the lowest path cost) for communicating messages to the other router devices. This routing technique may allow the router devices to determine when other router devices have dropped off the network 200c, or a path cost of a communication path between two of the router devices has changed, and determine a communication path having the next lowest cost path to maintain connectivity to other router devices in the network 200c.

In an effort to distinguish relatively older data being transmitted in the network status advertisement messages from relatively newer data transmitted in the network status advertisement messages, each of the network status advertisement messages may include a sequence number. The leader device 215 may be responsible for updating the sequence number and distributing the updated sequence number to the other router devices in the network 200c (e.g., the router devices 225a-225f). For example, the leader device 215 may increment the sequence number periodically (e.g., after transmission of one or more network status advertisement messages) and/or after a router device is added to the network. The sequence number may be updated to allow router devices in the network 200c (e.g., the leader device 215 and/or the router devices 225a-225f) to identify updated network data transmitted in network status advertisement messages. For example, as the router devices in the network 200c (e.g., the leader device 215 and/or the router devices 225a-225f) may periodically communicate network status advertisement messages that include path cost information that indicates the path cost for communicating with the other router devices in the network 200c, the sequence number may be updated to identify that the network status advertisement messages include updated path cost information.

After the leader device 215 updates the sequence number, the leader device 215 may transmit network status advertisement messages including the sequence number to the other router devices 225a-225f in the network 200c. After receiving a network status advertisement message including the updated sequence number, each of the router devices 225a-225f may include the updated sequence number in subsequent network status advertisement messages transmitted from the respective router device in the network 200c. Each of the router devices in the network 200c may include the updated sequence number in the network status advertisement messages transmitted by the respective router device until the respective router device receives a subsequent network status advertisement message including another updated sequence number. For example, the router device 225c may receive a network status advertisement message including an updated sequence number directly from the leader device 215 and include the updated sequence number in subsequent network status advertisement messages. The router device 225b may receive the network status advertisement message including the updated sequence number in the network status advertisement messages transmitted from the router device 225c and include the updated sequence number in subsequent network status advertisement messages transmitted from the router device 225b. Each of the router devices in the network 200c (e.g., the leader device 215 and the router devices 225a-225f) may each include the present sequence number in the network status advertisement messages until a subsequent network status advertisement message including an updated sequence number is received (e.g., that was originated at and distributed from the leader device 215). Each of the router devices 225a-225f may update the network data in the locally-stored router table when the router device receives a network status advertisement message from a non-leader router device (e.g., the router devices 225a-225f) that includes an updated sequence number. If one of the router devices receives a network status advertisement message that includes the same sequence number as a previously-received network status advertisement message, and/or was previously received from the same non-leader router device, the respective router device may fail to process the network status advertisement message. If a router device fails to receive a network status advertisement message including an updated sequence number within a predefined period of time (e.g., minutes, seconds, etc.), the respective router device may assume the leader device 215 is unavailable for communications (e.g., offline, powered off, dropped from the network, changed roles and/or relationships, or is otherwise unable to communicate with the router device) and attempt to form another network and/or network partition having another leader device.

As described herein, the control devices that are attached to a network (e.g., such as the networks 200, 200a, 200b, 200c) may each take on a respective role. Control devices that are assigned certain roles in the network, such as the role of leader device or router device, may be configured to facilitate communication with control devices that are assigned other roles in the network, such as end devices (e.g., including sleepy end devices and/or router-eligible end devices, as described herein). The roles of control devices may be initially assigned on a first-come-first-serve basis. For example, the control devices that attempt to join a network first may be assigned roles that are configured to facilitate the communication of other control devices that subsequently join the network. This may result in degradation of the quality of network communication links as the network evolves and other devices are added to the network, or in the vicinity of the network. For example, control devices may establish network communication links with one another that provide the best quality network links at the time. But over time, the quality of these network communication links may be subject to change and, in certain scenarios (e.g., when noise sources are introduced to the load control environment in which the load control system having the network is installed), the quality of these network communication links may degrade. The initial set of router devices in the network may provide adequate, but less than optimal, coverage. As a result, the network may have network communication links that have lower qualities than desired and may be more susceptible to interference, potentially due to the distance between devices.

Control devices may be assigned to the role of a leader device or a router device during network formation according to a pre-defined procedure (e.g., pre-defined by the respective protocol of the network). The roles of the leader device and the router devices may initially be assigned to control devices on a first-come-first-serve basis during initial network formation (e.g., when the control devices in the network are powered on). For example, after joining a network (e.g., a first network partition), a control device may attempt to initiate attachment to another control device in the network (e.g., by transmitting a parent request message, a child ID request message that includes the identifier of the control device, or another message requesting to be added as a child device) during network formation. If the control device fails to attach the other control device in the network (e.g., fails to receive a response to the request, for example, because a leader device or a router device fails to be in the network), the control device may be assigned the role of a leader device (e.g., the control device may assign itself to the role of the leader device) in a new network (e.g., a second network partition). During network formation, other control devices may join the network and attempt to attach to the control device assigned to the role of the leader device. For example, the other control devices may each initially be assigned the role of an end device in the first network. Further, as described herein, the leader device may approve changes to the roles and/or relationships of other control devices in response to a request, for example, by approving a request to upgrading to the role of router device in response to a request or removing a router device from a router list. In determining to adjust the roles of the other control devices, however, the leader device, the router devices, and/or the end devices may fail to consider the quality of communications on network communication links of a respective control device. Initial network formation may be performed rapidly in order to quickly get to the network into an operational state, and a faster network formation may take preference over quality of communication links on the network.

The threshold criteria for establishing the roles of devices in the network may allow for a base level of communication between the devices in the network. However, when roles of control devices and/or relationships between control devices in the network are assigned during network formation, router devices may be located more remotely from one or more end devices and/or there may be greater interference between router devices and one or more end devices than may be desirable for higher-quality communication links. For example, the one or more end devices may be located around a noise source (e.g., wireless access points (WAPs) or other devices operating on an overlapping frequency spectrum, microwaves, video cameras, security badge readers, and/or other noise sources), which may degrade the quality of the initially established communication links. This may be a result of remotely-located end devices having a limited number of options of router devices to which to attach during network formation. Each router device may be remotely located from one or more of the end devices during formation, which may result in lower quality communication links between the router devices and those end devices than may be desirable for higher-quality communication links. The noise sources and/or other sources of interference (e.g., walls, cubicles, or other barriers) may be introduced into the same environment after the initial network formation, which may affect the quality of the communications to/from the end devices after network formation. As the network may be initially formed with end devices that are remotely located from router devices, the end devices may experience lower-quality network communications than if other devices were upgraded to router devices that were not remotely located. However, the roles of the control devices in the network may be difficult to adjust without negatively affecting or losing other network communication links.

Certain procedures may be performed to adjust network operation and/or network configuration of the network, for example, to adjust the roles of the control devices in the network (e.g., leader device, router devices, and/or end devices) and/or the relationships between devices (e.g., parent-child relationships) based on network optimization characteristics and/or certain network optimization criteria that may be considered for initiating adjustments to the roles of the control devices in the network. For example, the network optimization characteristics may be and/or include network adjustment characteristics, and the network optimization criteria may be and/or include network adjustment criteria. The changes may be initiated by any of the control devices monitoring the network optimization characteristics. Each control device may use the network optimization characteristics measured locally and/or received from other control devices with certain network optimization criteria. The changes to the roles and/or relationships may be made after initial network formation is complete (e.g., stabilized). Each change may be implemented with at least a minimum period of time between changes to allow for the roles and/or relationships of the control devices in the network to be incrementally updated. The minimum period of time between changes may allow the control devices on the network to evaluate each change before initiating another change to the network operation and/or network configuration (e.g., as compared to the rapid process of initial network formation).

To avoid making changes to the roles and/or relationships of the control devices in the network during network formation, or while other control devices are attempting to join and/or attach to control devices that already have an established role as a router device (e.g., leader device or router device), the control devices in the network may wait for an indication of network stabilization. The network stabilization may be indicated after one or more control devices identify that network formation is determined to be stable for at least a network stabilization period (e.g., after the control devices determine that formation is complete). Each control device may receive network status advertisement messages that indicate control devices in the network and/or changes to the control devices in the network, which may be used to determine whether the network is stable. The network may be determined to be stable when the number of control devices in the network remains the same or remains within a predefined range for at least the network stabilization period. The network may be determined to be stable when the roles of the control devices in the network remains the same or the number of changes to the roles of the control devices is within a predefined threshold for at least the network stabilization period. For example, the network may be determined to be stable when the router devices in the network remain the same for at least a network stabilization period. The network may be determined to be stable when the relationships between the control devices in the network remains the same or a number of changes to the relationships between the control devices within a predefined threshold for at least the network stabilization period. The network stabilization may be determined by a single device (e.g., a control device operating as the leader device or another control device in the network) or collectively at a plurality of control devices based on communications between the control devices. The network stabilization period may be a predefined period of time prior to initiating a change to the network operation and/or network configuration. The control devices in the network may identify that formation of the network has stabilized (e.g., has stabilized for the network stabilization period) based on a message from one or more of the control devices (e.g., the leader device) in the network and/or one or more network indicators. The network indicators may include changes, or a lack thereof, of the router devices in the router list for the network stabilization period. For example, the leader device and/or the router devices in the network may advertise the router list in network status advertisement messages, as described herein, and the router list remaining unchanged for the network stabilization period may indicate that formation of the network is stable. The network stabilization period may be a predefined period of time prior to initiating a change to the roles of the control devices in the network.

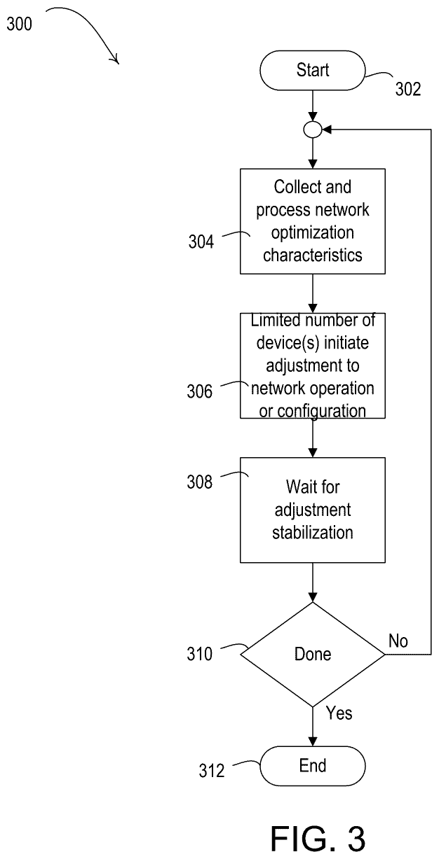

After formation of the network is determined to be stable (e.g., has determined to be stable for a period of time), the control devices may each monitor the network optimization characteristics to determine whether to initiate the adjustments to the network operation (e.g., communication of messages, communication paths, and/or other network operation) and/or network configuration (e.g., the roles of the control devices in the network, relationships between control devices, etc.). Network operation may be performed based on the network configuration, such that updates to the network may be implemented to update the network operation or an individual device may update its network operation independently. FIG. 3 is a flowchart of an example procedure 300 for control devices to collect network data and/or initiate adjustment to network operation and/or network configuration to update and/or attempt to improve network operation. The procedure 300 may be executed by one or more control devices in a load control system that are joined or connected to other control devices in the network (e.g., each of the leader device, router devices, and/or end devices) in order to adjust (e.g., update) and/or attempt to improve network operation.

Each of the control devices in the network may start the procedure 300 at 302 and may begin collecting and processing network optimization characteristics at 304 using the network optimization criteria. The network optimization criteria may include one or more (any) network optimization characteristics. Each of the control devices in the network may collect and process the network optimization characteristics for determining whether to initiate an adjustment to the network operation and/or network configuration (e.g., after the control device has determined that formation of the network has stabilized for a network stabilization period).

In one example, each of the control devices may collect network optimization characteristics at 304 by performing local measurements. For example, each control device may measure a noise floor (e.g., background interference) on the network. The network optimization characteristics may include the respective noise floor measured at each of the control devices in the network. Each of the control devices in the network may collect the network optimization characteristics at 304 based on measurements of messages received from one or more other control devices in the network. For example, each of the control devices may be configured to transmit advertisement messages, which may be measured by receiving control devices for collecting network optimization characteristics. The advertisement messages that are measured for collecting the network optimization characteristics at 304 may include network status advertisement messages and/or network optimization advertisement messages. For example the network optimization advertisement messages may be network adjustment advertisement messages. The periodicity of the transmission of the network optimization advertisement messages may be the same as or different from the periodicity of the transmission of other advertisement messages transmitted on the network, such as network status advertisement messages. Each of the control devices may be configured to collect the network optimization characteristics at 304 based on the measurement of the received network status advertisement messages and/or the received network optimization advertisement messages (e.g., received before and/or during the procedure 300).

The network optimization characteristics may include one or more communication quality metrics that may be determined based on the network status advertisement messages and/or the network optimization advertisement messages received from other control devices in the network. Each of the control devices may determine (e.g., measure) and store one or more communication quality metrics based on the received network status advertisement messages and/or the received network optimization advertisement message along with an indication of the control device that transmitted the network status advertisement messages and/or the network optimization advertisement message, respectively (e.g., the network address). The communication quality metrics may comprise, for example, a received signal strength identifier (RSSI) of the received network status advertisement message and/or the received network optimization advertisement message. The communication quality metrics may comprise a link quality in (LQI) value, a link quality out (LQO) value, a link cost, a path cost, and/or a signal-to-noise ratio (SNR) of communications with a given control device in the network. Each of the control devices may be configured to determine (e.g., calculate) the SNR of communications with a given control device in the network based on one of the communication quality metrics associated with the given control device (e.g., the RSSI of a received network status advertisement message and/or a received network optimization advertisement message) and the noise floor (e.g., the difference between the RSSI and the noise floor). One or more of the communication quality metrics may be averaged over time (e.g., for multiple network status advertisement messages and/or multiple network optimization advertisement messages received over time).

The network optimization characteristics that are collected at a control device at 304 may include other data transmitted in the network status advertisement messages and/or the network optimization advertisement messages from other control devices based on locally stored information. For example, each control device may store locally a number of router devices and/or a number of child devices in the network; the router list or router table that indicates the number of router devices in the network or network partition; a number of router devices from which a device (e.g., a single hop away from the router devices) is receiving messages; a number of child devices that are attached to a the control device (e.g., operating as a router device); potential parent options of the control device (e.g., including router devices within a single hop, which may include router devices with an SNR or other communication quality metric above a predefined threshold for messages being transmitted to and/or received from the router devices) and/or router-eligible end devices within a single hop (e.g., router-eligible end devices with an SNR or other communication quality metric above a predefined threshold for messages being transmitted to and/or received from the router-eligible end devices).

The network optimization characteristics stored at a given control device may be transmitted to other control devices. For example, network optimization characteristics measured at a given control device may be aggregated and shared with other control devices in the network (e.g., via network optimization advertisement messages) for collection and processing of the network optimization characteristics at the other control devices. In an example, the control devices may each collect the network optimization characteristics of control devices within a single hop in the network or control devices from which messages are received within a predefined signal strength, from which network status advertisement messages and/or multiple network optimization advertisement messages are received on particular communication links (e.g., direct communication links), and/or having a predefined relationship (e.g., single-hop relationship, parent/child relationship, etc.) in the network. The network optimization advertisement messages may include the identifier of the network device from which the network optimization characteristics are transmitted and the corresponding network optimization characteristics collected at the control device from which the network optimization advertisement messages are transmitted (e.g., network optimization characteristics related to devices within a single hop or communication links to devices within a single hop in the network). The network optimization characteristics transmitted in network optimization advertisement messages may include local network optimization characteristics at one or more control devices in the network (e.g., a local noise floor or background interference measured at control devices within a single hop from which the network optimization advertisement message is transmitted, an SNR of messages at control devices within a single hop from which the network optimization advertisement message is transmitted, etc.).

The network optimization characteristics transmitted in the network optimization advertisement message may include a link quality of communications transmitted to (e.g., link quality out) and/or received from (e.g., link quality in) one or more other control devices on the network (e.g., as determined and/or stored by the advertising control device). The link quality is an example of a communication quality metric and may be indicated by a link quality value (e.g., a link quality in or link quality out). The network data adjustment characteristics transmitted in the network optimization advertisement message may include a link cost of communications transmitted to and/or received from one or more other control devices on the network (e.g., as determined and/or stored by the advertising control device). The link cost is an example of a communication quality metric may be indicated by a link cost value. The network data adjustment characteristics transmitted in the network optimization advertisement message may include a path cost for communicating to other control devices on the network from the control device transmitting the network optimization advertisement message (e.g., as determined and/or stored by the advertising control device). The path cost may indicate the total of the link costs for each hop between the advertising control device (e.g., the control device from which a message may originate) and one of the router devices (e.g., at which the message may be received) in the network. The network data adjustment characteristics transmitted in the network optimization advertisement message may include a number of hops to a particular device, such as a leader device, a system controller, and/or a border router device. The network data adjustment characteristics may include a child count for router devices. The network data adjustment characteristics transmitted in the network optimization advertisement message may include an amount of time a control device has been on the network or has been a router device.

Router devices (e.g., including the leader device) may transmit different network optimization advertisement messages than end devices. For example, the router devices may transmit router network optimization advertisement messages and the end devices may transmit end device network optimization advertisement messages. End devices (e.g., router-eligible end devices) may be capable of transmitting end device network optimization advertisement messages to gather information for determining whether to upgrade to a router device. Router devices may transmit router network optimization advertisement messages periodically to indicate certain network optimization characteristics that may be available from storage or measurements performed at the router devices. Certain network optimization characteristics may be specifically defined for being included in router network optimization advertisement messages. For example, router network optimization advertisement messages may indicate a number of child devices attached to the router device and/or a SNR of messages received from the child devices.

End devices (e.g., including router-eligible end devices) may periodically transmit end device network optimization advertisement messages to indicate certain network optimization characteristics. Router-eligible end devices may also, or alternatively, transmit end device network optimization advertisement messages. The router-eligible end devices may transmit network data characteristics in separate router device network optimization advertisement messages and end device network optimization advertisement messages, or the same information in a single network optimization advertisement message. Certain network optimization characteristics may be specifically defined for being included in end device network optimization advertisement messages. For example, end device network optimization advertisement messages may indicate potential parent options (e.g., router devices and/or router-eligible end devices) for the end device.

Control devices operating the procedure 300 (e.g., including router devices and end devices) may collect the network optimization characteristics in the network optimization advertisement messages and process the network optimization characteristics at 304 using network optimization criteria, such as advertised cost criteria, to determine an advertised cost for communications performed through or with the control device. Router devices and/or router-eligible end devices may process network optimization characteristics using router advertised cost criteria to determine a router device advertised cost. For example, the router devices may collect network optimization characteristics and use certain router advertised cost criteria (e.g., a number of router devices in the network, a number of child devices, an SNR of messages transmitted to/received from end devices in the network, and/or another router advertised cost criteria) to determine a router device advertised cost. The router advertised cost criteria may include a router-based cost criteria that may cause the router device advertised cost to be biased to a lower value (e.g., a percentage, reduction by a predefined amount, or other lower value) to bias one or more control devices toward becoming a router device. The router-based cost criteria may bias the router device advertised cost to be a lower value to solicit a greater number of end devices with lower end device cost criteria and/or influence a router-eligible end device to upgrade to a router device. The router device advertised cost may be indicated by a value within a relative range of values (e.g., 1-10). The router device advertised cost may be calculated based on an algorithm (e.g., summation) of weighted router advertised cost criteria. The end devices (e.g., including router-eligible end devices) may process network optimization characteristics using end device advertised cost criteria to determine an end device advertised cost. For example, the end devices may collect network optimization characteristics and use certain end device advertised cost criteria (e.g., a number of potential parent devices or router devices above a threshold quality in the network, an SNR of messages transmitted to/received from end devices in the network, and/or another end device advertised cost criteria) to determine the end device advertised cost. The end device advertised cost may be indicated by a value within a relative range of values (e.g., 1-10). The end device advertised cost may be calculated based on an algorithm (e.g., summation) of weighted end device advertised cost criteria. The router-eligible end devices may transmit a router advertised cost and an end device advertised cost in separate router device network optimization advertisement messages and end device network optimization advertisement messages, or in the same network optimization advertisement message.

Each control device may include their advertised cost in the network optimization advertisement messages that are being communicated to other control devices in the network. Control devices receiving the network optimization advertisement messages may use the advertised cost of the network optimization advertisement messages it receives to determine whether to initiate an adjustment to the network operation and/or network configuration. For example, end devices (e.g., including router-eligible end devices) may receive router device network optimization advertisement messages from router devices and/or router-eligible end devices that include respective router device advertised costs. The end devices may evaluate the router device advertised costs of the router device network optimization advertisement messages they receive and determine whether to initiate a change in a parent device from the potential parent devices in the network. The change in the parent device may be initiated when the router device advertised cost of a potential parent is at least a threshold less than the current parent device to which the end device is currently attached as a child device. The threshold may be dynamically updated based on changes in the router device advertised costs received at a given end device. The router-eligible end devices may receive end device network optimization advertisement messages from end devices (e.g., including other router-eligible end devices) that include respective end device advertised costs. The router-eligible end devices may evaluate the end device advertised costs of the end device network optimization advertisement messages they receive and determine whether to initiate a change to upgrade to a router device in the network. The change in the role to a parent device may be initiated when the end device advertised cost of one or more end devices within a single hop (e.g., with a signal strength of communications above a threshold) is at least a threshold less than the router advertised cost of router devices within a single hop (e.g., with a signal strength of communications above a threshold). The threshold may be dynamically updated based on changes in the router device advertised costs and/or end device advertised costs received at a given router-eligible end device.

Each of the control devices may be configured to determine whether to initiate an adjustment to the network operation and/or network configuration (e.g., the roles of the control devices in the network) based on the network optimization characteristics and/or the network optimization criteria, as described herein. One or more control devices may attempt to adjust the network operation and/or network configuration at 306 by initiating a change in the role and/or relationships of the control devices in the network. For example, a control device may initiate an upgrade in a role from an end device (e.g., router-eligible end device) to a router device or a downgrade in a role from a router device to an end device. To initiate a change in role and/or relationships, the control device may send a request to the leader device. For example, a control device operating as an end device (e.g., a router-eligible end device) may send a router request message to the leader device to become a router device in the network. The router request message may be an address solicit message soliciting a router identifier from the leader device, for example. Assuming the leader device approves the upgraded role of the control device to router device, the control device may be added to the router table by the leader device and may begin advertising and operating as a router device, as described herein. The change in role may cause a change in relationships with other control devices in the network. For example, the control device may detach from being the child device of its prior parent-child relationship when operating as an end device and may become the parent device to child devices that are able to attach to the control device. The control device may advertise its status as a router device and respond to requests for establishing an attachment to one or more child devices in the network.

A control device operating as a router device may attempt to adjust the network operation and/or network configuration by initiating a downgrade in a role from a router device to an end device. In one example, the control device may downgrade its role by ceasing to advertise and/or operate as a router device and initiate an attachment procedure to another router device in the network. The leader device may detect the loss of the control device as the router device by failing to detect the unique identifier of the router device (e.g., the router identifier or other unique identifier) in network status advertisement messages and release the control device from the router table. The leader device may remove the router identifier of the control device from the router table. Any control devices that were attached the control device that has ceased operating as a router device may detect the loss of the control device as a router device by failing to detect the unique identifier of the router device (e.g., the router identifier or other unique identifier) in the network status advertisement messages and initiate an attachment procedure to attach to another router device in the network.

In another example, in downgrading its role from a router device to an end device, the control device may send a router release message to the leader device to be released as a router device from the router table by the leader device. The router release message may be sent as a unicast message directly to the leader device or as a multicast message. The router release message may include the unique identifier of the router device (e.g., the router identifier or other unique identifier) to be released from the router table. The leader device may receive the router release message and release the control device from the router table. The leader device may remove the router identifier of the control device from the router table. The receipt of the router release message at the leader device may allow the leader device to release the control device from the router table proactively before the control device leaves the network (e.g., detaches from control devices on the network and/or fails to respond to control devices on the network) or the leader device otherwise waits to determine that the control device has left due to non-responsiveness, which will allow the leader device to update the router table and/or the bitmap sooner than having to wait a period of time to determine that the control device has been lost as a router device. The proactive removal of the control device from the router table and/or the bitmap will allow end devices to identify the loss of their router device from the network earlier, as they will receive the updated router table and/or bitmap and attempt to attach to another router device (e.g., as a parent device or auxiliary parent device) without having to wait a period of time to determine that their router device has been lost due to non-responsiveness. Upon receiving the router release message, the leader device may transmit a network status advertisement message including the updated router table having the bitmap indicating that the identified router device has been removed from the network. The router devices on the network may retransmit the advertisement message until the advertisement message is transmitted to each router device and end device in the network. An end device that is a child device of the control device that has been removed from the router table may, in response to receiving the advertisement message (e.g., from a parent device, an auxiliary parent device, or other router device), identify that its parent device is no longer a router device and send a request message to another router device on the network to request attachment as a child device.

A control device may perform an adjustment to the network operation and/or network configuration by changing a relationship with another control device in the network. For example, a control device operating as an end device may attempt to attach to another router device to change the parent device in its parent-child relationship for better communication on the network. A control device may also, or alternatively, initiate a change from a parent device to a child device, or from child device to a parent device.

To prevent more than a threshold number of control devices from initiating adjustment to the network operation and/or network configuration at the same time or within the same timeframe, and potentially causing a greater negative effect on the network operation and/or network configuration than anticipated, a number of control devices that are allowed to initiate an adjustment to the network operation and/or network configuration at 306 may be limited. For example, a single control device may be limited to initiating an adjustment to the network operation and/or network configuration at a time. To avoid multiple control devices initiating adjustment to the network operation and/or network configuration at the same time, each control device may set a timer to a value that is randomly selected between a maximum and minimum value from the determination to initiate the adjustment to the network operation and/or network configuration. The randomization may prevent multiple control devices from initiating adjustment to the roles of control devices in the network at the same time.

After the limited number of control devices initiate adjustment to the network operation and/or network configuration at 306, each of the control devices may wait for an adjustment stabilization period at 308 (e.g., after receiving one or more adjustment notices). The adjustment stabilization period may prevent additional control devices on the network from reacting to the adjustment by attempting to perform another adjustment prior to the expiration of the adjustment stabilization period.

After the expiration of the adjustment stabilization period, the control devices may determine whether the procedure 300 is complete at 310. The procedure 300 may be performed periodically. If the procedure 300 is determined to be complete, the procedure 300 may end at 312. If the procedure 300 is not complete, the procedure 300 may return to 304 and the control devices may continue to collect and process network data. The control devices may determine that adjustment to the roles of the control devices in the network is complete by each device determining that there is not a preferentially better configuration of the roles of the control devices in the network for improving their communications and failing to determine a need to initiate an adjustment to a role of one of the control devices in the network within a period of time.

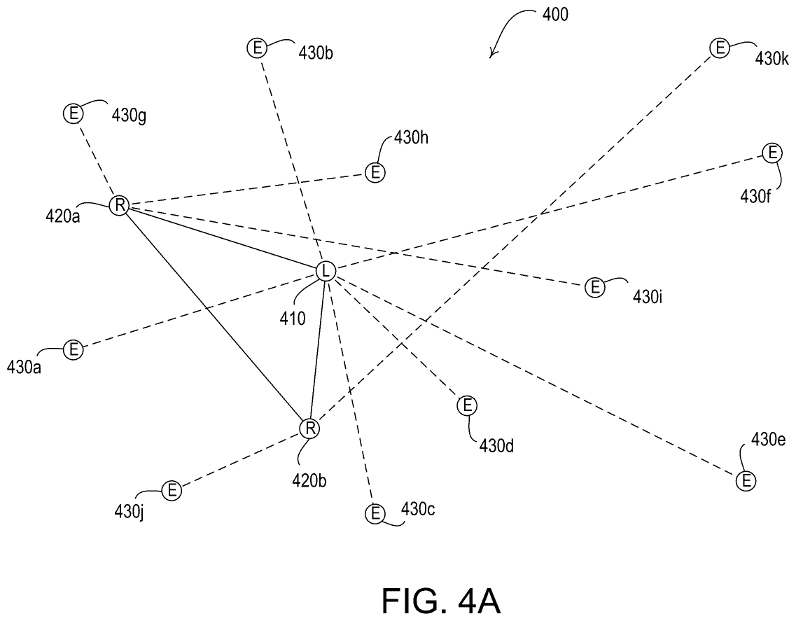

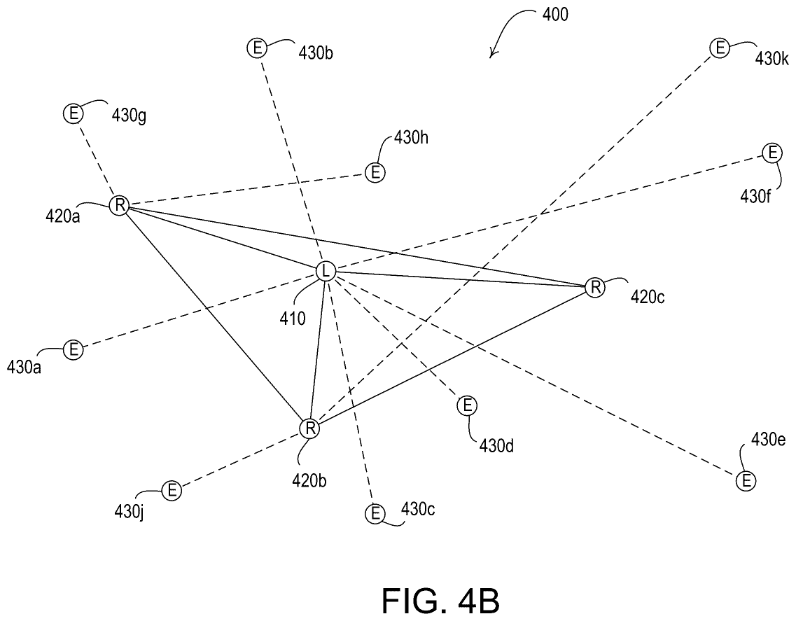

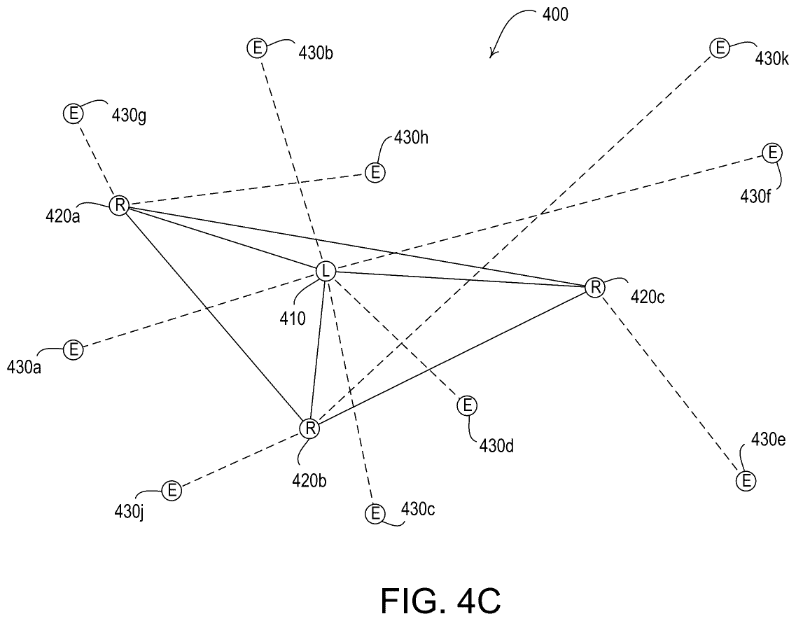

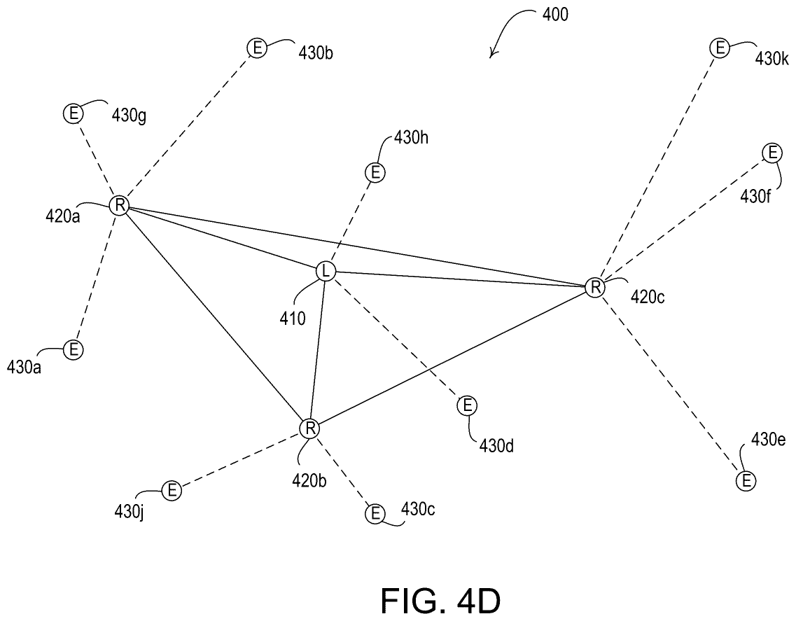

FIGS. 4A-4D include diagrams illustrating examples of a network 400 that includes control devices changing roles and/or relationships over time during a procedure for adjusting the operation and/or configuration of the control devices in the network 400. For example, the network 400 may be a mesh network in which control devices communicate using a mesh network wireless communication protocol (e.g., the THREAD protocol, the CLEAR CONNECT X protocol, and/or other suitable protocol). The operation and/or configuration (e.g., the roles and/or relationships) of the control devices in the network 400 that may be updated or adjusted over time. For example, the number of control devices in the network 400 may change over time and/or the roles and/or relationships of the control devices the network 400 may be updated over time. As shown in FIGS. 4A-4D, the network 400 may comprise a single network partition.

The circled nodes of FIGS. 4A-4D may represent control devices that are attached to other control devices in the network 400 (e.g., the various control devices of the load control system 100 of FIG. 1A). The network communication links between the control devices may be indicated by lines (e.g., solid and dashed lines) that connect the respective control devices. The control devices that are attached to at least one other control device in the network 400 may take on and/or be assigned a respective role in the network 400. In addition, each of the control devices that is attached to at least one other control device in the network 400 may form a relationship (e.g., a parent-child relationship) with one of the at least one other control device in the network 400 (e.g., which may be indicated by a respective dashed line).

As illustrated in FIG. 4A, the network 400 may include a leader device 410, router devices 420a, 420b, and end devices 430a-430k. The router devices 420a, 420b may each be attached to the leader device 410 in the network 400 and may be in communication with each other. The router devices 420a, 420b may be in communication with one another via the network communication links (e.g., as indicated by the solid lines connecting the router devices 420a, 420b). The router devices 420a, 420b may be in communication with the leader device 410, either directly and/or through one or more other router devices (e.g., as indicated by the solid lines connecting the leader device 410 to the router devices 420a, 420b). The leader device 410 may operate as a router device, but also may operate as and/or perform the functions of a leader device, as described herein. The router devices 420a, 420b and the leader device 410 may receive and route messages to other control devices in the network 400 (e.g., the end devices 430a-430k). For example, the router devices 420a, 420b and the leader device 410 may receive and/or transmit messages between end devices, or between each other for communicating messages received from an attached end device to another end device attached to another router device.

The end devices 430a-430k may each be attached to one of the router devices 420a, 420b or the leader device 410 to create a parent-child relationship with the respective one of the router devices 420a, 420b or the leader device 410. The end devices 430a-430k may be router-eligible end devices. One or more of end devices 430a-430h, 430k may be sleepy end devices. Each of the end devices 430a-430k may be attached to one of the router devices 420a, 420b or the leader device 410, which may operate as a parent device to the end device in the parent-child relationship. As indicated in FIGS. 4A-4D, the parent-child relationship (e.g., formed by attachment) between a child device and a respective parent device may be indicated by dashed lines. The leader device 410 and/or the router devices 420a, 420b may be parent devices in the parent-child relationship. The end devices 430a-430k may be child devices in the parent-child relationship. Each child device may have a single parent device. Each parent device may have multiple child devices, a single child device, or no child devices. For example, as indicated in FIG. 4A, the end devices 430g-430i may be attached to the router device 420a, such that the router device 420a may be the parent device of the end devices 430g-430i, and the end devices 430g-430i may be the child devices of the router device 420a. The end devices 430j and 430k may be attached to the router device 420b, such that the router device 420b may be the parent device of the end devices 430j and 430k, and the end devices 430j and 430k may be the child devices of the router device 420b. The end devices 430a-430f may be attached to the leader device 410, such that the leader device 410 may be the parent device of the end devices 430a-430f, and the end devices 430a-430f may be the child devices of the leader device 410.

After one of the end devices 430a-430k attaches to one of the router devices (e.g., the leader device 410 and/or the router devices 420a, 420b) in a parent-child relationship, a network communication link (e.g., an attachment between the parent and the child) may be established between the respective one of the end devices 430a-430k and the respective one of the router devices. The end devices 430a-430k may transmit to and/or receive messages from the other control devices in the network 400 via its attached parent device (e.g., one of the leader device 410 or the router device 420a, 420b) through the network communication link (e.g., the attachment between the parent device and the child device). Each of the end devices 430a-430k may transmit messages to their respective parent device (e.g., one of the router devices 420a, 420b or the leader device 410) and the parent device may route the message to the intended recipient, as described herein. In addition, the respective parent device (e.g., the one of the router devices 420a, 420b or the leader device 410) may store and/or relay messages that are sent by their respective attached child devices. Similarly, the respective parent device (e.g., the one of the router devices 420a, 420b or the leader device 410) may receive messages intended for their respective child device and route the message to the appropriate child device.

Control devices (e.g., the leader device 410, the router devices 420a, 420b, and/or the end devices 430a-430k) may be configured to transmit unicast messages, multicast messages, and/or broadcast messages to other devices in the network 400. For example, child devices may be configured to transmit unicast messages to their respective parent device (e.g., and may not be configured to transmit multicast or broadcast messages), while a router device may transmit a broadcast message and/or a multicast message to one or more end devices. Both router devices and end devices (e.g., parent devices and child devices) may receive multicast messages. Multicast messages may include a group identifier (ID) that identifies the device(s) to which the multicast message is sent. For example, a given multicast message may be intended for a group of control devices (e.g., which may include one or more end devices and/or router devices), and may include a group ID that identifies the control devices in the group. The control devices that are members of the group may recognize the group identifier in a multicast message and process the message accordingly. A router device (e.g., the leader device 410 and/or the router devices 420a, 420b) may send one or more broadcast messages the control devices in the network 400 (e.g., that are capable of receiving the message). A control device (e.g., the leader device 410, the router devices 420a, 420b, and/or the end devices 430a-430k) that receives a broadcast message may process the message accordingly. Each of the control devices in the network 400 may receive and process broadcast messages, multicast messages directed to a group of which the control device is a member, and/or unicast messages directed to the control device.

The router devices (e.g., the leader device 410 and the router devices 420a, 420b) may transmit network status advertisement messages as broadcast and/or multicast messages that may be processed at each of the control devices in the network 400, as described herein. The network status advertisement messages may be transmitted by the router devices in the network 400 periodically and/or after another predetermined condition is met. For example, the end devices 430a-430k may each receive network status advertisement messages periodically from the router devices 420a, 420b and/or the leader device 410. The end devices 430a-430k may each be configured to process the network status advertisement messages whether or not the network status advertisement messages are received from the respective parent device of the end device. The router devices 420a, 420b may each receive and process the network status advertisement messages from the other router device 420a, 420b and/or the leader device 410. The leader device 410 may receive and process network status advertisement messages from the router devices 420a, 420b.

The network status advertisement messages may enable other control devices to determine that the network 400 has been formed and/or that the network 400 is stable or has been stable (e.g., the roles and/or relationships of the control devices have not changed) for a network stabilization period, as described herein. For example, the leader device 410 and/or the router devices 420a, 420b may periodically transmit network status advertisement messages that indicate the router devices in the network 400. For example, the network status advertisement messages may include a router list including router identifiers and/or a bitmap that may be used to indicate the router identifiers of the router devices in use in the network 400. The network status advertisement messages may indicate changes to the router devices (e.g., the router identifiers) identified in the router list and/or the bitmap in the network 400. The control devices in the network 400 may receive the network status advertisement messages and may determine whether the network 400 has stabilized and/or whether the network 400 has been stable for at least the network stabilization period based on the router list being maintained (e.g., including the same router devices, the same number of router devices, or less than a threshold amount of change in the router devices and/or the number of router devices identified in the router list and/or the bitmap) for the network stabilization period. After formation of the network 400 and/or changes to the roles and/or relationships of the control devices in the network, the network stabilization period may be a predefined period of time that is awaited prior to a control device initiating a subsequent change to the roles and/or relationships of the control devices in the network 400, which may allow for additional changes in the operation and/or configuration of the control devices to be propagated throughout the network 400 prior to initiation of another change. In another example, a control device, such as the control device that is assigned the role of leader device, may send a message indicating that the network 400 is stable (e.g., based on the router list maintained by the leader device 410).

After the network stabilization period has ended, each of the control devices in the network 400 (e.g., the leader device 410, the router devices 420a, 420b, and/or the end devices 430a-430k) may begin evaluating network optimization characteristics to determine whether to initiate an adjustment to the operation and/or configuration of the network 400 (e.g., to the roles and/or relationships of the control devices in the network 400). For example, the router devices 420a, 420b (e.g., and/or the leader device 410) may each evaluate the network optimization characteristics to determine whether to downgrade their role from a router device to an end device. The end devices 430a-430k may each evaluate the network optimization characteristics to determine whether to upgrade their role from an end device to a router device. The network optimization characteristics may also, or alternatively, be evaluated to determine whether to change a parent-child relationship (e.g., attaching to another parent device). Each control device in the network 400 (e.g., the leader device 410, the router devices 420a, 420b, and/or the end devices 430a-430k) may process the network optimization characteristics collected from other control devices and stored locally at the control device for performing communications on the network 400 for determining whether to adjust the operation and/or configuration of the network 400 (e.g., to the roles and/or relationships of the control devices in the network 400).

The network optimization characteristics may be determined based on local measurements that are performed and/or network optimization advertisement messages that may include the network data characteristics of other control devices in the network 400, or from which the network data characteristics may be measured by other control devices. The leader device 410 and/or the router devices 420a, 420b may transmit different network optimization advertisement messages than end devices 430a-430k. For example, the leader device 410 and/or the router devices 420a, 420b may each transmit router network optimization advertisement messages, as described herein. The end devices 430a-430k may each transmit end device network optimization advertisement messages, as described herein. The network optimization advertisement messages may be transmitted as broadcast messages or multicast messages. For example, each of the router devices (e.g., the leader device 410 and/or the router devices 420a, 420b) may transmit the network optimization advertisement messages as single-hop broadcast messages such that control devices within a single hop may receive the network optimization advertisement messages even when the control devices do not have a respective network communication link (e.g., an attachment) with the router device that transmitted the network optimization advertisement message.

Each of the control devices in the network (e.g., the leader device 410, the router devices 420a, 420b, and/or the end devices 430a-430k) may process the network optimization characteristics using advertised cost criteria to determine an advertised cost for communications performed through or with the control device. Router devices (e.g., the leader device 410 and the router devices 420a, 420b) and/or router-eligible end devices of the end devices 430a-430k may process the network optimization characteristics using router advertised cost criteria. The router cost criteria may include or use any of the network optimization characteristics. For example, the network optimization characteristics may include a number of router devices in the network, a number of child devices, and/or an SNR of messages transmitted to/received from end devices in the network to determine a router device advertised cost. The router device advertised cost may be calculated based on an algorithm (e.g., summation) of router advertised cost criteria. The end devices 430a-430k (e.g., including router-eligible end devices) may process the network optimization characteristics using end device advertised cost criteria to determine an end device advertised cost. The end device advertised cost may be calculated based on an algorithm (e.g., summation) of end device advertised cost criteria.

Each control device may include their advertised cost in the network optimization advertisement messages that are being communicated to other control devices in the network and may use the advertised cost of the network optimization advertisement messages it receives to determine whether to initiate an adjustment to the network operation and/or network configuration (e.g., the roles and/or relationships of the control devices in the network 400). For example, each of the end devices 430a-430k (e.g., that may be a router-eligible end device) may evaluate the router device advertised costs received from the router devices 420a, 420b and the leader device 410 in the router network optimization advertisement messages and the child device advertised costs received from the end devices 430a-430k in the end device network optimization advertisement messages to determine whether to upgrade their role from an end device to a router device. The advertised costs may also, or alternatively, be evaluated to determine whether to change a parent-child relationship (e.g., attaching to another parent). For example, each of the end devices 430a-430k may evaluate the router device advertised costs received from the router devices 420a, 420b and the leader device 410 in the router network optimization advertisement messages to determine to transmit a request message (e.g., parent request message) to another one of the router devices 420a, 420b and the leader device 410 to change the parent device to which it is attached. In one example, the end device 430i (e.g., that may be a router-eligible end device), based on the evaluation of the router device advertised costs received from the router devices 420a, 420b and the leader device 410 and/or one or more end device costs of the end devices (e.g., the end devices, 430k, 430f, 430e) performed at the end device 430i, the end device 430i may initiate a change to upgrade from an end device to a router device. The end device 430i may send a message (e.g., a router request message or address solicit message via router device 420a) to the leader device 410 requesting to become a router device in the network 400. The leader device 410 may approve the upgraded role of the end device 430i to a router device and the control device may be added to the router table by the leader device 410.

As shown in FIG. 4B, the former end device 430i may be upgraded to the role of a router device and may now be represented by a router device 420c in the network 400. The router device 420c may be identified in the updated router list indicated in the network status advertisement messages from the leader device 410. The router devices 420a-420c may receive the upgraded router list in the network status advertisement messages and upgrade a locally stored router table to include the router device 420c. The router device 420c may begin advertising in the manner of a router device, as described herein. The router device 420c may be in communication with the other router device 420a, 420b via network communication links (e.g., as indicated by the solid lines connecting the router devices 420a-420c). The router device 420c may be in communication with the leader device 410, either directly and/or through one or more other router devices (e.g., through the network communication links indicated by the solid lines connecting the leader device 410 to the router device 420c).

The upgrade of the router device 420c (e.g., from the role of an end device to the role of a router device) may cause a change in roles and/or relationships with other control devices in the network 400. For example, when upgrading to the router device 420c the control device may detach from being the child of the router device 420a and may become the parent device to one or more child devices that are able to attach to the control device. The router device 420c may advertise its status as a router device and respond to request messages for establishing an attachment to one or more child devices in the network.

As shown in FIGS. 4C and 4D, the end devices 430e, 430f, and 430k may receive the network status advertisement messages from the router device 420c and attach to the router device 420c for performing communications on the network 400. In another example, each of the end devices 430e, 430f, and 430k may receive router network optimization advertisement messages that include a router device advertised cost from the router device 420c and one or more other router devices (e.g., the router devices 420a, 420b and the leader device 410) and evaluate the router device advertised costs to determine whether to initiate an update to their parent-child relationship. As indicated by the dashed lines in FIG. 4C, the end device 430e may establish an updated parent-child relationship (e.g., formed by attachment) with the router device 420c. For example, the end device 430e may determine, based on the evaluation of the router device advertised cost from the router device 420c and one or more other router devices (e.g., the router devices 420a, 420b and the leader device 410), that it would have a stronger communication link to the router device 420c than the leader device 410 and transmit a request message to the router device 420c for attaching to the router device 420c as a child device. The router device 420c may attach to the end device 430e becoming the parent of the end device 430e in the parent-child relationship.

As indicated by the dashed lines in FIG. 4D, the end devices 430f, 430k may each establish an updated parent-child relationship (e.g., formed by attachment) with the router device 420c. For example, the end devices 430f, 430k may each determine, based on the evaluation of the router device advertised cost from the router device 420c and one or more other router devices (e.g., the router devices 420a, 420b and the leader device 410), that it would have a stronger communication link to the router device 420c than the leader device 410 and transmit a request message to the router device 420c to establish a parent-child relationship. The router device 420c may attach to the end devices 430f, 430k becoming the parent of the end devices 430f, 430k in the parent-child relationship.

After the control device determines to change its role from the end device 430i to the router device 420c, the control device that is initiating the change may transmit an adjustment notice. The adjustment notice may be included in a broadcast message or a multicast message to be received by other control devices in the network. The adjustment notice may be sent as a unicast message to one or more other control devices (e.g., parent device or leader device in the network) that may transmit a broadcast or a multicast message that includes the adjustment notice. The adjustment notice may be transmitted in a message configured to execute the adjustment on the network. For example, the control device may transmit a single message (e.g., a router request message or address solicit message) that is configured to initiate the adjustment and trigger a notification (e.g., directly or via a broadcast/multicast message from another device, such as a parent device or leader device in the network) of the adjustment to other control devices in the network.

Each additional adjustment to the network operation and/or network configuration may be delayed by an adjustment stabilization period. For example, control devices may await the adjustment stabilization period before initiating a change in a role and/or a relationship with other devices in the network 400. As shown in FIG. 4C, the end device 430e may identify the change in the role of the control device from the end device 430i to the router device 420c and await for an expiration of the adjustment stabilization period before initiating an attachment to the router device 420c. For example, after the control device illustrated as the end device 430i in FIG. 4A sends a router request message (e.g., address solicit message) to be upgraded and/or is upgraded to the router device 420c, as illustrated in FIG. 4B, the control devices (e.g., the leader device 410, the router devices 420a, 420b, and/or the end devices 430a-430k) in the network 400 may each await an adjustment stabilization period before determining initiating additional adjustments to the role of a control device in the network 400. The control devices in the network 400 may identify a change in the router list in network status advertisement messages from the leader device 410 and/or the router devices 420a-420c, or detect the network status advertisement messages from the upgraded router device 420c and wait the adjustment stabilization period. After the adjustment stabilization period has ended, the control devices (e.g., the leader device 410, the router devices 420a, 420b, and/or the end devices 430a-430k) in the network 400 begin transmitting network optimization advertisement messages and/or initiating adjustments to the roles of one or more control devices based on the network optimization characteristics, as described herein. For example, the end device 430e may identify the change in the role of the control device from the end device 430i to the router device 420c and await for an expiration of the adjustment stabilization period before initiating an attachment to the router device 420c.

Each of the end devices 430f, 430k may also await the expiration of an additional adjustment stabilization period (e.g., after a prior change in a parent-child relationship) before initiating an updated parent-child relationship (e.g., formed by attachment) with the router device 420c. Though examples are provide for each control device awaiting the adjustment stabilization period before initiating another change in network operation and/or network configuration, there may be certain types of changes to the network operation and/or network configuration that may trigger the delay by the adjustment stabilization period. For example, control devices in the network 400 may await the adjustment stabilization period after a change in a role and/or relationship of a control device in the network 400. Certain types of changes in network operation and/or network configuration may be delayed by the adjustment stabilization period. For example, additional changes to roles of control devices in the network 400 after the change in the role of a device may be delayed by the adjustment stabilization period, which may allow for changes to relationships to be performed without the additional delay caused by the adjustment stabilization period.

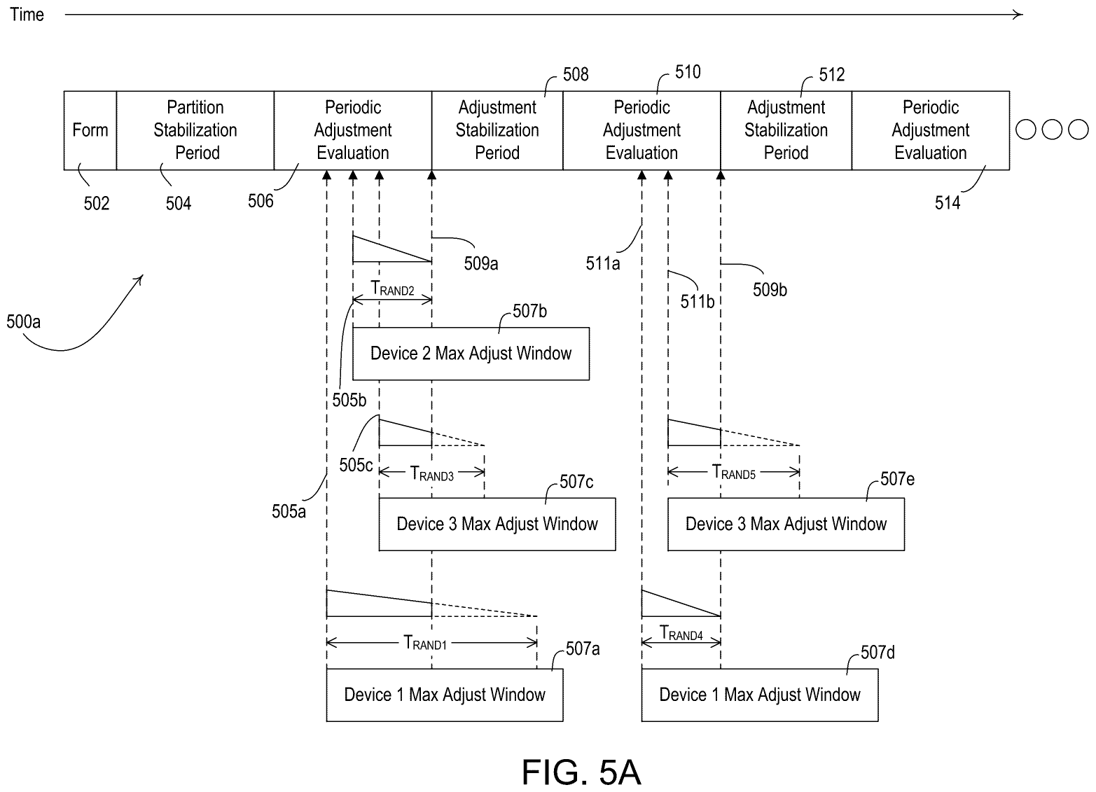

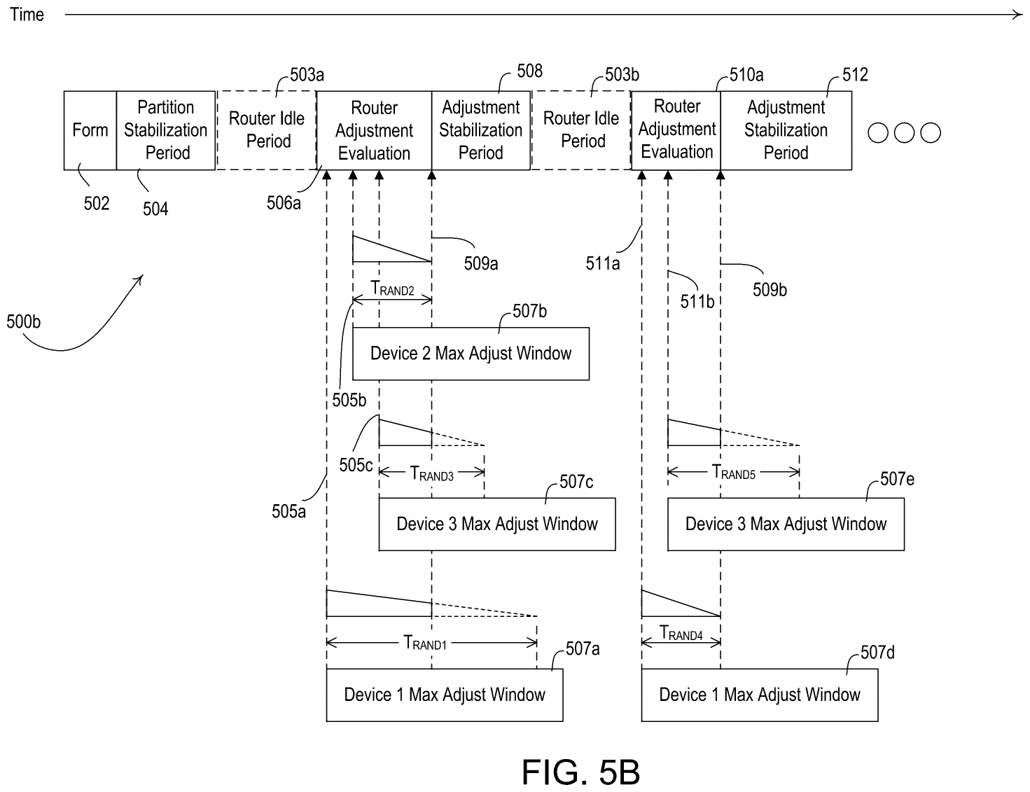

FIG. 5A is a diagram illustrating a timeline of an example procedure 500a. As shown in FIG. 5A, the example procedure 500a may be performed after formation of a network (e.g., the network 400) at 502, or after the network formation has been determined by the control devices to be stabilized for a network stabilization period 504. The network stabilization period 504 may be a stabilization period for the network. After the network stabilization period 504, each of the control devices may collect network optimization characteristics locally and from other control devices during an adjustment evaluation period 506. During the adjustment evaluation period 506, the control devices may each receive network optimization advertisement messages from other control devices and determine whether to initiate an adjustment to network operation and/or network configuration (e.g., by changing a role of a control device or a relationship between control devices in the network). The network optimization advertisement messages may each include network optimization characteristics and/or an advertised cost of performing communications with or through the control device from which the network optimization advertisement message is received.

To prevent control devices from initiating potentially conflicting requests for adjustments to the network operation and/or network configuration, each control device that is triggered, based on the collected network optimization characteristics and/or an advertised costs, to initiate an adjustment to the network operation and/or network configuration may set a random backoff timer within a predefined timeframe before initiating the network adjustment. For example, as shown in FIG. 5A, a first control device may determine at 505a to initiate a network adjustment and set a random backoff timer T_{RAND1} within a maximum adjustment window 507a. A second control device may determine at 505b to initiate a network adjustment and set a random backoff timer T_{RAND2} within a maximum adjustment window 507b. A third control device may determine at 505c to initiate a network adjustment and set a random backoff timer T_{RAND3} within a maximum adjustment window 507c.

The maximum adjustment windows 507a, 507b, 507c may be the same or different. For example, the maximum adjustment window within which each of the random backoff timers are generated may be different based on the type of network adjustment to be performed (e.g., change in role or relationship). In another example, the maximum adjustment window within which each of the random backoff timers are generated may be different based on the relative difference in advertised costs of control devices within a single hop. The maximum adjustment window may be changed based on an amount improvement to the network communications performed within the network. The amount of improvement may be evaluated by a change in one or more network optimization characteristics and/or one or more advertised costs of devices within a single hop. A control device may attempt to prioritize its network adjustment by decreasing the time period of the maximum adjustment window and/or the random backoff timer. Relatively larger improvements to the network may cause the control device to decrease the size of the maximum adjustment window and/or the random backoff timer, while relatively smaller improvements to the network may cause the control device to increase the size of the maximum adjustment window and/or the random backoff timer. Router upgrades and/or downgrades may be considered larger improvements and given a higher priority than end devices changing parent devices or other relationship changes.

As shown in FIG. 5A, the random backoff timer T_{RAND2} set by the second control device may expire at 509a before the other random backoff timers that have been set and the second control device may initiate a change to a network operation and/or network configuration at 509a. For example, the second control device may initiate an upgrade (e.g., an update request) in the role from an end device to a router device.

After the second control device determines to initiate the upgrade to the router device and the random backoff timer T_{RAND2} expires, the second control device may transmit an adjustment notice at 509a. The adjustment notice 509a may be included in a broadcast message or a multicast message to be received by other control devices in the network. The adjustment notice 509a may be sent as a unicast message to one or more other control devices (e.g., parent device or leader device in the network) that may transmit a broadcast or a multicast message (e.g., a network status advertisement message) that includes the adjustment notice. The adjustment notice 509a may be received by one or more control devices to notify the control devices that another control device has initiated an adjustment to the network. The adjustment notice may be transmitted in a message configured to execute the adjustment of the role of one of the control devices in the network. For example, the second control device may transmit a single message (e.g., a router request message or address solicit message) that is configured to initiate the adjustment and trigger a notification (e.g., directly or via a broadcast and/or multicast message from another device, such as a parent device or leader device in the network) of the adjustment to other control devices in the network. Additionally, or alternatively, the other control devices may detect the change in the role and/or relationships of the control device, and the control devices in the network may await an adjustment stabilization period 508. The adjustment stabilization period 508 after an adjustment to the role of the control device may be the same or a different period of time than the network stabilization period 504 after formation of the network. The adjustment stabilization period 508 may prevent additional control devices in the network from reacting to the adjustment by attempting to perform another adjustment prior to the expiration of the adjustment stabilization period 508.

The control device may execute the network adjustment by sending the adjustment notice 509a, or the adjustment notice 509a may be sent in a separate message than messages communicated to initiate the network adjustment. For example, the control device may initiate a change (e.g., upgrade or downgrade) in a role and/or a relationship with other control devices in the network. The adjustment notice 509a may be transmitted in a message configured to execute the adjustment of the role of one of the control devices in the network. For example, the control device may transmit a single message (e.g., a router request message and/or address solicit message, a router release message, a parent request message, or another message configured to initiate the network adjustment) that is configured to initiate the adjustment and trigger a notification (e.g., directly or via a broadcast/multicast message from another device, such as a parent device or leader device in the network) of the adjustment to the role of another control device in the network.

After the adjustment notice 509a is sent and the control devices await the adjustment stabilization period 508, each of the control devices may collect network optimization characteristics locally and/or from other control devices during an adjustment evaluation period 510. During the adjustment evaluation period 510, the control devices may each receive network optimization advertisement messages from other control devices and determine whether to initiate an adjustment to the network operation and/or network configuration (e.g., by changing a role of one of the control devices and/or the relationship between one or more of the control devices in the network). The first and third control devices that previously determined that they wanted to initiate a network adjustment may have queued their prior request for network adjustments and may re-evaluate whether to initiate the network adjustments based on the collected network optimization characteristics at a later time. In another example, the first and third control devices may re-evaluate whether to initiate a network adjustment based on the collected network optimization characteristics.

As shown in FIG. 5A, the first control device may determine at 511a to initiate a network adjustment and set a random backoff timer T_{RAND4} within a maximum adjustment window 507d. The maximum adjustment window 507d may be the same or different than the maximum adjustment window 507a. The third control device may determine at 511b to initiate a network adjustment and set a random backoff timer T_{RAND5} within a maximum adjustment window 507e. The maximum adjustment window 507e may be the same or different than the maximum adjustment window 507c.

As shown in FIG. 5A, the random backoff timer T_{RAND4} set by the first control device may expire at 509b before the other random backoff timer that has been set and the first control device may initiate a change to a network operation and/or network configuration at 509b. For example, the first control device may initiate a change in an attachment to a parent device by transmitting a request message to another router device in the network to establish a parent-child relationship. The first control device may transmit an adjustment notification at 509b, which may be sent in the same message that initiates the adjustment to the network or in a separate adjustment notification message.

After the first control device initiates the change in the parent device at 509b and/or the other control devices detect the change, the control devices in the network may await an adjustment stabilization period 512. The adjustment stabilization period 512 may prevent additional control devices in the network from reacting to the adjustment by attempting to perform another adjustment prior to the expiration of the adjustment stabilization period 512. After the adjustment stabilization period 508, each of the control devices may collect network optimization characteristics locally and from other control devices during an adjustment evaluation period 514. The control devices may each receive network optimization characteristics and/or advertised costs in network optimization advertisement messages, as described herein. The timeline of the procedure 500a may continue for attempting to improve the network operation or until an end condition is met.

As described herein, the periodic adjustment evaluations 506, 510, 514 may be used for adjustments to upgrades from the role of end devices to the role of router device and/or adjustments to downgrade the roles of router devices to a role of end device (e.g., rather than having end devices (e.g., including router-eligible end devices) wait for the periodic adjustment evaluations 506, 510, 514 to initiate changes in the parent devices to which they are attached). Adjustments to relationships between router devices and end devices may be performed during other periods of time and the router devices and/or end devices may wait for periods of time to allow for the relationships between router devices and/or end devices to be updated prior to evaluating and/or initiating adjustments to upgrade from the role of end devices to the role of router device and/or downgrade from the role of router device to the role of end device.

FIG. 5B is a diagram illustrating a timeline of an example procedure 500b. The timeline of the example procedure 500b, shown in FIG. 5B, is similar to the timeline of the example procedure 500a, shown in FIG. 5A, and includes router idle periods 503a, 503b to allow for adjustments to relationships between router devices and end devices to be performed prior to periodic evaluations and/or initiation of adjustments to upgrade/downgrade the roles of a devices during router adjustment evaluation periods 506a, 510a.

As shown in FIG. 5B, the example procedure 500b may be performed after formation of the network at 502, or after the network formation has been determined by the control devices to be stabilized for a network stabilization period 504. After the network stabilization period 504, the router devices and/or router-eligible end devices may await a router idle period 503a while the relationships between router devices and end devices are updated. During the router idle period 503a, each of the router devices and/or end devices may be communicating/collecting network optimization advertisement messages for determining an adjustment to be made on the network. The end devices may collect network optimization characteristics and/or router advertised costs from router devices within a single hop for determining whether to change parent devices during the router idle period 503a. The network optimization characteristics and/or router advertised costs may be transmitted in router network optimization advertisement messages. During the router idle period 503a, the end devices may each determine, based on the network optimization characteristics and/or router advertised costs received in the router network optimization advertisement messages, whether to attach to other router devices to improve communication quality of communications performed on the network. The router idle period 503a may allow for changes to relationships between router devices and end devices to be performed prior to periodic adjustments to change the role of router devices in the network.

After the router idle period 503a, the router devices and/or router-eligible end devices may evaluate whether to adjust their roles during the periodic adjustment evaluation based on router network optimization advertisement messages received from other router devices and/or router-eligible end devices. During the router adjustment evaluation period 506a, the router devices and/or router-eligible end devices may determine whether to initiate an adjustment to a role in the network based on the network optimization characteristics and/or router advertised costs received in router network optimization advertisement messages from router devices within a single hop. To prevent router devices and/or router-eligible end devices from initiating potentially conflicting requests for adjustments to roles in the network, each device that is triggered, based on the collected network optimization characteristics, to initiate an adjustment to the network operation and/or network configuration may set a random backoff timer within a predefined timeframe before initiating the network adjustment. For example, as shown in FIG. 5B, a first control device may determine at 505a to initiate a network adjustment and set a random backoff timer T_{RAND1} within a maximum adjustment window 507a. A second control device may determine at 503b to initiate a network adjustment and set a random backoff timer T_{RAND2} within a maximum adjustment window 507b. A third control device may determine at 505c to initiate a network adjustment and set a random backoff timer T_{RAND3} within a maximum adjustment window 507c.

The maximum adjustment windows 507a, 507b, 507c may be the same or different. For example, the maximum adjustment window within which each of the random backoff timers are generated may be different based on an amount of improvement to the network communications performed on the network. The amount of improvement may be evaluated by a change in one or more network optimization characteristics and/or advertised costs of communications. For example, the amount of improvement may be evaluated by a change in an advertised cost of one or more devices with which a control device is communicating. A router device or router-eligible end device may attempt to prioritize its network adjustment by decreasing the time period of the maximum adjustment window and/or the random backoff timer. Relatively larger improvements to the network may cause the router device or router-eligible end device to decrease the size of the maximum adjustment window and/or the random backoff timer, while relatively smaller improvements to the network may cause the router device or router-eligible end device to increase the size of the maximum adjustment window and/or the random backoff timer. The priority of the improvement may be based on a change in costs for performing communications on the network.

As shown in FIG. 5B, the random backoff timer T_{RAND2} set by the second control device may expire at 509a before the other random backoff timers that have been set and the second control device may initiate a change to a network operation and/or network configuration at 509a. For example, the second control device may initiate an upgrade in the role from an end device to a router device.

After the second control device determines to initiate the upgrade to the router device and the random backoff timer T_{RAND2} expires, the second control device may transmit an adjustment notice at 509a. In one example, upgrades/downgrades to router devices may be detected from router list received from the leader device and/or messages received from other control devices. After the adjustment to the network is initiated by the second control device, the control devices on the network may await an adjustment stabilization period 508. The adjustment stabilization period 508 may prevent additional control devices on the network from reacting to the adjustment by attempting to perform another adjustment prior to the expiration of the adjustment stabilization period 508.

After the adjustment notice 509a is sent and the control devices await the adjustment stabilization period 508, the router devices and/or router-eligible end devices may await a router idle period 503b while the relationships between router devices and end devices are updated. During the router idle period 503b, each of the end devices may collect network optimization characteristics locally and/or from other router devices. During the router idle period 503b, the end devices may each receive router network optimization advertisement messages from router devices that include router advertised costs and determine whether to attach to other router devices to improve communication quality of communications performed on the network. The router idle period 503b may allow for changes to relationships between router devices and end devices to be performed prior to periodic adjustments to change the role of router devices in the network.

After the router idle period 503b, the router devices and/or router-eligible end devices may evaluate whether to adjust their roles during the periodic adjustment evaluation based on router network optimization advertisement messages received from other router devices and/or router-eligible end devices. During the router adjustment evaluation period 510a, the router devices and/or router-eligible end devices may determine whether to initiate an adjustment to a role in the network based on the network optimization characteristics and/or router advertised costs received in router network optimization advertisement messages. The first and third control devices that previously determined that they wanted to initiate a network adjustment may have queued their prior request for network adjustments and may re-evaluate whether to initiate the network adjustments based on the collected network optimization characteristics at a later time. In another example, the first and third control devices may re-evaluate whether to initiate a network adjustment based on the collected network optimization characteristics.

As shown in FIG. 5B, the first control device may determine at 511a to initiate a network adjustment and set a random backoff timer T_{RAND4} within a maximum adjustment window 507d. The maximum adjustment window 507d may be the same or different than the maximum adjustment window 507a. The third control device may determine at 511b to initiate a network adjustment and set a random backoff timer T_{RAND5} within a maximum adjustment window 507e. The maximum adjustment window 507e may be the same or different than the maximum adjustment window 507c.

As shown in FIG. 5B, the random backoff timer T_{RAND4} set by the first control device may expire at 509b before the other random backoff timer that has been set and the first control device may initiate a change to a network operation and/or network configuration at 509b. For example, the first control device may initiate a change in the role in the network by transmitting a router release message to the leader device to be released as a router device from the router table by the leader device in the network. The first control device may transmit an adjustment notification at 509b, which may be sent in the same message that initiates the adjustment to the network (e.g., the router release message) or in a separate adjustment notification message.

After the first control device initiates the change in the parent device at 509b and/or the other control devices detect the change, the control devices on the network may await an adjustment stabilization period 512. The adjustment stabilization period 512 may prevent additional control devices on the network from reacting to the adjustment by attempting to perform another adjustment prior to the expiration of the adjustment stabilization period 512. After the adjustment stabilization period 512, the timeline of the procedure 500b may continue for attempting to improve the network operation or until an end condition is met.

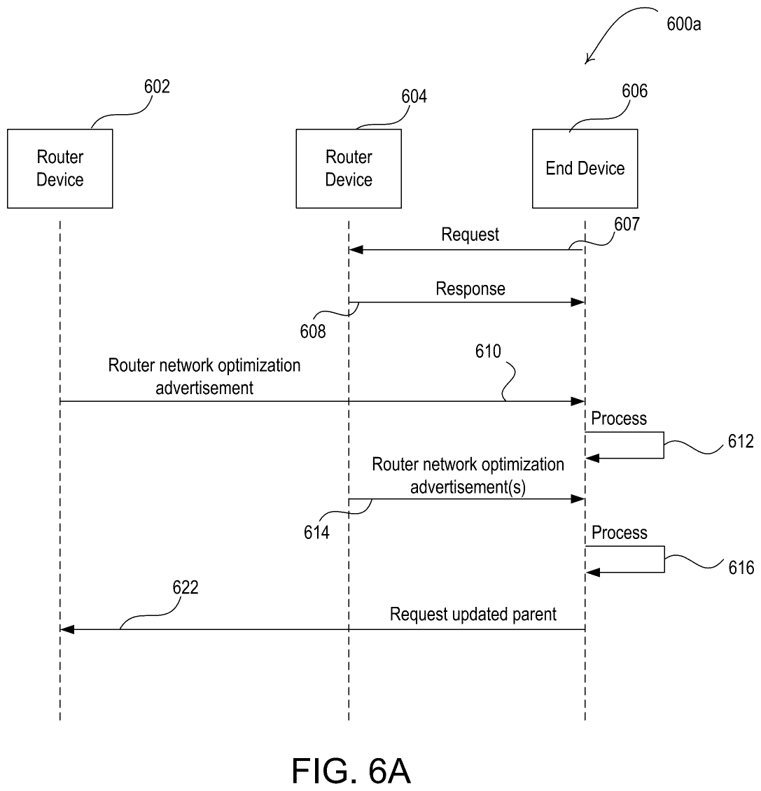

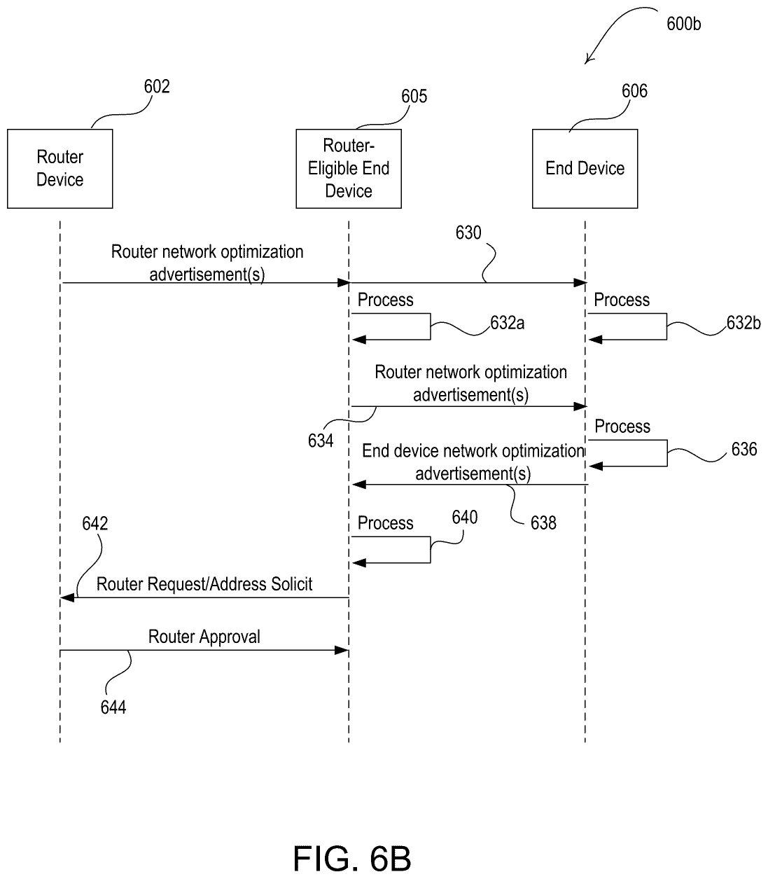

FIGS. 6A and 6B are sequence flow diagrams illustrating example sequence flows 600a, 600b, respectively, illustrating messages communicated between control devices having certain roles in a network for performing adjustments to network operation and/or network configuration. As shown in FIG. 6A, the network may include one or more router devices 602, 604. One of the router devices 602, 604 may be a leader device. The network may also include one or more end devices, such as end device 606. The end device 606 may be a router-eligible end device.

As shown in FIG. 6A, an end device 606 may communicate messages to attach to a router device 604 in the network to create a parent-child relationship. For example, the end device 606 may transmit a request message 607 to the router device 604 to establish an attachment and a parent-child relationship. The end device 606 may send a parent request message, a child ID request message that includes the identifier of the end device 606 and requesting an acceptance of the end device 606 as a child device, or another type of request message 607. The router device 604 may transmit a response message 608 to establish the parent-child relationship between the router device 604 and the end device 606.

The end device 606 may periodically receive router network optimization advertisement messages from each of the router devices 604 and re-evaluate its parent device in the network. For example, the end device 606 may receive a router network optimization advertisement message 610 from the router device 602. The router network optimization advertisement message 610 may include network optimization characteristics and/or a router advertised cost for performing communications with or through the router device 602. The end device 606 may process the router network optimization advertisement message 610 at 612. The end device 606 may process the router network optimization advertisement message 610 by using the network optimization characteristics and/or the router advertised cost to determine whether the end device 606 should initiate a change in the parent device. The end device 606 may store a communication quality metric associated with the router network optimization advertisement message that indicates a quality of communications from the router device 602. The router network optimization advertisement messages and end device network optimization advertisement messages may be transmitted as broadcast messages or unicast messages. For example, router network optimization advertisement messages and end device network optimization advertisement messages may each be transmitted as single-hop broadcast messages, such that control devices within a single hop may receive the network optimization advertisement messages with or without a formal parent-child or router-to-router communication link.

The end device 606 may receive a router network optimization advertisement message 614 from the router device 604 to which it is currently attached. The router network optimization advertisement message 614 may include network optimization characteristics and/or a router advertised cost for performing communications with or through the router device 604. The end device 606 may process the router network optimization advertisement message 614 at 616. The end device 606 may process the router network optimization advertisement message 614 by using the network optimization characteristics and/or the router advertised cost to determine whether the end device 606 should initiate a change in the parent device. The end device 606 may store a communication quality metric associated with the router network optimization advertisement message 614 that indicates a quality of communications from the router device 604.

The end device 606 may compare the network optimization characteristics and/or the router advertised cost received in the router network optimization advertisement messages 610, 614 to determine whether to initiate a change in the parent device to which it is attached in the network (e.g., at 612 and 616). For example, the end device 606 may compare the router advertised costs received in the router network optimization advertisement messages 610, 614 and determine that the difference between the router advertised cost of the router device 604 is greater than a threshold amount from the router advertised cost of the router device 602. Based on the comparison, the end device 606 may determine to initiate a change in its parent device. During the processing performed at 616, the end device may set a random backoff timer and await an adjustment notice from other control devices attempting to initiate an adjustment to the network operation and/or network configuration. Assuming another device or a threshold number of devices have not initiated a previous adjustment to the network operation and/or network configuration, the end device 606 may transmit a message 622 initiating an update to the parent device to which the end device 606 is attached. For example, the end device 606 may send a request message to change its parent-child relationship. In another example, the end device 606 may send a child ID request message to the router device 602 that includes the identifier of the end device 606 and requesting an acceptance of the end device 606 as a child device. The end device 606 may receive an acknowledgement that router device 602 has accepted the end device 606 as a child and that attachment has been established.

As shown in FIG. 6B, the network may include one or more router devices, such as router device 602. The router device 602 may include a leader device. The network may also include one or more end devices, such as router-eligible end device 605 and end device 606.

As shown in FIG. 6B, the router-eligible end device 605 may receive network optimization advertisement messages from router devices and/or end devices (e.g., router network optimization advertisement messages and/or end device network optimization advertisement messages) and process the network optimization advertisement messages to evaluate whether to upgrade from operating as an end device to a router device on the network. For example, the router-eligible end device 605 may receive a router network optimization advertisement message 630 from the router device 602. The router network optimization advertisement message 630 may include network optimization characteristics and/or a router advertised cost for performing communications with or through the router device 602. The router-eligible end device 605 may process the router network optimization advertisement message 630 at 632a. The router-eligible end device 605 may process the router network optimization advertisement message 610 by using the network optimization characteristics and/or the router advertised cost to determine a router device advertised cost for communicating in the router device network optimization advertisement message 634 transmitted from the router device 605. The router-eligible end device 605 may determine its router device advertised cost based on one or more router device advertised cost criteria, as described herein. The router-eligible end device 605 may store a communication quality metric associated with the router network optimization advertisement message that indicates a quality of communications from the router device 602.

The end device 606 may receive the router network optimization advertisement message 630 from the router device 602. The end device 606 may process the router network optimization advertisement message 630 at 632b. The end device 606 may process the router network optimization advertisement message 630 by using the network optimization characteristics and/or the router advertised cost to determine an end device advertised cost for communicating in the end device network optimization advertisement message 638 transmitted from the end device 606. The end device 606 may determine its end device advertised cost based on one or more end device advertised cost criteria, as described herein. The end device 606 may store a communication quality metric associated with the router network optimization advertisement message that indicates a quality of communications from the router device 602. The router network optimization advertisement messages and end device network optimization advertisement messages may be transmitted as broadcast messages or unicast messages. For example, router network optimization advertisement messages and end device network optimization advertisement messages may each be transmitted as single-hop broadcast messages, such that control devices within a single hop may receive the network optimization advertisement messages with or without a formal parent-child or router-to-router communication link.

The router-eligible end device 605 may transmit the router network optimization advertisement message 634, which may be received by the end device 606. The router network optimization advertisement message 634 may include network optimization characteristics and/or a router advertised cost for performing communications with or through the router-eligible end device 605, if it were to become a router device. The end device 606 may process the router network optimization advertisement message 634 at 636. The end device 606 may process the router network optimization advertisement message 634 by using the network optimization characteristics and/or the router advertised cost to update the end device advertised cost for communicating in the end device network optimization advertisement message 638 transmitted from the end device 606. The end device 606 may store a list of router devices and/or corresponding router device costs/network optimization characteristics that indicates the relative quality of potential parent device options. The potential parent device options and/or corresponding router device costs/network optimization characteristics may be transmitted in the end device network optimization advertisement message 638. When sending the end device advertised cost, include the top candidates from the list. The end device 606 may store a communication quality metric associated with the router network optimization advertisement message that indicates a quality of communications from the router-eligible end device 605.

The router-eligible end device 605 may receive the end device network optimization advertisement message 638 from the end device 606 and process the end device network optimization advertisement message 638 at 640. The end device network optimization advertisement message 638 may include network optimization characteristics and/or an end device advertised cost. The router device 606 may compare the network optimization characteristics and/or the end advertised cost received in the end device network optimization advertisement message 638 to the network optimization characteristics and/or the router advertised cost received in the router network optimization advertisement message 630 to determine whether to initiate an upgrade to operate as a router device in the network. For example, the router-eligible end device 605 may determine, based on router device advertised cost criteria, its router device advertised cost and compare its router advertised cost to the router advertised cost in the router network optimization advertisement message 630. The router-eligible end device 605 may know the router advertised cost of the router devices to which other end devices, such as the end device 606, are current attached and compare its own router device advertised cost to the router advertised cost of the end devices (e.g., within a single hop). The router advertised cost of the router-eligible end device 605 may be based on or set equal to the end device cost received in the end device network optimization advertisement message 638. The router-eligible end device 605 may determine that the difference between the router advertised cost of the router device 602 is greater than a threshold amount from the router advertised cost of the router-eligible end device 605. Based on the comparison and/or quality of communications (e.g., indicated by a communication quality metrics) with one or more end devices (e.g., within a single hop), such as the end device 606, the router-eligible end device 605 may determine to initiate an upgrade to operate as a router device on the network. During the processing performed at 640, the router-eligible end device 605 may set a random backoff timer and await an adjustment notice from other control devices attempting to initiate an adjustment to the network operation and/or network configuration. Assuming another device or a threshold number of devices have not initiated a previous adjustment to the network operation and/or network configuration, the router-eligible end device 605 may transmit a router request message 642 to the leader device, which may be the router device 602, to change its status to operate as a router device. The router request message 642 may be an address solicit message soliciting a router identifier from the leader device, for example. The router-eligible end device 605 may receive a router approval message 644 and begin operating as a router device on the network.

Though the example sequence flow 600b illustrates a single router device 602 and a single end device 606, the router-eligible end device 605 may receive router network optimization advertisement messages from multiple router devices and/or end device network optimization advertisement message from multiple end devices for being evaluated for initiating an upgrade to the role of router device. Additionally, though the example sequence flow 600b illustrates the router-eligible end device 605 evaluating network optimization characteristics and/or advertised costs from a router device 602 and an end device 606 for determining whether to upgrade to the role of router device, the router-eligible end device 605 may consider either the network optimization characteristics and/or advertised costs from router devices or end devices.

Though the example sequence flow 600b illustrates an upgrade of the router-eligible end device 605 to a router device, the router device 602 in the network may also, or alternatively, perform a downgrade to a router-eligible end device. For example, each router device, such as the router device 602 may maintain a list of end devices currently connected in a parent-child relationship. The router device 602 may compare the sum of the end device advertised costs for the parent-child router services provided to the router advertised cost. If the sum of the end device advertised costs is less than the router advertised cost by at least some threshold value, the router device 602 may begin the randomized timer to count down to a downgrade event.

Various advertised cost criteria may be considered when determining an advertised cost of a control device operating on the network. The advertised cost criteria may include any network optimization characteristics. Different advertised cost criteria may be considered for a router device advertised cost (e.g., router device advertised cost criteria) than an end device advertised cost (e.g., end device advertised cost criteria). Multiple values may be considered and/or weighted when calculating each advertised cost of a control device operating on the network. For example, the advertised cost may be calculated by a summation of multiple values generated from one or more network optimization characteristics and/or advertised cost criteria. However, other algorithms may be implemented for determining the advertised cost of a control device.

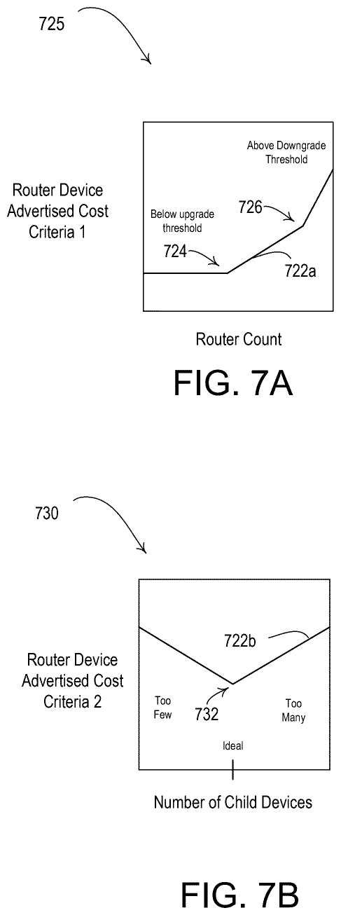

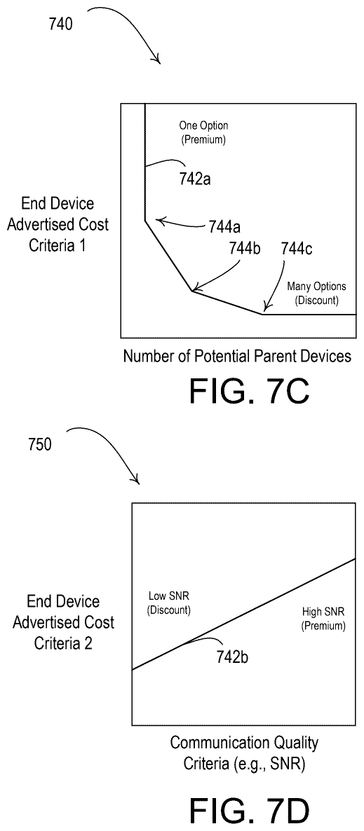

FIG. 7A includes a graph 725 of an example router device advertised cost value 722a based on the number of router devices on the network. The number of router devices on the network may be included as one or more router device advertised cost criteria considered for determining the router device advertised cost. The shape of the curve in the graph 725 indicates a relative change in the router advertised cost value 722a to encourage a greater or lesser number router-eligible end devices to upgrade/downgrade in the network. As shown in FIG. 7A, the router device advertised cost value 722a may increase at different rates and/or periods depending on the number of router devices on the network. The router device advertised cost value 722a may be determined based on an algorithm that may be static or dynamically updated. The router device advertised cost value 722a may remain static for a predefined number of router devices in the network to prevent a change when the network has less than the predefined number of router devices. In one example, router device advertised cost value 722a may remain static for a given number of router devices below an upgrade threshold, which may indicate a low-end or minimum number of router devices 724 desired in the network (e.g., 16 router devices). The router device advertised cost value 722a may increase at a rate after the low-end or minimum number of router devices 724 has been reached and until reaching a downgrade threshold, which may indicate a maximum or high-end number of router devices 726 desired in the network (e.g., 32 router devices). The rate of change of the router device advertised cost value 722a may be further increased after the downgrade threshold to reduce the frequency at which router devices may be added after the downgrade threshold. The router device advertised cost value 722a may be used to determine the router device advertised cost. A higher number of router devices may cause the router device advertised cost to be increased, while a lower number of router devices may cause the router device advertised cost to be decreased. As shown in the graph 725, adding or removing child devices to a router device may change the router device advertised cost value 722a for each of the connected child devices.

As described herein, the router advertised cost criteria may include a router-based cost criteria that may cause the router device advertised cost to be biased to a lower value (e.g., a percentage, reduction by a predefined amount, or other lower value) to bias one or more router-eligible end devices toward becoming a router device. The router-based cost criteria may bias the router device advertised cost to be a lower value to solicit a greater number of end devices with lower end device cost criteria and/or influence a router-eligible end device to upgrade to a router device.

FIG. 7B includes a graph 730 of an example the router device advertised cost value 722b that may be considered for determining the router device advertised cost based on the number of child devices attached to the router device. The number of child devices attached to a given router device may be included as one or more router device advertised cost criteria considered for determining the router device advertised cost. The shape of the curve in the graph 730 indicates a relative change in the router advertised cost value 722b to encourage a greater or lesser number end devices to attach to the router device. For example, as the number of child devices increases greater than a preferred number or range of child devices 732 attached to the router device, the router device advertised cost value 722b may be increased to deter end devices from attaching as child devices and/or reduce the number of child devices attached to the router device. As the number of child devices decreases lower than the preferred number or range of child devices 732 attached to the router device, the router device advertised cost value 722b may also be increased to deter end devices from attaching as child devices and/or encourage the router device to consider downgrading to an end device.

As shown in FIG. 7B, the router device advertised cost value 722b may increase/decrease at different rates and/or periods depending on the number of child devices currently attached to the router device. The router device advertised cost value 722b may be determined based on an algorithm that may be static or dynamically updated. The router device advertised cost value 722b may start at a predefined number and decrease as the number of attached child devices approach the preferred number or range of child devices 732. The router device advertised cost value 722b may remain static for a given number of router devices within the preferred range of child devices 732. The router device advertised cost value 722b may increase at a rate after the preferred number or range of child devices 732. The router device advertised cost value 722b may be used to determine the router device advertised cost. For example, both the router device advertised cost value 722a, shown in FIG. 7A, and the router device advertised cost value 722b, shown in FIG. 7B, may be used to determine the router device advertised cost.

Equation 1 provides an example for calculating the router device advertised cost based on multiple router device advertised cost criteria and/or values.

Router Device Advertised Cost=Router Device Advertised Cost Value 1+Router Device Advertised Cost Value 2+ Equation 1

FIG. 7C includes a graph 740 of an example end device advertised cost value 742a that may be considered for determining the end device advertised cost based on the number of router device parent options on the network. The number of router device parent options on the network may be included as one or more end device advertised cost criteria considered for determining the end device advertised cost. The shape of the curve in the graph 740 indicates a relative change in the end device advertised cost value 742a to encourage a greater or lesser number router devices (e.g., router-eligible end devices to upgrade or router devices to downgrade). For example, the number of potential parent device options may be based on a number of router devices and/or router-eligible end devices from which a communication quality metric is received for communications above a threshold. As the number of potential parent device options increases, the end device advertised cost value 742a may be increased to promote more router devices in the network. As the number of potential parent device options decreases, the end device advertised cost value 742a may be decreased to encourage a reduced number of router devices in the network. In one example, the end device advertised cost may be based on a router device advertised cost received from one or more router devices, so the end device advertised cost value 742a may be positive or negative, to increase or decrease the value of the router device advertised cost received from router devices.

As shown in FIG. 7C, the end device advertised cost value 742a may be at its highest when there is a single parent device option in the network. The end device advertised cost value 742a may be determined based on an algorithm that may be static or dynamically updated. The end device advertised cost value 742a may remain static for a predefined number of potential parent device options in the network to prevent a change when the number of potential parent device options changes between values. As the potential parent device options increase, end device advertised cost value 742a may decrease, causing the end device advertised cost to decrease. The rate of change of the end device advertised cost value 742a may decrease more significantly as the percentage of the number of potential parent device options initially increases. The rate of change of end device advertised cost value 742a may decrease at different defined thresholds 744a, 744b, 744c, as the number of potential parent device options increases. The rate of change of the end device advertised cost value 742a may stop changing after the number of potential parent options reaches a defined threshold 744c. The end device advertised cost value 742a value may be used to determine the end device advertised cost. For example, as the number of potential parent options increases, the end device advertised cost may decrease based on the end device advertised cost value 742a.

FIG. 7D includes a graph 750 of an end device advertised cost value 742b for determining the end device advertised cost based on the communication quality (e.g., SNR) of the communications (e.g., communications to and/or from) the current router device parent on the network. The communication quality (e.g., SNR) of the communications (e.g., communications to and/or from) the current router device parent on the network may be included as one or more end device advertised cost criteria considered for determining the end device advertised cost. The shape of the curve in the graph 750 indicates a relative change in the end device advertised cost value 742b to encourage the end device to stay attached to the current router device parent when the communication quality (e.g., SNR) is higher, and encourage the end device to consider other potential parent devices when the communication quality (e.g., SNR) is lower. In one example, the end device advertised cost may be based on a router device advertised cost received from one or more router devices, so the end device advertised cost value 742b may be positive or negative, to increase or decrease the value of the router device advertised cost received from router devices.

As shown in FIG. 7D, the end device advertised cost value 742b may increase as the communication quality to/from the current parent device increases. The end device advertised cost value 742b may be determined based on an algorithm that may be static or dynamically updated. The end device advertised cost value 742b may have a linear relationship with the communication quality to/from the current parent device on the network. The end device advertised cost value 742b may be used to determine the end device advertised cost. For example, as the communication quality between the end device and the current parent device increases, the end device advertised cost may increase.

Equation 2 provides an example for calculating the end device advertised cost based on multiple end device advertised cost criteria and/or values.

End Device Advertised Cost=Router Device Advertised Cost+End Device Advertised Cost Value 1+End Device Advertised Cost 2 Equation 2

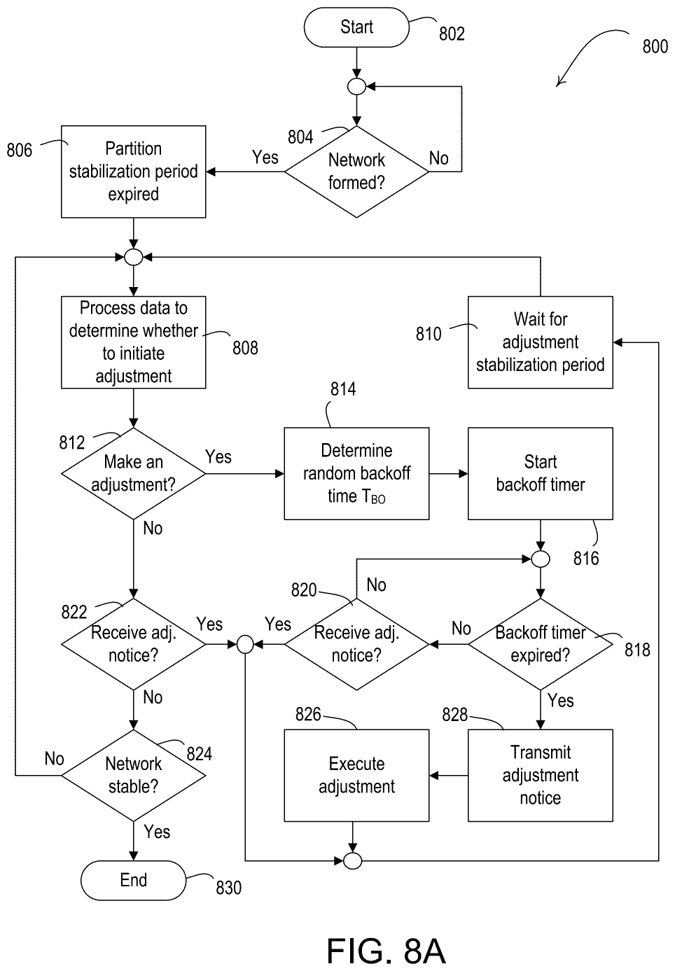

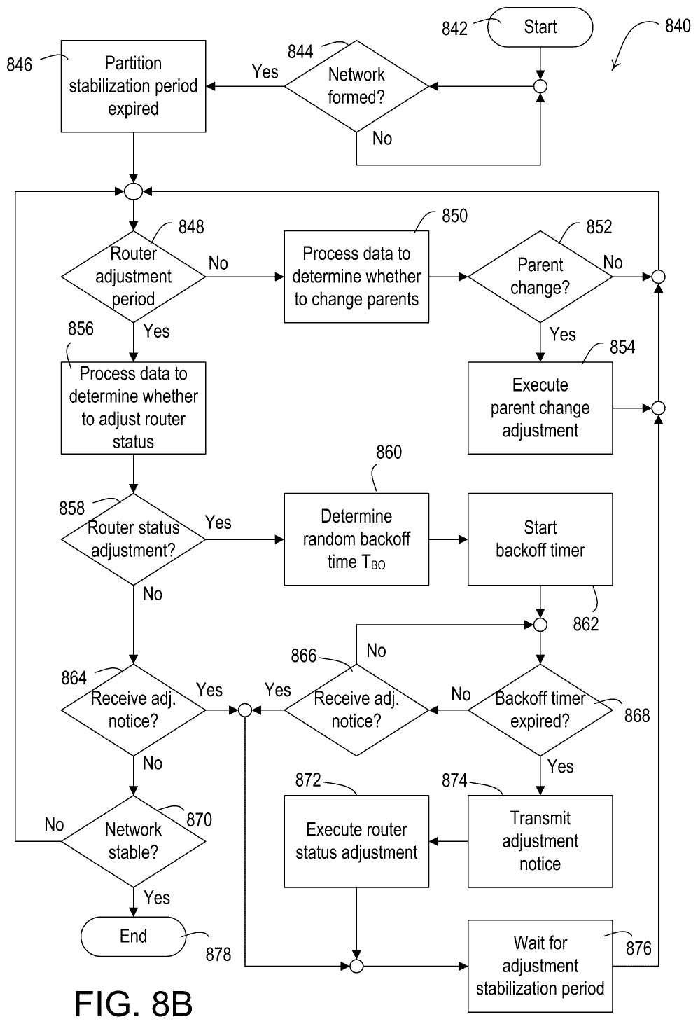

FIG. 8A is a flowchart of an example procedure 800 for control devices to collect network data and initiate adjustment to network operation and/or network configuration to update network operation. The procedure 800 may be executed by one or more control devices in a load control system that is joined or connected to the network (e.g., each of the leader device, router devices, and/or end devices) in order to update and/or improve network operation.

A control device may start the procedure 800 at 802 and the control device may determine whether the network has been formed and/or whether the network has been formed for a network stabilization period. If the network has not been formed, or has not been formed for a network stabilization period, the control device may continue to monitor for the formation of the network for the network stabilization period at 804. If the network is determined at 806 to be formed and/or formed for the network stabilization period, the control device may process network optimization characteristics at 808 to determine whether to make an adjustment to the network operation and/or network configuration. For example, the control device may collect network optimization characteristics locally and from other control devices during an adjustment evaluation period. The control device may each receive network optimization advertisement messages from other control devices and determine whether to initiate an adjustment to the network operation and/or network configuration (e.g., by changing a role of a control device or a relationship between control devices on the network), as described herein.

The control device may determine, based on the collected network optimization characteristics, whether to make an adjustment to the network at 812.

If the control device determines to make an adjustment to the network at 812, the control device may determine a random backoff timer value T_{BO} at 814. The control device may determine the random backoff timer value T_{BO} as a random value within a predefined timeframe before initiating a network adjustment. The predefined timeframe within which the random backoff timer value T_{BO} is generated may be a different predefined timeframe based on the network adjustment to be performed and/or weight values given to the network optimization characteristics being evaluated. A random backoff timer may be set to the random backoff timer value T_{BO} and the random backoff timer may be started at 816.

At 818, the control device may determine whether the random backoff timer has expired. If the random backoff timer is determined to have expired at 818, the control device may transmit an adjustment notice at 828. The adjustment notice may be included in a broadcast message or a multicast message to be received by other control devices on the network. The adjustment notice may be sent as a unicast message to one or more other control devices (e.g., parent device or leader device on the network) that may transmit a broadcast or a multicast message that includes the adjustment notice. The adjustment notice may be received by one or more control devices to notify the control devices that another control device has initiated an adjustment to the network. At 826, the control device may execute the network adjustment. For example, the control device may initiate a change (e.g., upgrade or downgrade) in a role and/or a relationship with other control devices in the network. The adjustment notice may be transmitted in a message configured to execute the adjustment on the network. For example, the control device may transmit a single message (e.g., a router request message/address solicit message, a router release message, a parent request message, or another message configured to initiate the network adjustment) that is configured to trigger a notification (e.g., directly or via a broadcast/multicast message from another device, such as a parent device or leader device on the network) of the adjustment to other control devices on the network.

At 818, if the control device determines that the random backoff timer has not expired, the control device determines whether it has received an adjustment notice from another control device at 820. If the adjustment notice fails to be received, the control device may continue to await for the expiration of the random backoff timer at 818. If at 820, the control device determines that the adjustment notice has been received from another device, the control device may wait for an adjustment stabilization period at 810. The control device may also, or alternatively, determine to wait for the adjustment stabilization period at 810 after execution of an adjustment on the network at 826.

If, at 812, the control device determines not to make an adjustment to the network (e.g., maintain current state and/or relationships), the control device may determine whether an adjustment notice was received indicating an adjustment to the network initiated by another control device on the network. If an adjustment notice was received from another control device at 822, the control device may wait for the adjustment stabilization period at 810. If the control device failed to receive the adjustment notice from another control device at 822, the control device may determine whether the network is stable at 824 to process collected network optimization characteristics for determining whether to initiate an adjustment to the network at 808. If the network is not determined to be stable, at 824, the procedure 800 may end at 830.

FIG. 8B is a flowchart of an example procedure 840 for control devices to collect network data and initiate adjustment to network operation and/or network configuration to update network operation. The procedure 840 may be executed by one or more control devices in a load control system that is joined or connected to the network (e.g., each of the leader device, router devices, and/or end devices) in order to update and/or improve network operation.

A control device may start the procedure 840 at 842 and the control device may determine whether the network has been formed and/or whether the network has been formed for a network stabilization period. If the network has not been formed, or has not been formed for a network stabilization period, the control device may continue to monitor for the formation of the network for the network stabilization period at 844. If the network is determined a 846 to be formed for the network stabilization period, the control device may determine whether a router adjustment period has elapsed at 848.

If the control device is operating as an end device and the router adjustment period has not been entered at 848, the control device may process network optimization characteristics, at 850, to determine whether to change parent devices. For example, the control device may determine that the network is operating in a router idle period or another period of time that is outside of the router adjustment period and may process network optimization characteristics router network optimization advertisement messages from router devices and determine, based on certain role adjustment criteria, whether to change parent devices. In one example, the control device may determine to change parent devices when a network data characteristic (e.g., the router device advertised cost or another network data characteristic) will be improved by a defined amount. If the control device determines, at 852, not to initiate a change to a parent device in the network, the control device may continue to process network optimization characteristics during the router adjustment period. If the control device determines, at 854, to initiate a change to a parent device in the network, the control device may initiate the change in the parent device to which the control device is attached on the network, as described herein. The control device may continue to process network optimization characteristics during the router adjustment evaluation period to determine whether to perform additional changes in its attachment to parent devices.

If the control device is operating as a router device or router-eligible end device and determines, at 848, that the network is operating within the router adjustment period, the control device may process network optimization characteristics, at 856, to determine whether to initiate an adjustment to the role of the control device on the network. For example, the control device may process the network optimization characteristics to determine whether to upgrade the role to a router device or downgrade the role to an end device.

If the control device determines, at 858, to perform an adjustment to its role in the network, the control device may determine a random backoff timer value T_{BO} at 860. The control device may determine the random backoff timer value T_{BO} as a random value within a predefined timeframe before initiating a network adjustment. The predefined timeframe within which the random backoff timer value T_{BO} is generated may be a different predefined timeframe based on the network adjustment to be performed and/or weight values given to the network optimization characteristics being evaluated. A random backoff timer may be set to the random backoff timer value T_{BO} and the random backoff timer may be started at 862.

At 868, the control device may determine whether the random backoff timer has expired. If the random backoff timer is determined to have expired at 868, the control device may transmit an adjustment notice at 874. The adjustment notice may be included in a broadcast message or a multicast message to be received by other control devices on the network. The adjustment notice may be sent as a unicast message to one or more other control devices (e.g., parent device or leader device on the network) that may transmit a broadcast or a multicast message that includes the adjustment notice. The adjustment notice may be received by one or more control devices to notify the control devices that another control device has initiated an adjustment to the network. At 872, the control device may execute the adjustment to the role of the control device. For example, the control device may initiate a change (e.g., upgrade or downgrade) in a role. The adjustment notice may be transmitted in a message configured to execute the adjustment on the network. For example, the control device may transmit a single message (e.g., a router request message/address solicit message, a router release message, or another message configured to initiate the network adjustment) that is configured to trigger a notification (e.g., directly or via a broadcast/multicast message from another device, such as a parent device or leader device on the network) of the adjustment to other control devices on the network.

At 868, if the control device determines that the random backoff timer has not expired, the control device determines whether it has received an adjustment notice from another control device at 866. If the adjustment notice fails to be received, the control device may continue to await for the expiration of the random backoff timer at 868. If at 866, the control device determines that the adjustment notice has been received from another device, the control device may wait for an adjustment stabilization period at 876. The control device may also, or alternatively, determine to wait for the adjustment stabilization period at 876 after execution of an adjustment of its role on the network at 872.

If, at 858, the control device determines not to make an adjustment to its role on the network (e.g., maintain current role), the control device may determine whether an adjustment notice was received at 864 indicating an adjustment to the network initiated by another control device on the network. If an adjustment notice was received from another control device at 864, the control device may wait for the adjustment stabilization period at 876. If the control device failed to receive the adjustment notice from another control device at 864, the control device may determine whether the network is stable at 870 to process collected network optimization characteristics for determining whether to initiate an adjustment to the network. If the network is not determined to be stable, at 870, the procedure 840 may end a 878.

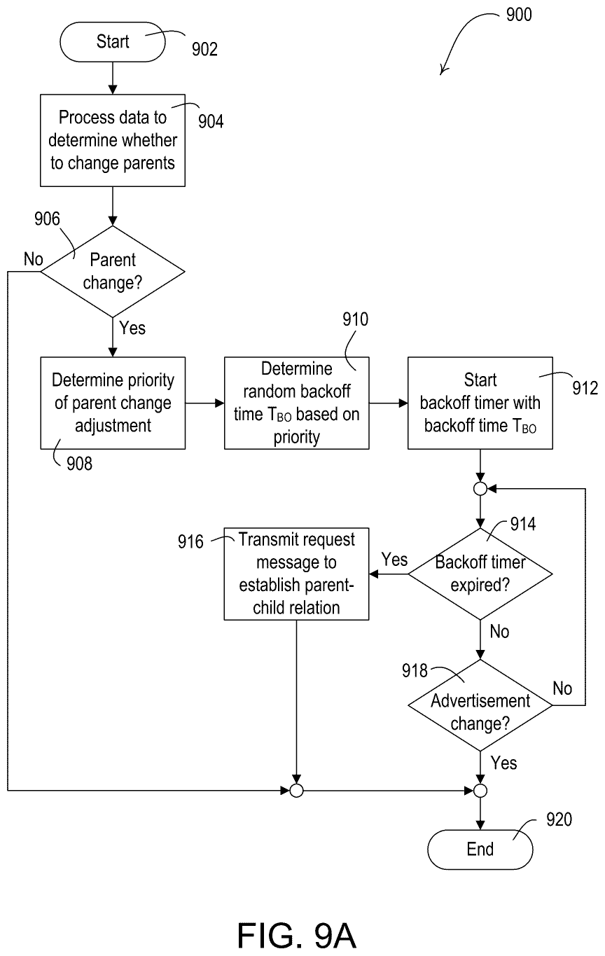

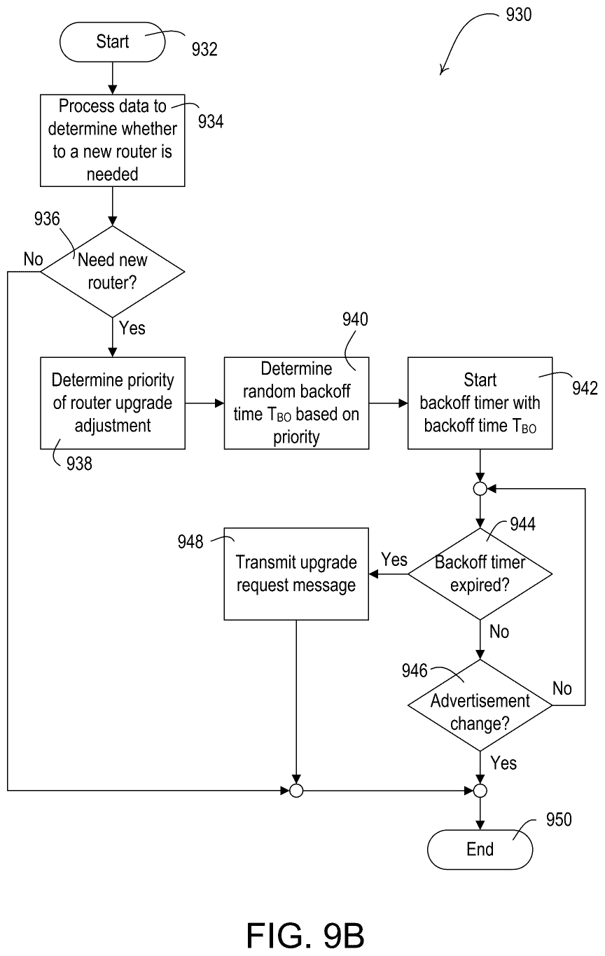

FIGS. 9A and 9B include flowcharts of other example procedures 900 and 930, respectively, for control devices to collect network data and initiate adjustments to network operation and/or network configuration to update network operation. The example procedures 900, 930 may be performed as alternatives to the procedures 800, 840 shown in FIGS. 8A and 8B. The example procedures 900 and 930 may each be performed at different times on the same control device (e.g., a router-eligible end device) or on different control devices (e.g., a router device and an end device) at different times or in parallel.

As shown in FIG. 9A, the procedure 900 may be performed at a control device operating as an end device to determine whether to initiate a change in a parent device based on network optimization characteristics. For example, the procedure 900 may begin at 902 and the control device may process network optimization characteristics, at 904, to determine whether to change parent devices. The network optimization characteristics may be transmitted in router network optimization advertisement messages. The network optimization characteristics may include the router device advertised cost for a respective router device transmitting the router network optimization advertisement message. The control device may determine from the router device advertised cost or other network optimization characteristics whether to initiate an adjustment to change parent devices to which the control device is attached as a child device at 906. In one example, the router device advertised cost may be determined from a child count of each router device and the total number of router devices in the network. The control device may determine, for example, that one or more role adjustment criteria have been met for initiating an adjustment in its parent device. For example, the control device may receive router device advertised costs or other network optimization characteristics from the router devices in the network and determine that the router device advertised cost or other network optimization characteristics being advertised from another router device than its current parent device will improve its network communications (e.g., the router advertised cost or other network optimization characteristics are improved by at least a threshold).

If the control device determines to initiate a change in its parent at 906, the control device may initiate a random backoff timer value T_{BO} to avoid initiating a change in the network at the same time as other control devices. The random backoff timer value T_{BO} may be set based on a priority of the parent change adjustment that is determined at 908. The parent change adjustment priority may be determined at 908 to determine whether to set the random backoff timer value T_{BO} within a longer or shorter timeframe. Higher-priority changes may be randomized within a shorter timeframe than lower-priority changes to increase the chance that the higher-priority changes are implemented. Changes that are determined to cause a greater benefit to the quality of the network may be given greater priority than changes that are determined to have less of a benefit to the quality of the network. Changes to roles in the network may be given higher priority than changes to parent-child relationships. Larger changes in network improvements may be given a higher priority than smaller changes in network improvements. For example, larger changes in the router device advertised costs between router devices may be given higher priority than smaller changes in the router device advertised costs between router devices. Child devices with weaker links to a current parent devices may be prioritized for parent change adjustments over child devices with stronger links to the current parent. In one example, the priority may be based on a communication quality metric (e.g., SNR or another communication quality metric) indicating a quality of communications between child devices and their current parent devices. The priority of the parent change adjustment may be determined based on a relative level of communication quality with the current parent device and/or the number of child devices of the current parent device. For example, parent change adjustments may be given a priority level based on a corresponding range (e.g., high, medium, or low) within which the communications between child device and its current parent device is operating. The priority of the parent change adjustment may be based on one or more network optimization characteristics (e.g., LQO value and/or LQI value) associated with communications between the child device and its current parent. The priority of the parent change adjustment may be based on the number of current child devices of the current parent device, such that higher priority is given to child devices requesting to move from parent devices with a greater number of child devices to offload the current parent device.

At 910, the random backoff timer value T_{BO} may be determined based on the priority of the parent change adjustment determined at 908. The random backoff timer value T_{BO} may be determined within a maximum adjustment window based on the priority of the parent change adjustment determined at 908. As described herein, higher priority changes may be given larger maximum adjustment windows within which the random backoff timer value T_{BO} may be determined, while lower priority changes may be given smaller maximum adjustment windows within which the random backoff timer value T_{BO} may be determined. For example, different maximum adjustment windows may correspond to a different priority level (e.g., high, medium, or low). At 912, the backoff timer may begin with the random backoff timer value T_{BO} determined at 910.

At 914, the control device may determine whether the random backoff timer has expired. If the random backoff timer is determined to have expired at 914, the control device may transmit an adjustment notice and/or a request message at 916 to change the parent to which the control device is attached as a child. The adjustment notice may be received by one or more control devices to notify the control devices that another control device has initiated an adjustment to the network. The control device may transmit the request message at 916 to request attachment as a child device to another parent device on the network. The request message may operate as an adjustment notice, or the adjustment notice may be transmitted separately.

At 914, if the control device determines that the random backoff timer has not expired, the control device determines whether it has received an adjustment notice from another control device at 918. If the adjustment notice fails to be received, the control device may continue to await for the expiration of the random backoff timer at 914. After the control device initiates a change to its parent by transmitting the request message, or the control device receives an indication that another control device is initiating a change on the network, the procedure 900 may end at 920.

FIG. 9B illustrates a procedure 930 for a control to initiate an adjustment to the network by initiating an upgrade from an end device to a router device. The control device that performs the procedure 930 may be a router-eligible end device that is operating as an end device on the network. In another example, the procedure 930 may be performed by another device on the network (e.g., a leader device, a router device, or another device) capable of identifying a router-eligible end device in a location where an upgraded router devices is needed and that can initiate the upgrade at the router-eligible end device. As shown in FIG. 9B, the procedure 930 may begin at 932 and the control device may process network optimization characteristics, at 934, to determine whether a new router device is needed on the network. The network optimization characteristics may be transmitted in router network optimization advertisement messages. The network optimization characteristics may include the router device advertised cost for a respective router device transmitting the router network optimization advertisement message. In one example, the router device advertised cost may be determined from a child count of each router device and the total number of router devices in the network.

The control device may determine, from the router device advertised cost or other network optimization characteristics being received from the current router devices on the network, whether another router device is needed on the network at 936. The control device may determine, for example, that one or more role adjustment criteria have been met for initiating an adjustment to upgrade the network to include a router device. For example, the control device may receive router device advertised costs or other network optimization characteristics from the router devices in the network and determine that another router device being added to the network will improve network communications (e.g., by at least a threshold). In one example, the control device may determine a router device advertised cost for itself or another router-eligible end device on the network if the router-eligible end device were to be upgraded to a router. The router device advertised cost may be determined for the control device or another router-eligible end device on the network based on a child count and/or the total number of router devices on the network in the event of a router upgrade.

If the control device determines that a new router is needed on the network at 936, the control device may need to transmit an upgrade request message to the leader device or communicate with another router-eligible end device on the network to cause the router-eligible end device to transmit an upgrade request message to the leader device to initiate the upgrade on the network. When another router-eligible end device is identified for being upgraded, the router-eligible end device may be determined (e.g., from the network optimization characteristic) to have a lower noise floor or background noise or a higher communication quality metric (e.g., a higher SNR, a higher RSSI value) for communications with other devices (e.g., with weaker communication quality metrics) in an area of the network.

If the control device determines to initiate a change in the network by upgrading a new router device on the network at 936, the control device may initiate a random backoff timer value T_{BO} to avoid initiating a change in the network at the same time as other control devices. The random backoff timer value T_{BO} may be set based on a priority of the router upgrade that is determined at 936. The router upgrade priority may be determined at 938 to determine whether to set the random backoff timer value T_{BO} within a longer or shorter timeframe. Higher-priority changes may be randomized within a shorter timeframe than lower-priority changes to increase the chance that the higher-priority changes are implemented. Changes that are determined to cause a greater benefit to the quality of the network may be given greater priority than changes that are determined to have less of a benefit to the quality of the network. Changes to upgrade the role of a router in the network may be given higher priority than changes to parent-child relationships and/or changes to downgrade the role of a router device. Larger changes in network improvements may be given a higher priority than smaller changes in network improvements. For example, larger changes in the router device advertised costs between current router devices and the new router device being added may be given higher priority than smaller changes in the router device advertised costs between current router devices and the new router device being added. Larger improvement in link quality for child devices to the new router device being added to the network may be given higher priority than smaller improvements in link quality for child devices to the new router device being added. In one example, the priority may be based on a communication quality metric (e.g., SNR or another communication quality metric) indicating a quality of communications between child devices and their current parent devices and a communication quality metric (e.g., SNR or another communication quality metric) indicating a quality of communications between the same end devices and the router-eligible end device that may be upgraded.

At 940, the random backoff timer value T_{BO} may be determined based on the priority of the router upgrade adjustment determined at 938. The random backoff timer value T_{BO} may be determined within a maximum adjustment window based on the priority of the router upgrade adjustment determined at 938. As described herein, higher priority changes may be given larger maximum adjustment windows within which the random backoff timer value T_{BO} may be determined, while lower priority changes may be given smaller maximum adjustment windows within which the random backoff timer value T_{BO} may be determined. At 942, the backoff timer may begin with the random backoff timer value T_{BO} determined at 940.

At 944, the control device may determine whether the random backoff timer has expired. If the random backoff timer is determined to have expired at 944, the control device may transmit an adjustment notice and/or a router upgrade request message at 948. The adjustment notice may be received by one or more control devices to notify the control devices that another control device has initiated an adjustment to the network. The control device may transmit the router upgrade request message at 948 to request an upgrade to router device from the leader device, as described herein. In another example, the control device may transmit a message to a router-eligible end device in the network to cause the router-eligible end device to transmit the router upgrade request message to the leader device. The router upgrade request message may operate as an adjustment notice, or the adjustment notice may be transmitted separately by the control device or the other router-eligible end device requesting the upgrade.

At 944, if the control device determines that the random backoff timer has not expired, the control device determines whether it has received an adjustment notice from another control device at 946. If the adjustment notice fails to be received, the control device may continue to await for the expiration of the random backoff timer at 944. After the control device initiates an upgrade to a router device on the network, or the control device receives an indication that another control device is initiating a change on the network, the procedure 930 may end at 950.

Although features and elements are described herein in particular combinations, each feature or element can be used alone or in any combination with the other features and elements. The methods described herein may be implemented in a computer program, software, instructions, or firmware stored on one or more non-transitory computer-readable media or other machine-readable media for execution by a computer or machine, or portion thereof. For example, the computer-readable or machine-readable media may be executed by a control circuit, such as a processor. Examples of computer-readable media or machine-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs). The control circuit may access the computer program, software, instructions, or firmware stored on the computer-readable media or machine-readable media for being executed to cause the control circuit to operate as described herein, or to operate one or more devices as described herein.

What is claimed is:

1. A load control system comprising a plurality of control devices configured to communicate via a network according to a network configuration, the load control system comprising:
a first control device of the plurality of control devices configured to:
receive first network optimization advertisement messages from other control devices of the plurality of control devices;
collect first network optimization characteristics related to the plurality of control devices in the load control system based on the network optimization advertisement messages; and
determine, based on the first network optimization characteristics, to initiate a first adjustment to the network configuration; and
a second control device of the plurality of control devices configured to:
receive second network optimization advertisement messages from the other control devices of the plurality of control devices;
collect second network optimization characteristics related to the plurality of control devices in the load control system based on the second network optimization advertisement messages; and
determine, based on the second network optimization characteristics, to initiate a second adjustment to the network configuration;
determine that the plurality of control devices is permitted to initiate adjustments to the network configuration based on an expiration of a prior network formation period or a prior adjustment stabilization period after a prior adjustment to the network configuration; and
initiate the second adjustment to the network configuration;
wherein, in response to receipt of an indication that the second control device has initiated the second adjustment to the network configuration, the first control device is configured to await an adjustment stabilization period before a subsequent determination to initiate the first adjustment or a third adjustment to the network configuration.

2. The load control system of claim 1, wherein the first network optimization characteristics and the second network optimization characteristics comprise communication quality metrics measured at the other control devices from which the first network optimization advertisement messages and the second network optimization advertisement messages are received.

3. The load control system of claim 1, wherein the first network optimization characteristics and the second network optimization characteristics comprise one or more of a noise floor measured at the other control devices from which the first network optimization advertisement messages and the second network optimization advertisement messages are received, or a communication quality metric of network optimization messages measured at the other control devices.

4. (canceled)

5. The load control system of claim 1, wherein the network optimization advertisement messages comprise router device network optimization advertisement messages or end device network optimization advertisement messages.

6. The load control system of claim 1, wherein the first network device is configured to process the first network optimization characteristics using network optimization criteria to determine to initiate the first adjustment to the network configuration, and wherein the second network device is configured to process the second network optimization characteristics using the network optimization criteria to determine to initiate the second adjustment to the network configuration.

7. The load control system of claim 6, wherein the network optimization criteria comprises an advertised cost criteria, and wherein the first network device is configured to process the advertised cost criteria to determine an advertised cost for communications performed through or with each of the other control devices from which the first network optimization advertisement messages are received, and wherein the second network device is configured to process the advertised cost criteria to determine an advertised cost for communications performed through or with each of the other control devices from which the second network optimization advertisement messages are received.

8. The load control system of claim 1, wherein the other control devices from which the first control device receives the first network optimization advertisement messages and collects the first network optimization characteristics comprises control devices within a single hop on the network from the first control device, and wherein the other control devices from which the second control device receives the second network optimization advertisement messages and collects the second network optimization characteristics comprises control devices within a single hop on the network from the second control device.

9. The load control system of claim 1, wherein the first control device is configured to measure a communication quality metric of the first network optimization advertisement messages and collect the first network optimization characteristics for the other control devices from which the first network optimization advertisement messages are received with the communication quality metric above a threshold, and wherein the second control device is configured to measure a communication quality metric of the second network optimization advertisement messages and collect the second network optimization characteristics for the other control devices from which the second network optimization advertisement messages are received with the communication quality metric above a threshold.

10. The load control system of claim 1, wherein the second control device is further configured to:
after determining to initiate the second adjustment to the network configuration, set a random backoff timer within a predefined timeframe before initiating the second adjustment; and
after an expiration of the random backoff timer, transmit a message configured to indicate the second adjustment to the network configuration is being performed, wherein the message comprises an adjustment notice.

11. (canceled)

12. The load control system of claim 1, wherein the second control device is configured to initiate the second adjustment to the network configuration by being configured to transmit a message configured to perform an adjustment to a role of a third control device on the network.

13. The load control system of claim 12, wherein the role of the third control device is a router device on the network prior to the adjustment, and wherein the message is configured to downgrade the role of the third control device to an end device on the network.

14. The load control system of claim 12, wherein the role of the third control device is an end device on the network prior to the adjustment, and wherein the message is configured to upgrade the role of the third control device to a router device on the network.

15. The load control system of claim 1, wherein the second adjustment to the network configuration comprises an adjustment to a relationship of a third control device with another control device of the plurality of control devices on the network, wherein the relationship is a parent-child relationship, wherein the third control device is a child device to another control device of the plurality of control devices to which the third control device is attached as a parent device, and wherein the second adjustment is initiated to change the parent device of the third control device to another control device of the plurality of control devices on the network.

16. (canceled)

17. The load control system of claim 1, wherein the first control device is a first load control device configured to control a first electrical load, and wherein the second control device is a second load control device configured to control a second electrical load.

18. The load control system of claim 17, wherein the first load control device comprises a first lighting control device, wherein the first electrical load comprises a first lighting load, wherein the second load control device comprises a second lighting control device, wherein the second electrical load comprises a second lighting load, and wherein the first load control device is further configured to:
control the first lighting load based on control instructions sent to the first lighting control device; and
wherein the second load control device is further configured to control the second lighting load based on control instructions sent to the second lighting control device.

19. (canceled)

20. The load control system of claim 1, wherein the second control device is further configured to:
receive a message that indicates the first adjustment to the network configuration;
collect updated network optimization characteristics; and
determine, based on the updated network optimization characteristics, that the first adjustment occurred in response to the message.

21. A method for adjusting a network configuration of a network comprising a plurality of control devices in a load control system, the method comprising:
collecting network optimization characteristics related to the plurality of control devices in the load control system;
determining that the plurality of control devices is permitted to initiate adjustments to the network configuration based on an expiration of a prior network formation period or a prior adjustment stabilization period after a prior adjustment to the network configuration;
determining, based on the collected network optimization characteristics, to initiate an adjustment to the network configuration; and
prior to receipt of an indication that any control device of the plurality of control devices has initiated adjustment to the network configuration after the determination that the plurality of control devices is permitted to initiate adjustments, initiating the adjustment to the network configuration.

22. The method of claim 21, further comprising:
receiving network optimization advertisement messages from other control devices of the plurality of control devices, wherein the network optimization characteristics are collected based on the network optimization advertisement messages.

23. The method of claim 22, wherein the network optimization characteristics comprise one or more of: communication quality metrics measured at the other control devices from which the network optimization advertisement messages are received, a noise floor measured at the other control devices from which the network optimization advertisement messages are received, or a communication quality metric of network optimization messages measured at the other control devices.

24. (canceled)

25. (canceled)

26. The method of claim 21, further comprising:
after determining to initiate the adjustment to the network configuration, setting a random backoff timer within a predefined timeframe before initiating the adjustment to the network configuration; and
after an expiration of the random backoff timer, transmitting a message configured to indicate the adjustment to the network configuration is being performed, wherein the message comprises an adjustment notice.

27. (canceled)

28. The method of claim 21, further comprising:
detecting that the network has been formed; and
in response to detecting that the network has been formed, awaiting a network stabilization period prior to at least one of the collecting of the network optimization characteristics or the determining to initiate the adjustment to the network configuration.

29. The method of claim 21, wherein the adjustment to the network configuration is performed by transmitting a message configured to perform an adjustment to a role of a first control device on the network.

30. The method of claim 29, wherein the role of the first control device is a router device on the network prior to the adjustment, and wherein the message is configured to downgrade the role of the first control device to an end device on the network.

31. The method of claim 29, wherein the role of the first control device is an end device on the network prior to the adjustment, and wherein the message is configured to upgrade the role of the first control device to a router device on the network.

32. The method of claim 21, wherein the adjustment to the network configuration comprises an adjustment to a relationship of a first control device with another control device of the plurality of control devices on a network.

33. The method of claim 32, wherein the relationship is a parent-child relationship, wherein the first control device is a child device to another control device of the plurality of control devices to which the first control device is attached as a parent device, and wherein the adjustment is initiated to change the parent device of the first control device to another control device of the plurality of control devices on the network.

34. The method of claim 21, wherein the plurality of control devices comprises a first control device and a second control device, wherein the first control device is a first load control device configured to control a first electrical load, and wherein the second control device is a second load control device configured to control a second electrical load.

35. The method of claim 34, wherein at least one of the first load control device or the second load control device comprises a lighting control device, and wherein at least one of the first electrical load or the second electrical load comprises a lighting load, the method further comprising:
controlling the at least one of the first lighting load or the second lighting load based on control instructions sent to the at least one of the first lighting control device or the second lighting control device.

36. The method of claim 21, further comprising:
receiving a message that indicates the adjustment to the network configuration;
collecting updated network optimization characteristics; and
determining, based on the updated network optimization characteristics, that the adjustment occurred in response to the message.

37. A device comprising:
a control circuit configured to:
collect network optimization characteristics related to a plurality of control devices in a load control system;
determine that the plurality of control devices is permitted to initiate adjustments to a network configuration based on an expiration of a prior network formation period or a prior adjustment stabilization period after a prior adjustment to the network configuration;
determine, based on the collected network optimization characteristics, to initiate an adjustment to the network configuration; and
prior to receipt of an indication that any control device of the plurality of control devices has initiated adjustment to the network configuration after the determination that the plurality of control devices is permitted to initiate adjustments, initiate the adjustment to the network configuration.

38. At least one non-transitory computer-readable medium comprising instructions that are configured to, when executed by at least one control circuit, cause the control circuit to:
collect network optimization characteristics related to a plurality of control devices in a load control system;
determine that the plurality of control devices is permitted to initiate adjustments to a network configuration based on an expiration of a prior network formation period or a prior adjustment stabilization period after a prior adjustment to the network configuration;
determine, based on the collected network optimization characteristics, to initiate an adjustment to the network configuration; and
prior to receipt of an indication that any control device of the plurality of control devices has initiated adjustment to the network configuration after the determination that the plurality of control devices is permitted to initiate adjustments, initiate the adjustment to the network configuration.

39-110. (canceled)

111. The device of claim 37, wherein the control circuit is further configured to:
receive network optimization advertisement messages from other control devices of the plurality of control devices, wherein the network optimization characteristics are collected based on the network optimization advertisement messages, wherein the network optimization characteristics comprise one or more of: communication quality metrics measured at the other control devices from which the network optimization advertisement messages are received, a noise floor measured at the other control devices from which the network optimization advertisement messages are received, or a communication quality metric of network optimization messages measured at the other control devices.

112. The device of claim 37, wherein the control circuit is further configured to:
after determining to initiate the adjustment to the network configuration, set a random backoff timer within a predefined timeframe before initiating the adjustment to the network configuration; and
after an expiration of the random backoff timer, transmit a message configured to indicate the adjustment to the network configuration is being performed, wherein the message comprises an adjustment notice.

113. The device of claim 37, wherein the control circuit is further configured to:
detect that the network has been formed; and
in response to detecting that the network has been formed, await a network stabilization period prior to at least one of the collecting of the network optimization characteristics or the determining to initiate the adjustment to the network configuration.

114. The device of claim 37, wherein the control circuit is configured to perform the adjustment to the network configuration by transmitting a message configured to perform an adjustment to a role of a first control device on the network.

115. The device of claim 114, wherein the role of the first control device is a router device on the network prior to the adjustment, and wherein the message configured to downgrade the role of the first control device to an end device on the network.

116. The device of claim 114, wherein the role of the first control device is an end device on the network prior to the adjustment, and wherein the message is configured to upgrade the role of the first control device to a router device on the network.

117. The device of claim 37, wherein the adjustment to the network configuration comprises an adjustment to a relationship of a first control device with another control device of the plurality of control devices on a network, wherein the relationship is a parent-child relationship, wherein the first control device is a child device to another control device of the plurality of control devices to which the first control device is attached as a parent device, and wherein the adjustment is initiated to change the parent device of the first control device to another control device of the plurality of control devices on the network.

118. The device of claim 37, wherein the plurality of control devices comprises a first load control device configured to control a first electrical load and a second load control device configured to control a second electrical load, wherein at least one of the first load control device or the second load control device comprises a lighting control device, wherein at least one of the first electrical load or the second electrical load comprises a lighting load, and wherein the control circuit is further configured to:
control the at least one of the first lighting load or the second lighting load based on control instructions sent to the at least one of the first lighting control device or the second lighting control device.

119. The non-transitory computer-readable medium of claim 38, wherein the instructions, when executed by the control circuit, further cause the control circuit to:
receive network optimization advertisement messages from other control devices of the plurality of control devices, wherein the network optimization characteristics are collected based on the network optimization advertisement messages, wherein the network optimization characteristics comprise one or more of: communication quality metrics measured at the other control devices from which the network optimization advertisement messages are received, a noise floor measured at the other control devices from which the network optimization advertisement messages are received, or a communication quality metric of network optimization messages measured at the other control devices.

120. The non-transitory computer-readable medium of claim 38, wherein the instructions, when executed by the control circuit, further cause the control circuit to:
after determining to initiate the adjustment to the network configuration, set a random backoff timer within a predefined timeframe before initiating the adjustment to the network configuration; and
after an expiration of the random backoff timer, transmit a message configured to indicate the adjustment to the network configuration is being performed, wherein the message comprises an adjustment notice.

121. The non-transitory computer-readable medium of claim 38, wherein the instructions, when executed by the control circuit, further cause the control circuit to:
detect that the network has been formed; and
in response to detecting that the network has been formed, await a network stabilization period prior to at least one of the collecting of the network optimization characteristics or the determining to initiate the adjustment to the network configuration.

122. The non-transitory computer-readable medium of claim 38, wherein the instructions, when executed by the control circuit, cause the control circuit to perform the adjustment to the network configuration by causing the control circuit to transmit a message configured to perform an adjustment to a role of a first control device on the network.

123. The non-transitory computer-readable medium of claim 122, wherein the role of the first control device is a router device on the network prior to the adjustment, and wherein the message is configured to downgrade the role of the first control device to an end device on the network.

124. The non-transitory computer-readable medium of claim 122, wherein the role of the first control device is an end device on the network prior to the adjustment, and wherein the message is configured to upgrade the role of the first control device to a router device on the network.

125. The non-transitory computer-readable medium of claim 38, wherein the adjustment to the network configuration comprises an adjustment to a relationship of a first control device with another control device of the plurality of control devices on a network, wherein the relationship is a parent-child relationship, wherein the first control device is a child device to another control device of the plurality of control devices to which the first control device is attached as a parent device, and wherein the adjustment is initiated to change the parent device of the first control device to another control device of the plurality of control devices on the network.

126. The non-transitory computer-readable medium of claim 38, wherein the instructions, when executed by the control circuit, further cause the control circuit to:
receive a message that indicates the adjustment to the network configuration;
collect updated network optimization characteristics; and
determine, based on the updated network optimization characteristics, that the adjustment occurred in response to the message.
